(19) United States
(12) Patent Application Publication
(10) Pub. No.: US 2026/0284819 A1
(43) Pub. Date: Sep. 24, 2026

(54) POSITION-BASED AUTO-STOP FEATURE FOR A POWER TOOL

(71) Applicant: MILWAUKEE ELECTRIC TOOL CORPORATION, Brookfield, WI (US)

(72) Inventor: Jesse A. Gibb, Milwaukee, WI (US)

(21) Appl. No.: 19/576,190

(22) Filed: Mar. 24, 2026

Related U.S. Application Data
(60) Provisional application No. 63/877,572, filed on Sep. 8, 2025.
(60) Provisional application No. 63/776,500, filed on Mar. 24, 2025.

(51) Int. Cl. B23Q 11/04; B25F 5/00; H02H 7/085

(52) U.S. Cl. CPC B23Q 11/04; B25F 5/00; H02H 7/0854

(57) ABSTRACT

Power tools and methods of operating the same. One power tool includes a housing, a motor within the housing, a sensor configured to monitor a power tool characteristic, a switching network electrically coupled to the motor, and an electronic processor. The electronic processor is configured to, while the motor is operating, determine an angular velocity of the housing about a rotational axis based on the power tool characteristic, compare the angular velocity to a velocity threshold, and, in response to the angular velocity exceeding the velocity threshold, add a value of the angular velocity to an integrator. The electronic processor is also configured to determine, based on a value of the integrator exceeding an auto-stop trip threshold, that a loss of control event is occurring, and control, in response to determining that the loss of control event is occurring, the switching network to cease driving of the motor.

### RELATED APPLICATIONS

This application claims priority to U.S. Provisional Application No. 63/776,500, filed Mar. 24, 2025, and U.S. Provisional Application No. 63/877,572, filed Sep. 8, 2025, the entire contents of which is incorporated by reference herein.

### FIELD

The present invention relates to detecting a loss of control event of a power tool and controlling the power tool accordingly.

### SUMMARY

Embodiments described herein provide power tools and methods for detecting loss of control of power tools. One power tool includes a housing, a motor within the housing and having a rotor and a stator, the rotor configured to rotationally drive a motor shaft about a rotational axis, a first sensor configured to monitor a power tool characteristic, and a second sensor configured to measure a motor characteristic, wherein the motor characteristic includes at least one selected from a group consisting of motor current and motor speed. The power tool also includes a switching network electrically coupled to the motor, and an electronic processor connected to the switching network, the first sensor, and the second sensor. The electronic processor is configured to implement an auto-stop function of the power tool, wherein, to implement the auto-stop function, the electronic processor is configured to, while the motor is operating, increment a counter based on the power tool characteristic monitored by the first sensor, and set an auto-stop trip threshold based on at least one selected from the group consisting of motor current and motor speed as measured by the second sensor. The electronic processor is also configured to determine, based on a value of the counter exceeding the auto-stop trip threshold, that a loss of control event is occurring, and control, in response to determining that the loss of control event is occurring, the switching network to cease driving of the motor.

In some embodiments, the motor speed is represented as a revolutions per minute (RPM) droop.

In some embodiments, the electronic processor is configured to set the auto-stop trip threshold by mapping the motor current to a threshold value using a relationship mapping motor current values to a plurality of threshold values between a maximum auto-stop trip threshold and a minimum auto-stop trip threshold, and setting the auto-stop trip threshold to the threshold value defined via the relationship. The relationship may be a linear relation and may map the motor current values to decreasing auto-stop trip threshold values as motor current increases.

In some embodiments, the electronic processor is configured to set the auto-stop trip threshold by mapping the motor speed to a threshold value using a relationship mapping motor speed values to a plurality of threshold values between a maximum auto-stop trip threshold and a minimum auto-stop trip threshold, and setting the auto-stop trip threshold to the threshold value defined via the relationship. The relationship may be a linear relationship. The motor speed values may represent speed droop values, and the relationship may map the motor speed droop values to decreasing auto-stop trip threshold values as motor speed droop increases.

In some embodiments, the electronic processor is configured to set the auto-stop trip threshold by mapping the motor current to a first threshold value using a first relationship mapping motor current values to a plurality of threshold values between a maximum auto-stop trip threshold and a minimum auto-stop trip threshold, mapping the motor speed to a second threshold value using a second relationship mapping motor speed values to a plurality of threshold values between the maximum auto-stop trip threshold and the minimum auto-stop trip threshold, and setting the auto-stop trip threshold based on the first threshold value and the second threshold value. The electronic processor may be configured to set the auto-stop trip threshold based on the first threshold value and the second threshold value by setting the auto-stop trip threshold to the lower of the first threshold value and the second threshold value or by setting the auto-stop trip threshold to an average of the first threshold value and the second threshold value.

In some embodiments, the power tool characteristic includes a measurement of an angular velocity of the housing of the power tool.

In some embodiments, the electronic processor is configured to increment the counter based on the power tool characteristic by determining a highest threshold of a plurality of thresholds that the power tool characteristic exceeds and incrementing the counter according to an incrementing rate associated with the highest threshold.

In some embodiments, the electronic processor is further configured to decrement the counter based on the power tool characteristic.

One method for detecting loss of control of a power tool includes incrementing, during operation of a motor of the power tool, a counter based on a power tool characteristic, and setting, during the operation of the motor, an auto-stop trip threshold based on at least one selected from a group consisting of a motor current and a motor speed. The method also includes determining, based on a value of the counter exceeding the auto-stop trip threshold, that a loss of control event is occurring, and controlling, in response to determining that the loss of control event is occurring, a switching network of the power tool to cease driving of the motor.

Another power tool includes a housing, a motor within the housing and having a rotor and a stator, the rotor configured to rotationally drive a motor shaft about a rotational axis, a sensor configured to monitor a power tool characteristic, a switching network electrically coupled to the motor, and an electronic processor connected to the switching network and the sensor. The electronic processor is configured to implement an auto-stop function of the power tool, wherein, to implement the auto-stop function while the motor is operating, the electronic processor is configured to determine an angular velocity of the housing about the rotational axis based on the power tool characteristic monitored by the sensor, compare the angular velocity to a velocity threshold, and, in response to the angular velocity exceeding the velocity threshold, add a value of the angular velocity to an integrator. The electronic processor is further configured to determine, based on a value of the integrator exceeding an auto-stop trip threshold, that a loss of control event is occurring, and control, in response to determining that the loss of control event is occurring, the switching network to cease driving of the motor.

The electronic processor of the power tool may be configured to add the value of the angular velocity to the integrator by multiplying the angular velocity of the housing by a detection rate of the power tool characteristic monitored by the sensor to calculate a positional change of the housing and add the positional change to the integrator.

The electronic processor may also be configured to add the value of the angular velocity to the integrator by, in response to the angular velocity of the housing being opposite to a direction of force applied via operation of the power tool, adding the angular velocity of the housing multiplied by a scaler value to the integrator.

The electronic processor may also be configured to make a value of the angular velocity of the housing negative in response to the angular velocity of the housing being opposite to a direction of force applied via operation of the power tool and wherein the electronic processor is configured to compare the negative angular velocity to the velocity threshold by comparing the negative angular velocity to an absolute value of the velocity threshold.

The electronic processor may also be configured to, in response to the angular velocity not exceeding the velocity threshold, subtract a predetermined leakage value from the integrator.

The electronic processor may also be configured to, in response to the angular velocity not exceeding the velocity threshold and the integrator having a value less than a predetermined leakage value, set the integrator to a value of zero.

The electronic processor may also be configured to determine the auto-stop trip threshold based at least one selected from a group consisting of motor current and motor speed.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect. Additionally, unless noted otherwise, “near,” “approximately,” and substantially may refer to within 5% or 10% of a particular value, or within 5 or 10 degrees of a particular angle, in the case of an angle.

It should be noted that a plurality of hardware and software based devices, as well as a plurality of different structural components may be utilized to implement the invention. Furthermore, and as described in subsequent paragraphs, the specific configurations illustrated in the drawings are intended to exemplify embodiments of the invention and that other alternative configurations are possible. The terms “processor” “central processing unit” and “CPU” are interchangeable unless otherwise stated. Where the terms “processor” or “central processing unit” or “CPU” are used as identifying a unit performing specific functions, it should be understood that, unless otherwise stated, those functions can be carried out by a single processor, or multiple processors arranged in any form, including parallel processors, serial processors, tandem processors or cloud processing/cloud computing configurations.

### BRIEF DESCRIPTION OF THE DRAWINGS

FIG. 1 illustrates a communication system according to one embodiment of the invention.

FIGS. 2A and 2B illustrate an example power tool of the communication system of FIG. 1 according to two example embodiments.

FIG. 3 illustrates a block diagram of the power tool of FIGS. 2A and 2B according to one example embodiment.

FIG. 4 illustrates a flowchart of an example method of detecting kickback of the power tool of FIGS. 2A and 2B and ceasing driving of a motor of the power tool in response to detecting the kickback.

FIG. 5 illustrates an example screenshot of a user interface of an external device of the communication system of FIG. 1.

FIG. 6 illustrates three example orientations of the power tool of FIGS. 2A and 2B.

FIG. 7 illustrates a flowchart of an example method of setting a kickback sensitivity parameter based on the orientation of the power tool of FIGS. 2A and 2B.

FIGS. 8A and 8B are charts that illustrate an exaggerated quick release feature of the power tool of FIGS. 2A and 2B according to some embodiments.

FIG. 9 illustrates a flowchart of an example method of setting a kickback sensitivity parameter based on a battery characteristic of a battery pack coupled to the power tool of FIGS. 2A and 2B.

FIG. 10 illustrates a flowchart of an example method of adjusting a kickback sensitivity parameter based on a kickback event of the power tool of FIGS. 2A and 2B.

FIG. 11 illustrates three example roll positions of the power tool of FIGS. 2A and 2B.

FIG. 12 illustrates a flowchart of an example method of reducing power supplied to the motor of the power tool of FIGS. 2A and 2B based on detected tool walk of the power tool.

FIGS. 13 and 14 illustrate flowcharts of example methods of controlling the power tool of FIGS. 2A and 2B after the power tool 102a becomes bound in a workpiece.

FIG. 15A illustrates a flowchart of another method of detecting kickback of the power tool of FIGS. 2A and 2B and ceasing driving of the motor in response to detecting the kickback.

FIG. 15B illustrates a flowchart of another method of detecting loss of control of the power tool of FIGS. 2A and 2B and ceasing driving of the motor in response to detecting the loss of control.

FIG. 15C illustrates example angular velocity thresholds used in the method of FIG. 15B.

FIG. 15D illustrates an example linear relationship between motor current and an auto-stop trip threshold.

FIG. 15E illustrates an example linear relationship between motor speed droop and an auto-stop trip threshold.

FIGS. 15F-1 and 15F-1 illustrate a plurality of graphs representing examples values over a period of time used as part of the method of FIG. 15B.

FIG. 16 illustrates a flowchart of an example method of detecting kickback of the power tool of FIGS. 2A and 2B where the method adjusts a working operating angle range based on a monitored angular velocity of the housing of the power tool of FIGS. 2A and 2B.

FIG. 17 illustrates an example power tool of the communication system of FIG. 1 according to another example embodiment.

FIGS. 18A and 18B illustrate a flowchart of another method of detecting loss of control of the power tool of FIGS. 2A and 2B and ceasing driving of the motor in response to detecting the loss of control.

FIGS. 18C and 18D illustrate a flowchart of yet another method of detecting loss of control of the power tool of FIGS. 2A and 2B and ceasing driving of the motor in response to detecting the loss of control.

FIG. 19A illustrates a graph representing example angular velocity values over a period of time used as part of the method of FIGS. 18A and 18B.

FIG. 19B illustrates a graph representing example integrator values over a period of time used as part of the method of FIGS. 18A and 18B.

FIG. 19C illustrates the graphs of FIGS. 19A and 19B aligned over a period of time.

### DETAILED DESCRIPTION

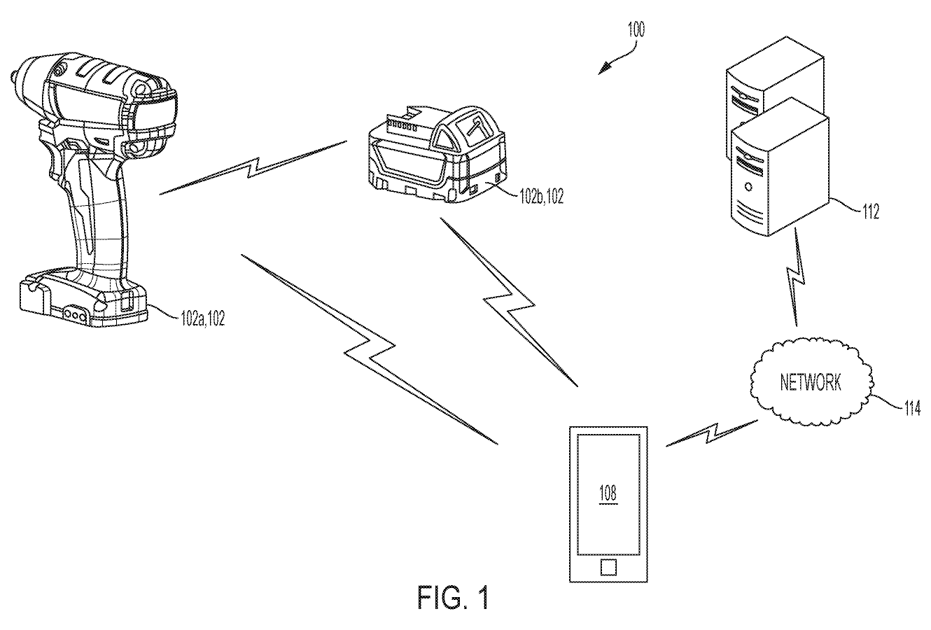

FIG. 1 illustrates a communication system 100. The communication system 100 includes power tool device 102 and an external device 108. Each power tool device 102 (e.g., power tool 102a and power tool battery pack 102b) and the external device 108 can communicate wirelessly while they are within a communication range of each other. Each power tool device 102 may communicate power tool status, power tool operation statistics, power tool identification, stored power tool usage information, power tool maintenance data, and the like. Therefore, using the external device 108, a user can access stored power tool usage or power tool maintenance data. With this tool data, a user can determine how the power tool device 102 has been used, whether maintenance is recommended or has been performed in the past, and identify malfunctioning components or other reasons for certain performance issues. The external device 108 is also configured to transmit data to the power tool device 102 for power tool configuration, firmware updates, or to send commands (e.g., turn on a work light). The external device 108 also allows a user to set operational parameters, safety parameters, select tool modes, and the like for the power tool device 102.

The external device 108 may be, for example, a smart phone (as illustrated), a laptop computer, a tablet computer, a personal digital assistant (PDA), or another electronic device capable of communicating wirelessly with the power tool device 102 and providing a user interface. The external device 108 provides a user interface and allows a user to access and interact with tool information. The external device 108 is configured to receive user inputs to determine operational parameters, enable or disable features, and the like. The user interface of the external device 108 provides an easy-to-use interface for the user to control and customize operation of the power tool 102a.

The external device 108 includes a communication interface that is compatible with a wireless communication interface of the power tool device 102 (e.g., transceiver 315 shown in FIG. 3). The communication interface of the external device 108 may include a wireless communication controller (e.g., a Bluetooth® module), or a similar component. The external device 108, therefore, grants the user access to data related to the power tool device 102, and provides a user interface such that the user can interact with an electronic processor of the power tool device 102.

In addition, as shown in FIG. 1, the external device 108 can also share the information obtained from the power tool device 102 with a remote server 112 connected by a network 114. The remote server 112 may be used to store the data obtained from the external device 108, provide additional functionality and services to the user, or a combination thereof. In one embodiment, storing the information on the remote server 112 allows a user to access the information from a plurality of different locations. In another embodiment, the remote server 112 may collect information from various users regarding their power tool devices and provide statistics or statistical measures to the user based on information obtained from the different power tools. For example, the remote server 112 may provide statistics regarding the experienced efficiency of the power tool device 102, typical usage of the power tool device 102, and other relevant characteristics and/or measures of the power tool device 102. The network 114 may include various networking elements (routers, hubs, switches, cellular towers, wired connections, wireless connections, etc.) for connecting to, for example, the Internet, a cellular data network, a local network, or a combination thereof. In some embodiments, the power tool device 102 may be configured to communicate directly with the server 112 through an additional wireless interface or with the same wireless interface that the power tool device 102 uses to communicate with the external device 108.

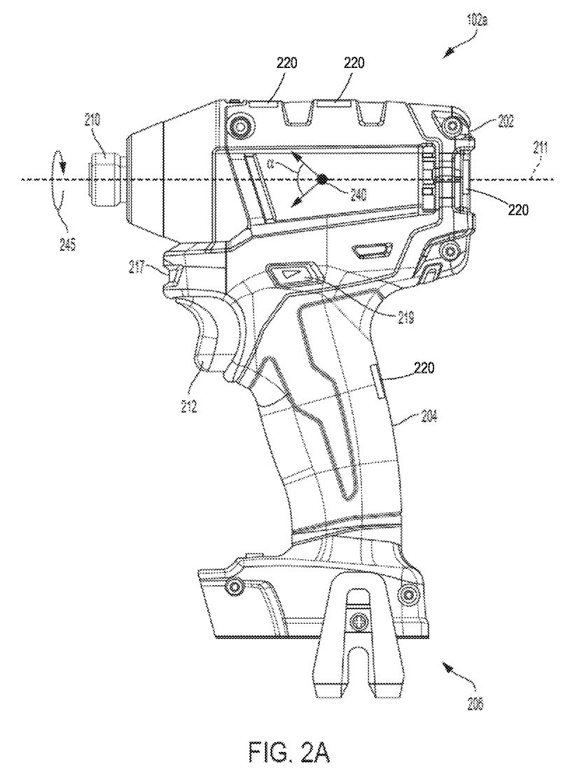

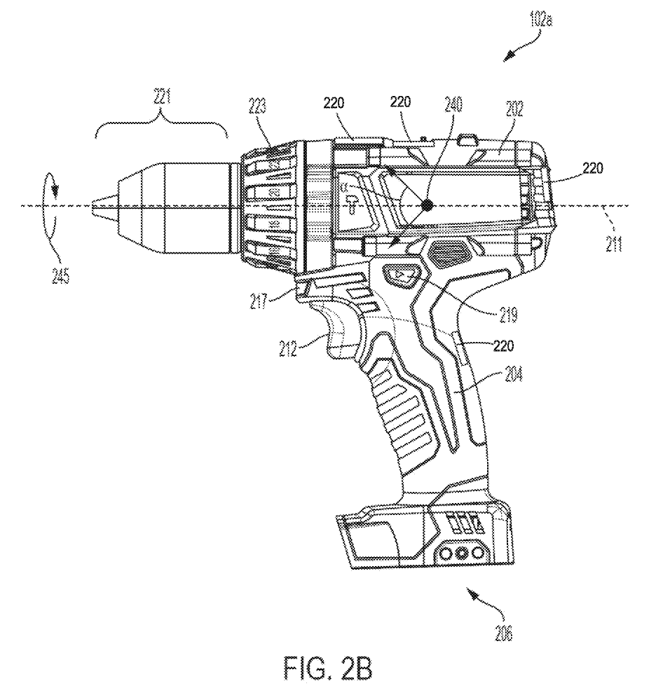

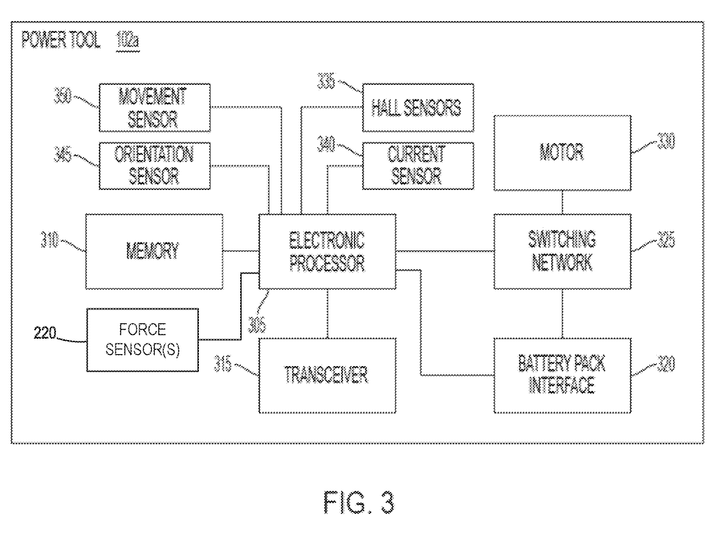

In some embodiments, the power tool 102a and power tool battery pack 102b may wirelessly communicate with each other via respective wireless transceivers within each device. For example, the power tool battery pack 102b may communicate a battery characteristic to the power tool 102a (e.g., a battery pack identification, a battery pack type, a battery pack weight, a current output capability of the battery pack 102b, and the like). Such communication may occur while the battery pack 102b is coupled to the power tool 102a. Additionally or alternatively, the battery pack 102b and the power tool 102a may communicate with each other using a communication terminal while the battery pack 102b is coupled to the power tool 102a. For example, the communication terminal may be located near the battery terminals in the battery pack receiving portion 206 of FIGS. 2A and 2B.

The power tool device 102 is configured to perform one or more specific tasks (e.g., drilling, cutting, fastening, pressing, lubricant application, sanding, heating, grinding, bending, forming, impacting, polishing, lighting, etc.). For example, an impact wrench and a hammer drill are associated with the task of generating a rotational output (e.g., to drive a bit).

FIGS. 2A and 2B illustrate the power tool 102a according to two example embodiments. In the embodiment shown in FIG. 2A, the power tool 102a is an impact driver. In the embodiment shown in FIG. 2B, the power tool 102a is a hammer drill. In FIGS. 2A and 2B, similar elements are labeled with the same reference numbers. The power tools 102a of FIGS. 2A and 2B are representative of various types of power tools that operate within the system 100. Accordingly, the description with respect to the power tool 102a in the system 100 is similarly applicable to other types of power tools, such as right angle drills, joist and stud drills, other drills, ratchets, screwdrivers, concrete mixers, hole diggers, rotary tools, and the like.

As shown in FIG. 2A, the power tool 102a includes an upper main body 202, a handle 204, a battery pack receiving portion 206, an output driver 210, a trigger 212, a work light 217, a forward/reverse selector 219, and one or more force sensors 220 (e.g., grip sensors, pressure sensors, grip pressure sensors, etc.) for detecting a magnitude and/or direction of a force applied to the power tool 102a. The housing of the power tool 102a (e.g., the main body 202 and the handle 204) are composed of a durable and light-weight plastic material. The output driver 210 is composed of a metal (e.g., steel). The output driver 210 on the power tool 102a is a female socket configured to hold a bit or similar device. However, other power tools may have a different output driver 210 specifically designed for the task associated with the other power tools, such as a chuck to hold a drill bit (see FIG. 2B), an arbor to hold a saw blade, a reciprocating saw blade holder, or a male socket driver. The battery pack receiving portion 206 is configured to receive and couple to a battery pack (e.g., battery pack 102b of FIG. 1) that provides power to the power tool 102a. The battery pack receiving portion 206 includes a connecting structure to engage a mechanism that secures the battery pack and a terminal block to electrically connect the battery pack to the power tool 102a.

The power tool 102a includes a motor housed within the upper main body 202. The motor includes a rotor and a stator. The rotor is coupled to the output driver 210 to produce an output about a rotational axis 211 to allow the output driver 210 to perform the particular task. In some embodiments, the trigger 212 is a mechanical switch that generates an actuation signal dependent on how far a user of the power tool 102a engages the trigger 212. In some embodiments, the trigger 212 is a pressure sensor and does not move when the user presses the trigger 212. Rather, the trigger 212 generates an actuation signal indicating how hard a user is pressing on the trigger 212 and pressure sensor. In some embodiments, a metal-on-capacitor sensing arrangement is used. The motor is energized based on the position of the trigger 212 for a mechanical switch or based on the amount of pressure applied to the trigger 212 for a pressure sensor. The language depressing the trigger 212, as used herein, does not necessarily imply motion of the trigger 212.

Unless overriding control features are activated, when the trigger 212 is depressed the motor is energized, and when the trigger 212 is released, the motor is de-energized. In the illustrated embodiment, the trigger 212 extends partially down a length of the handle 204; however, in other embodiments the trigger 212 extends down the entire length of the handle 204 or may be positioned elsewhere on the power tool 102a.

For a mechanical trigger 212, the trigger 212 is moveably coupled to the handle 204 such that the trigger 212 moves with respect to the tool housing. The trigger 212 is coupled to a push rod, which is engageable with a trigger switch. The trigger 212 moves in a first direction towards the handle 204 when the trigger 212 is depressed by the user. The trigger 212 is biased (e.g., with a spring) such that it moves in a second direction away from the handle 204, when the trigger 212 is released by the user. When the trigger 212 is depressed by the user, the push rod activates the trigger switch, and when the trigger 212 is released by the user, the trigger switch is deactivated.

In other embodiments, the trigger 212 is coupled to an electrical trigger switch. In such embodiments, the trigger switch may include, for example, a transistor. Additionally, for such electronic embodiments, the trigger 212 may not include a push rod to activate the mechanical switch. Rather, the electrical trigger switch may be activated by, for example, a position sensor (e.g., a Hall-Effect sensor) that relays information about the relative position of the trigger 212 to the tool housing or electrical trigger switch. The trigger switch outputs a signal indicative of the position of the trigger 212. In some instances, the signal is binary and indicates either that the trigger 212 is depressed or released. In other instances, the signal indicates the position of the trigger 212 with more precision. For example, the trigger switch may output an analog signal that various from 0 to 5 volts depending on the extent that the trigger 212 is depressed. For example, 0 V output indicates that the trigger 212 is released, 1 V output indicates that the trigger 212 is 20% depressed, 2 V output indicates that the trigger 212 is 40% depressed, 3 V output indicates that the trigger 212 is 60% depressed 4 V output indicates that the trigger 212 is 80% depressed, and 5 V indicates that the trigger 212 is 100% depressed. The signal output by the trigger switch may be analog or digital.

In other embodiments, the trigger 212 includes a force or pressure sensor that does not significantly change in position when depressed by the user. The pressure sensor may output an analog actuation signal that varies from 0 volts to 5 volts depending on the amount of pressure applied by the user. The actuation signal output by the pressure sensor may be analog or digital.

The grip sensors 220 generate output signals that provide grip parameters indicating that the user is holding the power tool 102a and how the user is holding the power tool 102a. For example, if the user has one hand on the power tool 102a, the grip sensor 220 on the handle 204 will sense the user’s hand. If the user has a second hand on the upper main body 202, one or more of the grip sensors 220 will detect the presence of the second hand. In some embodiments, the grip sensors 220 are touch sensors (e.g., capacitive sensors) that generate a binary signal if they are activated. In other embodiments, the grip sensors 220 are force or pressure sensors that provide a signal proportional to the strength of the force applied to the sensor (e.g., a user’s grip pressure). Thus, the grip parameters may include grip position (e.g., how the power tool 102a is being held) and grip strength (e.g., non-zero grip strength value to indicate presence). In some embodiments, the power tool 102a is prevented from being used or operated (e.g., is non-operational) unless the user’s grip is detected (e.g., non-zero grip strength value) on the handle 204 (e.g., for a grinder, chainsaw, etc.). In some embodiments, the power tool 102a is prevented from being turned off (e.g., is constantly operational) unless the user’s grip is not detected on the handle 204 (e.g., for a vacuum cleaner, etc.).

As shown in FIG. 2B, the power tool 102a includes many similar components as the power tool 102a shown in FIG. 2A. For example, the hammer drill of FIG. 2B includes an upper main body 202, a handle 204, a battery pack receiving portion 206, a trigger 212, a work light 217, a forward/reverse selector 219, and one or more force sensors 220 (e.g., grip sensors, pressure sensors, grip pressure sensors, etc.). The hammer drill also includes a chuck 221 and torque setting dial 223. As noted above, many elements of the hammer drill of FIG. 2B share reference numbers with respective elements of the impact driver of FIG. 2A. Accordingly, these similarly-labeled elements of FIG. 2B may include similar functionality as that described above with respect to FIG. 2A.

FIG. 3 illustrates a block diagram of the power tool 102a. As shown in FIG. 3, the power tool 102a includes an electronic processor 305 (for example, a microprocessor or other electronic device), a memory 310, a transceiver 315, a battery pack interface 320, a switching network 325, a motor 330, Hall sensors 335, a current sensor 340, an orientation sensor 345, a movement sensor 350, and one or more force sensors 220 (e.g., grip sensors, pressure sensors, grip pressure sensors, etc.). In some embodiments, the power tool 102a may include fewer or additional components in configurations different from that illustrated in FIG. 3. For example, in some embodiments, the power tool 102a may include one or more indicators such as light-emitting diodes (LEDs) to indicate a status of the power tool 102a or a mode of the power tool 102a. In some embodiments, the power tool 102a may include multiple orientation sensors 345 and/or movement sensors 350. In some embodiments, the power tool 102a may perform functionality other than the functionality described below.

For example, the electronic processor 305 is configured to adjust one or more of the settings, mode, and motor speed of the power tool 102a based on signals received from one or more sensors of the power tool 102a, as explained in greater detail below.

The transceiver 315 sends and receives data to and from the external device 108, the network 114, or both, as explained above. For example, through the transceiver 315, the electronic processor 305 may send stored power tool usage or maintenance data to the external device 108 and may receive operational parameters or tool modes from the external device 108.

The battery pack interface 320 transmits power received from the battery pack to the electronic processor 305 and the switching network 325. Although not shown in FIG. 3, in some embodiments, the power tool 102a includes active and/or passive components (e.g., voltage step-down controllers, voltage converters, rectifiers, filters, etc.) to regulate or control the power received through the battery pack interface 320 and provided to the electronic processor 305 and/or the motor 330.

The switching network 325 enables the electronic processor 305 to control the operation of the motor 330. Generally, when the trigger 212 is depressed, electrical current is supplied from the battery pack interface 320 to the motor 330, via the switching network 325. When the trigger 212 is not depressed, electrical current is not supplied from the battery pack interface 320 to the motor 330. The electronic processor 305 controls the switching network 325 to control the amount of current available to the motor 330 and thereby controls the speed and torque output of the motor 330. The switching network 325 may include numerous FETs, bipolar transistors, or other types of electrical switches. For instance, the switching network 325 may include a six-FET bridge that receives pulse-width modulated (PWM) signals from the electronic processor 305 to drive the motor 330.

The sensors 335, 340, 345, and 350 are coupled to the electronic processor 305 and communicate various signals to the electronic processor 305 that are indicative of different parameters of the power tool 102a or the motor 330. Although not shown in FIG. 3, in some embodiments, the power tool 102a includes additional sensors such as one or more voltage sensors, one or more temperature sensors, one or more torque sensors, and the like.

In some embodiments, each Hall sensor 335 outputs motor feedback information to the electronic processor 305, such as an indication (e.g., a pulse) when a magnet of the motor’s rotor rotates across the face of that Hall sensor 335. Based on the motor feedback information from the Hall sensors 335, the electronic processor 305 can determine the position, velocity, and acceleration of the rotor. In response to the motor feedback information and the position of the trigger 212, the electronic processor 305 transmits control signals to control the switching network 325 to drive the motor 330. For instance, by selectively enabling and disabling the FETs of the switching network 325, power received via the battery pack interface 320 is selectively applied to stator coils of the motor 330 to cause rotation of its rotor. The motor feedback information is used by the electronic processor 305 to ensure proper timing of control signals to the switching network 325 and, in some instances, to provide closed-loop feedback to control the speed of the motor 330 to be at a desired level. For example, as feedback from the Hall sensors 335 indicates rotation of the rotor, the electronic processor 305 sequentially (a) enables select FET pairs of the switching network 325 such that the magnetic field produced by the associated stator coils continuously drives the rotor and (b) disables the remaining FETs of the switching network 325 such that current is not diverted from the appropriate stator coils and such that the stator coils do not produce a magnetic field that inhibits rotation of the rotor.

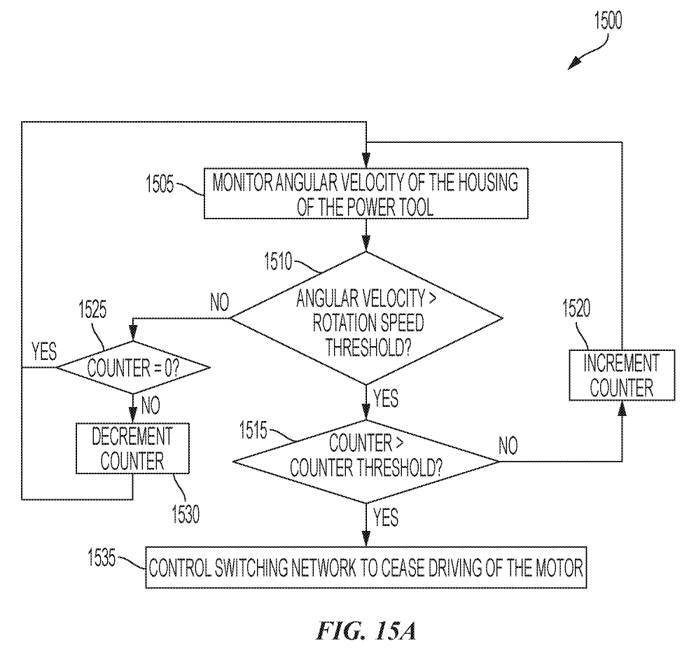

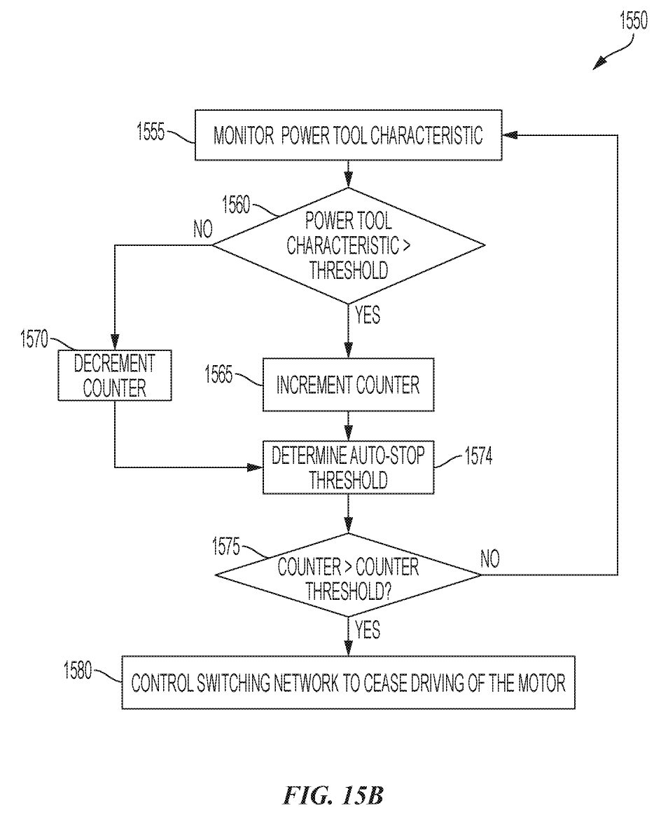

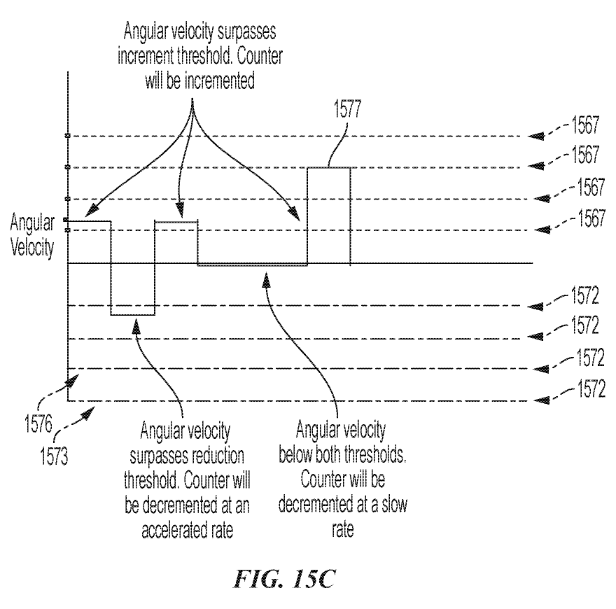

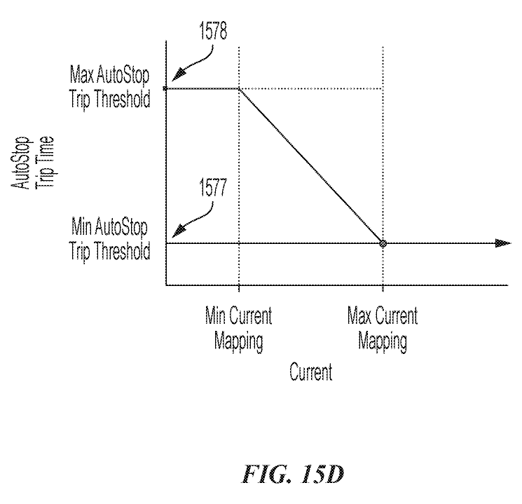

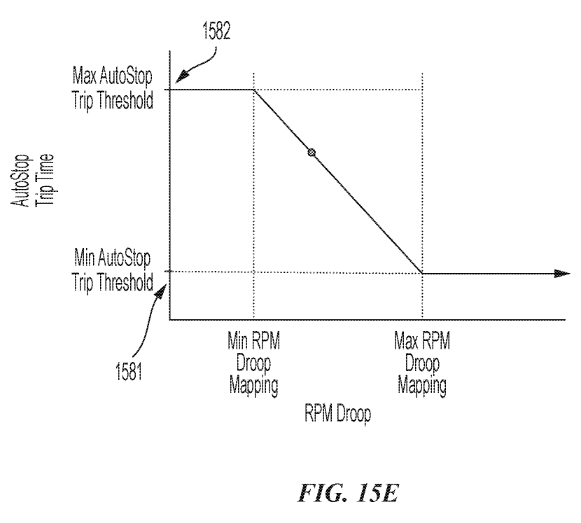

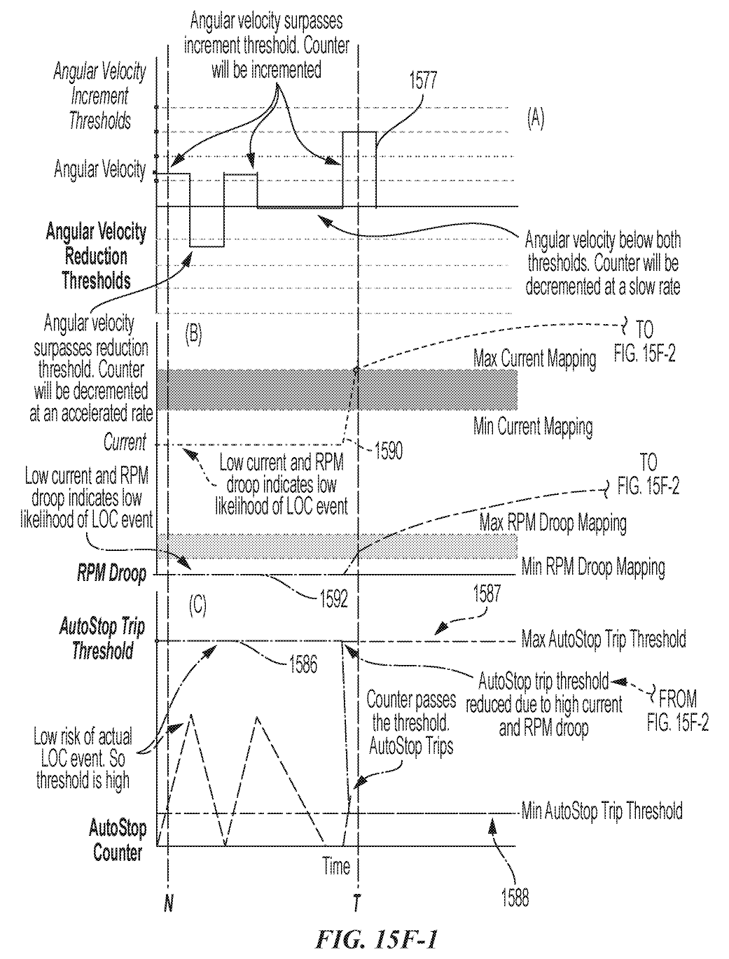

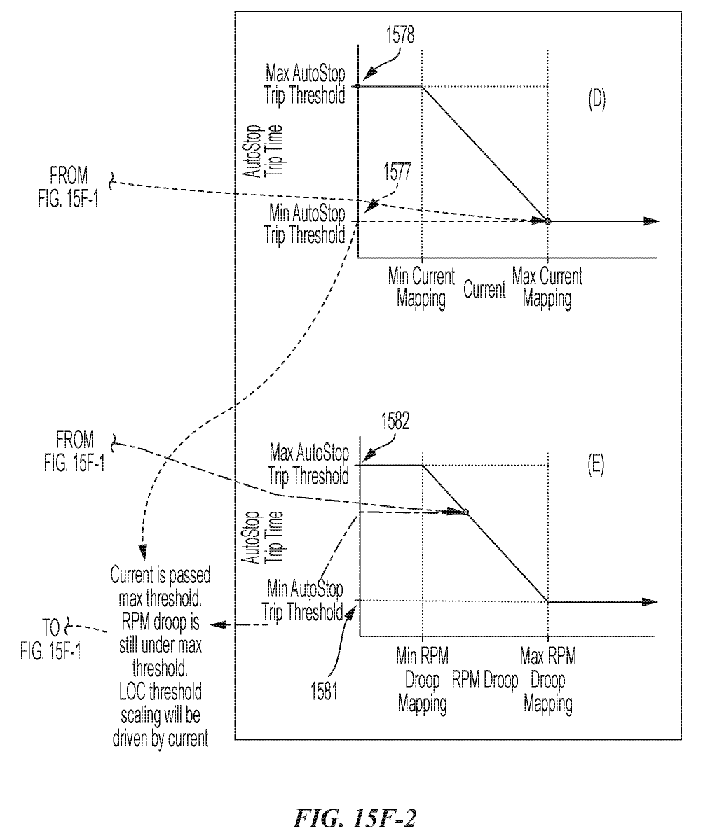

As described with respect to FIG. 15B, in some embodiments, the electronic processor 305 uses information from the Hall sensor 335 to determine a speed (e.g., revolutions per minute (RPM)) of the motor (i.e., motor shaft) and uses the speed (e.g., speed droop) to dynamically adjust one or more thresholds for detecting an auto-stop event. For example, the electronic processor 305 may be configured to determine an RPM droop using the information from the Hall sensor 335, wherein the RPM droop indicates a difference (error) between a measured (actual) RPM and a target RPM. As described with respect to FIG. 15B, in some embodiments, the electronic processor 305 uses RPM and/or RPM droop to dynamically adjust one or more thresholds for triggering an auto-stop event. It should be understood that, in some embodiments, the electronic processor 305 determines the motor speed, RPM droop, or both using one or more sensors other than the Hall sensor 335 (e.g., one or more rotary type encoders, photoelectric (optical) sensors, magnetic rotational speed sensors, or a combination thereof).

In some embodiments, the current sensor 340 monitors current drawn by the motor 330 (i.e., the motor current).

As described with respect to FIG. 15B, in some embodiments, the electronic processor 305 uses information from one or more sensors configured to measure a motor characteristic, wherein the motor characteristic includes at least one selected from a group consisting of motor current and motor speed and uses the measured motor characteristic to dynamically adjust one or more thresholds for detecting an auto-stop event. For example, the electronic processor 305 may use information from the Hall sensor 335 to determine a speed (e.g., revolutions per minute (RPM)) of the motor (i.e., motor shaft) and uses the speed to dynamically adjust one or more thresholds for detecting an auto-stop event. For example, the electronic processor 305 may be configured to determine an RPM droop using the information from the Hall sensor 335, wherein the RPM droop indicates a difference (error) between a measured (actual) RPM and a target RPM. As described with respect to FIG. 15B, in some embodiments, the electronic processor 305 uses RPM and/or RPM droop to dynamically adjust one or more thresholds for triggering an auto-stop event. It should be understood that, in some embodiments, the electronic processor 305 determines the motor speed, RPM droop, or both using one or more sensors other than the Hall sensor 335 (e.g., one or more rotary type encoders, photoelectric (optical) sensors, magnetic rotational speed sensors, or a combination thereof).

Similarly, in some embodiments, the electronic processor 305 uses information from the current sensor 340 (as a sensor configured to measure a motor characteristic) to dynamically adjust one or more thresholds for triggering an auto-stop event. While the Hall sensor 335 and the current sensor 340 are described herein as measuring a motor characteristic, other types of sensors and devices may be used to detect the noted motor characteristics as well as other motor characteristics that may be used to dynamically-adjust an auto-stop trip threshold as described herein with respect to FIG. 15B. For example, in some embodiments, a single sensor may be used to measure both speed (RPM) and current.

In some embodiments, the orientation sensor 345 is an accelerometer and transmits signals to the electronic processor 305 that are indicative of an orientation of the power tool 102a with respect to gravity. For example, the orientation sensor 345 may indicate a pitch or roll of the power tool 102a. The pitch of the power tool 102a is represented by a pitch angle α and indicates the direction in which the output driver 210 is facing along a pitch axis 240 of FIGS. 2A and 2B (e.g., upward, downward, or horizontally). The pitch axis 240, illustrated as a point, extends in an out of the page in the view of FIGS. 2A and 2B. The roll of the power tool 102a indicates a position/angle with respect to gravity of the power tool 102a about the rotational axis 211 (usually when the power tool 102a is oriented horizontally). For example, FIGS. 2A and 2B illustrate a roll motion 245 about the rotational axis 211.

In some embodiments, the movement sensor 350 is a gyroscope and transmits signals to the electronic processor 305 that are indicative of an angular velocity of the power tool 102a. For example, in a situation where the output of the power tool 102a is bound in a workpiece (i.e., during a kickback of the power tool 102a as described in greater detail below), signals from the movement sensor 350 may indicate the angular velocity at which the housing of the power tool 102a rotates about its rotational axis (e.g., in degrees per second).

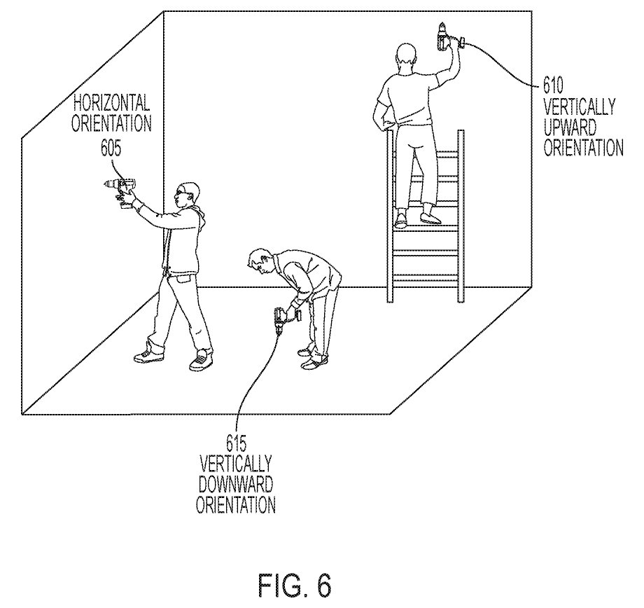

In some embodiments, the electronic processor 305 monitors roll position of the power tool 102a to determine when kickback of the power tool 102a is occurring. For example, the electronic processor 305 may compare a current roll position of the power tool 102a during operation to an initial roll position when the trigger 212 was actuated or to a preferred roll position (e.g., a horizontal orientation 605 with the rotational axis of the power tool 102a at ninety degrees with respect to gravity as shown in FIG. 6). In some embodiments, the electronic processor 305 directly monitors the current roll position of the power tool 102a by receiving signals from the orientation sensor 345 that indicate the roll position of the power tool 102a. In other embodiments, the electronic processor 305 infers the current roll position of the power tool 102a based on the initial roll position when the trigger 212 was actuated (as determined by direct measurement from the orientation sensor 345) and monitored angular velocity of the housing of the power tool 102 (as determined by the movement sensor 350). In other words, the electronic processor 305 indirectly determines the current roll position of the power tool 102a by multiplying the current angular velocity measurement by the amount of time between angular velocity measurements to determine a roll movement. The electronic processor 305 then adds the roll movement to the initial roll position of the power tool 102a to determine a current roll position of the power tool 102a.

In some embodiments, the sensors 345 and 350 may include one or more accelerometers, gyroscopes, or magnets that may be separate or integrated into a single assembly. In some embodiments, the sensors 345 and 350 allow for movement of the power tool 102a to be monitored from one to nine axes (e.g., at least one of three axis monitoring, six axis monitoring, and nine axis monitoring). In some embodiments, the power tool 102a includes an inertial measurement unit (IMU) printed circuit board (PCB) that includes the sensors 345 and 350. In some embodiments, the IMU PCB is located in the foot of the power tool 102a (i.e., near the battery pack receiving portion 206) and communicates information obtained by the sensors 345 and 350 to the electronic processor 305 located on a control PCB in the handle 204 of the power tool 102a. In such embodiments, the IMU PCB is isolated from vibration caused by the motor 330 and may accurately monitor the roll position of the power tool 102a about the rotational axis 211. In some embodiments, the IMU PCB is located at other locations in the power tool 102a. For example, the IMU PCB may be located underneath the motor 330 (e.g., above the handle 204 or at the upper portion of the handle 204). As another example, the IMU PCB may be located above the motor 330.

In some situations, the power tool 102a may kickback when the output of the power tool 102a becomes bound in a workpiece such that the output remains stationary. In such situations, the torque provided by the rotational inertia of the power tool 102a may overpower the force of the user’s hand or hands on the power tool 102a causing the housing of the power tool 102a to rotate outside of the user’s control. In some embodiments, the electronic processor 305 implements kickback control functionality to prevent or reduce kickback of the power tool 102a based on signals received from one or more of the sensors 220, 335, 340, 345, and 350.

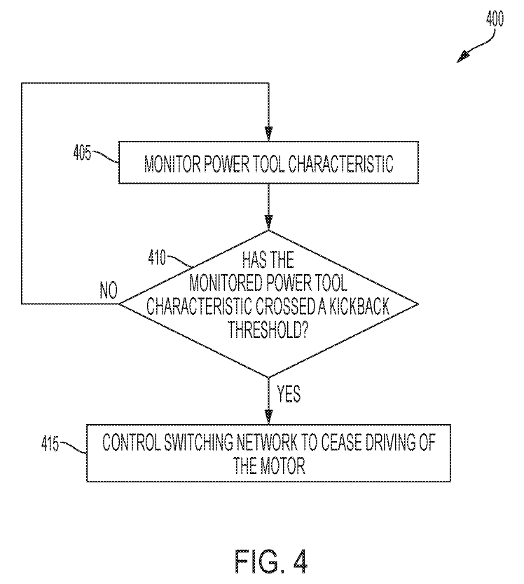

FIG. 4 illustrates a flowchart of an example method 400 of detecting kickback of the power tool 102a and ceasing (e.g., controlling) driving of the motor 330 in response to detecting the kickback. At block 405, the electronic processor 305 monitors a power tool characteristic of the power tool 102a using one or more sensors. For example, the power tool characteristic may be a motor current monitored using the current sensor 340, an angular velocity of a housing of the power tool 102a monitored using the movement sensor 350, a roll position of the power tool 102a directly monitored using the orientation sensor 345 or indirectly monitored using a combination of the orientation sensor 345 and the movement sensor 350, or the like.

In some embodiments, when monitoring the power tool characteristic, the electronic processor 305 may implement a filtering method to filter data received from the sensors to control the accuracy of the received data. For example, the electronic processor 305 may pass data through a low pass filter to remove spikes in data that may be caused by normal tool operation or may be generated due to errors made by the sensor. In other situations, the electronic processor 305 may lessen the effect of the low pass filter or may not implement the low pass filter such that the electronic processor 305 recognizes shorter direction spikes in data received from the sensors. As another example of a filtering method, when signals are received from the movement sensor 350 that indicate movement in multiple directions, the electronic processor 305 may give more weight to movement in a certain direction.

At block 410, the electronic processor 305 determines whether the power tool characteristic has reached a kickback threshold. This determination may indicate whether kickback of the power tool 102a is occurring where the housing of the power tool 102a rotates outside of the user’s control. In some embodiments, the kickback threshold may be a minimum value or a maximum value. For example, in some situations, a decrease in motor current is indicative of a start of kickback or some other loss of control of the power tool 102a by the user. For example, the decrease in motor current may indicate that the user is no longer applying pressure on the power tool 102a toward the workpiece. However, in other situations, an increase in motor current is indicative of a start of kickback (for example, when the power tool 102a encounters a tougher material than the workpiece such as rebar behind a piece of wood). In embodiments where the power tool characteristic is current, the kickback threshold may be a current threshold in Amps or a rate of change in current in Amps per second. In embodiments where the power tool characteristic is angular velocity, the kickback threshold is a rotation speed threshold (e.g., in degrees per second) of the housing of the power tool 102a. In embodiments where the power tool characteristic is roll position, the kickback threshold is a working operating angle range in which the housing of the power tool 102a may rotate before the motor 330 is shut down (e.g., plus-or-minus a number of degrees from an initial roll position or a preferred roll position of the power tool 102a). In embodiments with a different power tool characteristic, the electronic processor 305 uses a kickback threshold corresponding to the different power tool characteristic. In some embodiments, the electronic processor 305 sets the kickback threshold based on the speed of the motor 330. For example, in some embodiments, the method 400 is updated to include a first additional block (e.g., between blocks 405 and 410) for the electronic processor 305 to determine motor speed and a second additional block (e.g., between the first additional block and block 410) for the electronic processor 305 to update the kickback threshold based on the determined motor speed (e.g., using a lookup table mapping motor speeds to thresholds). In one example, as the speed of the motor 330 increases, the kickback threshold is updated to be more sensitive. For example, in embodiments where the power tool characteristic is angular velocity, the electronic processor 305 may use a lower kickback threshold (i.e., higher kickback sensitivity) when the speed of the motor 330 is high than when the speed of the motor 330 is lower. In this example, the kickback threshold changes dynamically based on the speed of the motor 330. In some embodiments, the kickback threshold is set or updated based on the user’s detected hand position. If the force sensors 220 indicate one-handed use, a default kickback threshold is employed. If the force sensors 220 indicate two-handed use or an increased grip strength, the kickback threshold is increased to reduce its sensitivity, since the user is likely to have better tool control with two hands. The kickback threshold may be updated dynamically as changes to the user’s grip are detected by the force sensors 220.

In some embodiments, the electronic processor 305 is configured to utilize two different kickback thresholds. For example, in embodiments where the power tool characteristic is angular velocity and the kickback threshold is a rotation speed threshold of the housing of the power tool 102a, a first rotation speed threshold that is lower (i.e., more sensitive) than a second rotation speed threshold may be utilized by the electronic processor 305. Because kickback of the power tool 102a most often occurs in a direction opposite of the rotation of the motor 330, the electronic processor 305 utilizes the first rotation speed threshold to detect kickback in the direction opposite of the rotation of the motor 330. In some embodiments, the first rotation speed threshold is lower (i.e., more sensitive) than a second rotation speed threshold utilized to detect kickback in the same direction of the rotation of the motor 330. Accordingly, when the forward/reverse selector 219 is actuated to change the rotational direction in which the output driver 210 is driven, the first and second rotation speed threshold correspondingly change such that the kickback threshold is more sensitive and shuts the power tool 102a more quickly based on an angular velocity of the housing of the power tool 102a in a direction opposite of the rotation of the motor 330. For example, when the output driver 210 is rotated in a clockwise direction, it is more likely that kickback of the power tool 102a will occur in a counter-clockwise direction. Therefore, samples indicating an angular velocity in the clockwise direction (which are less likely or unlikely to be a kickback of the power tool 102a) are handled with greater tolerance than samples indicating an angular velocity in the counter-clockwise direction (which are more likely to be a kickback of the power tool 102a). The different rotation speed thresholds depending on the direction of the angular velocity that is measured with respect to the rotational direction of the output driver 210 are intended to reduce nuisance shutdowns, for example, in the use case of operators rotating the tool themselves during operation. In some embodiments, the rotation speed thresholds are adjusted based on motor direction and grip parameters to reduce the relative sensitivity if a two-handed or strong grip is employed.

In some embodiments, the monitored power tool characteristic is the actuation signal from the trigger 212 and the kickback threshold is a predetermined change in the amount of trigger actuation or a predetermined change in the amount of trigger actuation over a predetermined time period (i.e., a speed of trigger release). In such embodiments, the kickback threshold indicates when the trigger 212 has been released to cause the electronic processor 305 to control the switching network 325 to cease driving of the motor 330. For example, the electronic processor 305 may determine that the actuation signal from the trigger 212 has changed such that the trigger 212 is being or has been released by the user. Accordingly, this kickback threshold may be referred to as a trigger release sensitivity of the power tool 102a because it determines how quickly the electronic processor 305 controls the switching network 325 to cease driving the motor 330 in response to changes in position of the trigger 212.

When the electronic processor 305 determines that the monitored power tool characteristic has not reached the kickback threshold (at block 410), the method 400 proceeds back to block 405 to continue monitoring the power tool characteristic. When the electronic processor 305 determines that the monitored power tool characteristic has reached the kickback threshold, at block 415, the electronic processor 305 controls the switching network 325 to cease driving of the motor 330. For example, the electronic processor 305 may prevent the switching network 325 from supplying power to the motor 330, may stop the motor 330 using active braking, or may cease driving of the motor 330 in another manner.

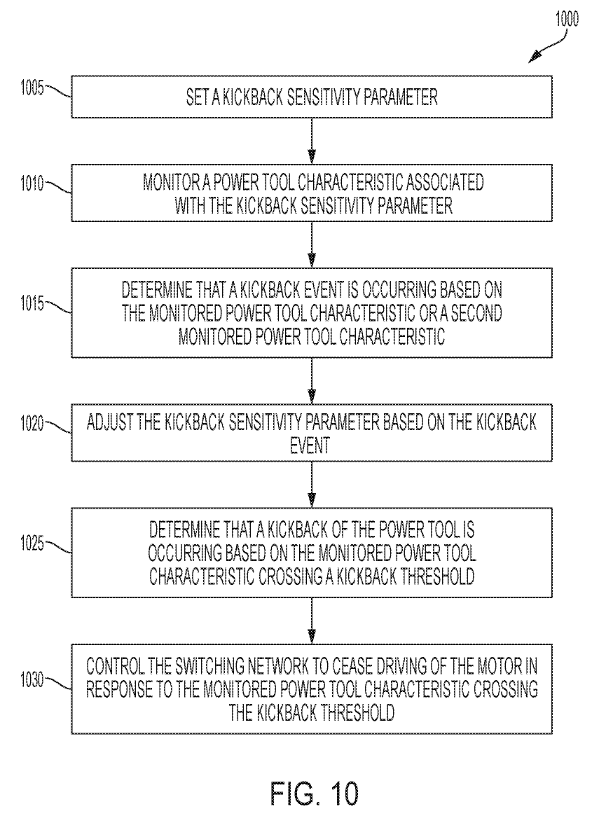

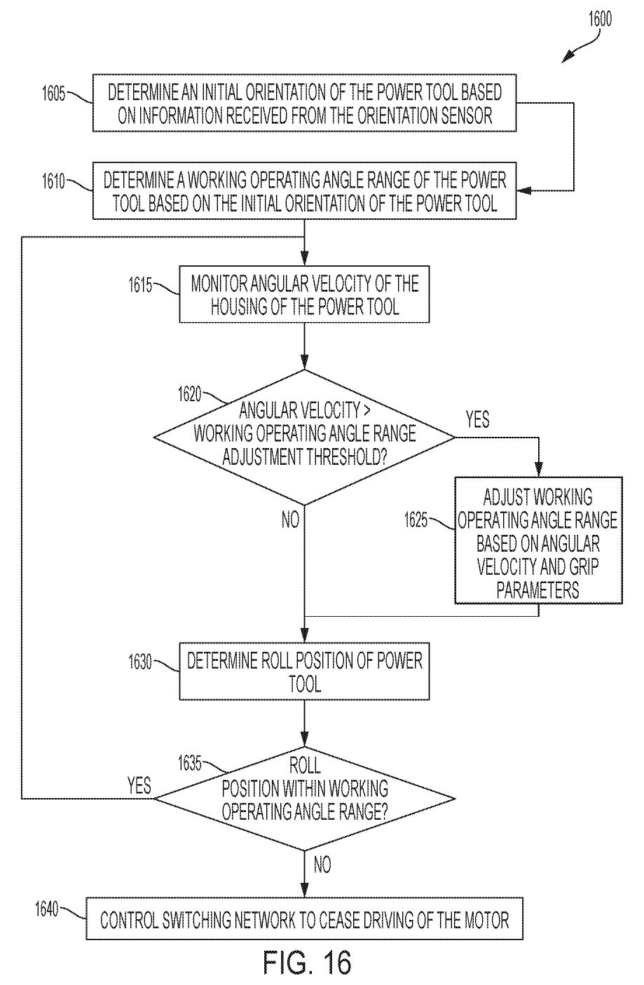

Although the method 400 is described above with respect to one power tool characteristic, in some embodiments, the electronic processor 305 monitors a plurality of power tool characteristics and compares each of the monitored power tool characteristics to a respective kickback threshold. In some of these embodiments, the electronic processor 305 controls the switching network 325 to cease driving of the motor 330 in response to a predetermined number of the plurality of power tool characteristics reaching their respective kickback thresholds. In some embodiments, when a first monitored power tool characteristic (e.g., motor current) reaches its respective kickback threshold (e.g., decreases below a low current threshold), the electronic processor 305 begins monitoring a second power tool characteristic (e.g., angular velocity of the power tool 102a). In such embodiments, when the second power tool characteristic reaches its respective threshold (e.g., increases above a rotation speed threshold), the electronic processor 305 controls the switching network 325 to cease driving of the motor 330. Additionally, in some embodiments, the electronic processor 305 monitors a plurality of power tool characteristics and adjusts at least one kickback sensitivity parameter based on at least one of the monitored power tool characteristics (e.g., see FIGS. 10 and 16 and corresponding explanation below). In some embodiments, by comparing a plurality of measurements of power tool characteristics to their respective kickback thresholds allows the electronic processor 305 to detect kickback of the power tool 102a and shuts down the motor 330 but also prevent nuisance shutdowns of the motor 330 (i.e., preventing frequent shutdown of the motor 330 when the user still has control of the power tool 102a). For example, the electronic processor shuts down the motor 330 in response to multiple measurements of a single power tool characteristic exceeding its respective kickback threshold or measurements of multiple power tool characteristics exceeding their respective kickback thresholds. In other words, in some embodiments, a single measurement of a power tool characteristic that exceeds its kickback threshold may not cause the electronic processor 305 to cease driving the motor 330 and, accordingly, may improve operator experience by preventing nuisance shutdowns of the motor 330.

FIG. 15A illustrates a flowchart of another method of detecting kickback of the power tool 102a and ceasing driving of the motor 330 in response to detecting the kickback. The method 1500 allows the electronic processor 305 to detect kickback of the power tool 102a when the angular velocity of the housing of the power tool 102a has exceeded a rotation speed threshold a predetermined number of times within a time period. However, in some embodiments, the electronic processor 305 may monitor a different power tool characteristic to determine when a different power tool characteristic exceeds a respective kickback threshold a predetermined number of times within a time period. In some embodiments, the time period is a predetermined time period (for example, 250 milliseconds, 500 milliseconds, one second, or the like). In other embodiments, the time period is not predetermined and instead the time period lasts for as long as the trigger 212 is actuated and the power tool 102a is running. In other words, the counter explained below with respect to FIG. 15A may rise and fall for as long as the power tool 102a is running and may reset when the trigger 212 is released. In such embodiments, the method 1500 allows the electronic processor 305 to detect kickback of the power tool 102a by a threshold crossing of a leaky accumulator augmented in response to the angular velocity of the housing of the power tool 102a exceeding a rotation speed threshold. Additionally, in some embodiments, the leaky accumulator acts as a leaky accumulator of some function of rotational speed or some other power tool characteristic whereby kickback is detected upon the leaky accumulator being augmented above an associated threshold for the other power tool characteristic. Similarly, a leak rate of leaky accumulator may not be constant and may be set by the electronic processor 305 as a function of a power tool characteristic. In some embodiments, a leaky accumulator, as described herein, may be a function implemented by the electronic processor 305.

At block 1505, the electronic processor 305 monitors an angular velocity of the housing of the power tool 102a (e.g., using information received from the movement sensor 350). At block 1510, the electronic processor 305 determines whether the angular velocity is greater than a rotation speed threshold. When the angular velocity is greater than the rotation speed threshold, the method 1500 proceeds to block 1515 where the electronic processor 305 determines whether a counter is greater than a counter threshold. When the counter is not greater than the counter threshold, the method 1500 proceeds to block 1520 where the electronic processor 305 increments the counter by one because the angular velocity has exceeded the rotation speed threshold. Then the method 1500 proceeds back to block 1505 to continue monitoring the angular velocity of the housing of the power tool 102a. In some embodiments, before proceeding back to block 1505, the electronic processor 305 may delay a predetermined time period in order to sample angular velocity data from the movement sensor 350 at predetermined intervals. In some embodiments, the predetermined time period that defines a sampling rate of angular velocity data from the movement sensor 350 is dynamically determined by the electronic processor 305 based on another power tool characteristic (for example, based on the orientation of the power tool 102a or the grip parameters).

When the angular velocity is not greater than the rotation speed threshold (at block 1510), the method 1500 proceeds to block 1525 where the electronic processor 305 determines whether the counter is equal to zero. When the counter is equal to zero, the method 1500 proceeds back to block 1505 to continue monitoring the angular velocity of the housing of the power tool 102a. When the counter is not equal to zero, at block 1530, the electronic processor 305 decrements the counter by one because the angular velocity is not greater than the rotation speed threshold. Then, the method 1500 proceeds back to block 1505 to continue monitoring the angular velocity of the housing of the power tool 102a. In some embodiments, before proceeding back to block 1505, the electronic processor 305 may delay a predetermined time period in order to sample angular velocity data from the movement sensor 350 at predetermined intervals. As mentioned above, in some embodiments, the predetermined time period that defines a sampling rate of angular velocity data from the movement sensor 350 is dynamically determined by the electronic processor 305 based on another power tool characteristic (for example, based on the orientation of the power tool 102a or the grip parameters).

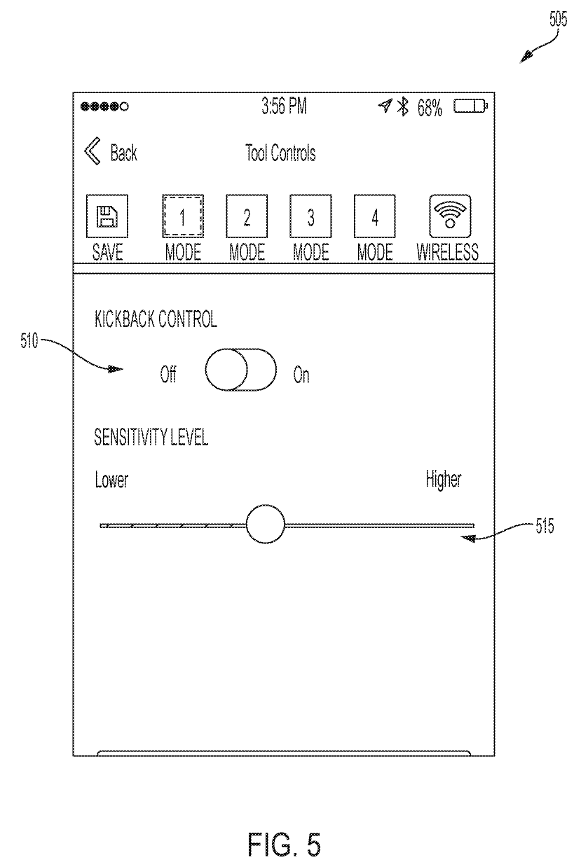

When the counter is greater than the counter threshold (at block 1515), the method 1500 proceeds to block 1535 where the electronic processor 305 controls the switching network 325 to cease driving of the motor 330. Accordingly, the method 1500 allows the electronic processor 305 to detect kickback of the power tool 102a when the angular velocity of the housing of the power tool 102a has exceeded a rotation speed threshold a predetermined number of times within a time period as defined by the counter threshold. In other words, with reference to the explanation of a leaky accumulator above, the method 1500 allows the electronic processor 305 to detect kickback of the power tool 102a when the angular velocity of the housing of the power tool 102a has augmented a leaky accumulator above some threshold. In some embodiments, the rotation speed threshold, the counter threshold, and the time delay between monitored samples of the angular velocity may be referred to as kickback sensitivity parameters that may be adjusted to refine kickback control of the power tool 102a in accordance with other portions of this application. For example, one or more of the rotation speed threshold, the counter threshold, and the time delay may be adjusted by a user via an external device 108 (see FIG. 5). In some embodiments, one or more of the rotation speed threshold, the counter threshold, and the time delay may be adjusted based on the grip parameters. The power tool 102a then receives one or more of these kickback sensitivity parameters from the external device 108, and the electronic processor 305 executes the method 1500 using the values of the received kickback sensitivity parameters. For example, the lower the rotation speed threshold, the counter threshold, and the time delay, the more sensitive the kickback control. Higher, less sensitive kickback control may be employed if the user adopts a two-handed or strong grip, as detected by the force sensors 220. As noted above, in some embodiments, the electronic processor 305 executes the method 1500 as the power tool 102a is running and may reset the counter when the trigger 212 is released or when a predetermined time period elapses. For example, an additional conditional block may be added before looping back to block 1505 in which the electronic processor 305 determines whether the predetermined time period has elapsed, the trigger has been released, or both, and, when true, resets the counter to zero. Further, when the trigger has been released and the counter is reset, the processor may cease running the method 1500 until the next trigger pull.

In some embodiments, the method 1500 detects kickback of the power tool 102a and shuts down the motor 330 but also prevents nuisance shutdowns of the motor 330 (i.e., preventing frequent shutdown of the motor 330 when the user still has control of the power tool 102a). For example, through use of the counter, the method 1500 shuts down the motor 330 in response to multiple measurements of the angular velocity of the housing of the power tool 102a exceeding the rotation speed threshold. In other words, in some embodiments, a single measurement of angular velocity that exceeds the rotation speed threshold may not cause the electronic processor 305 to cease driving the motor 330 and, accordingly, may improve operator experience by preventing nuisance shutdowns of the motor 330.

As mentioned above, in some embodiments, the electronic processor 305 monitors a plurality of power tool characteristics and adjusts at least one sensitivity parameters based on at least one monitored power tool characteristic. For example, FIG. 15B is a flowchart of another method 1550 of detecting particular operation of the power tool 102a and ceasing driving of the motor 330 in response to detecting the operation. FIG. 15B is described with respect to detecting a loss of control event of the power tool 102a. As used herein, “loss of control” may be a state in which the tool enters a bind event that causes excess rotation of the power tool 102a due to the user not providing enough counter torque on the power tool 102. A “loss of control” event, when detected, can be prevented by braking the motor of the power tool 102, which prevents the tool from over rotating.

Similar to the method 1500, the method 1550 is performed during operation of the motor 330 (i.e., while the power tool 102a is running or being operated or used) and includes detecting loss of control of the power tool 102a when a power tool characteristic, such as, for example, the angular velocity of the housing, of the power tool 102a exceeds a threshold (e.g., a rotational speed threshold) a predetermined number of times within a time period. While the method 1550 is described with respect to detecting loss of control based on the angular velocity of the housing, the method 1550 can similarly be used with one or more other power tool characteristics to detect loss of control of the power tool 102a.

In some embodiments, the time period (during which a count is maintained of how many times the power tool characteristic exceeds the associated threshold) is a predetermined time period (for example, 250 milliseconds, 500 milliseconds, one second, or the like). In other embodiments, the time period is not predetermined and instead the time period lasts for as long as the trigger 212 is actuated and the power tool 102a is running. In other words, a value of the counter explained below with respect to FIG. 15B (similar to the counter explained with respect to FIG. 15A) may rise and fall for as long as the power tool 102a is running and may reset when the trigger 212 is released. In such embodiments, the method 1550 allows the electronic processor 305 to detect loss of control of the power tool 102a by a threshold crossing of a leaky accumulator augmented in response to the angular velocity of the housing of the power tool 102a exceeding a rotation speed threshold (an angular velocity threshold). Additionally, in some embodiments, the leaky accumulator acts as a leaky accumulator of some function of rotational speed or some other power tool characteristic whereby loss of control is detected upon the leaky accumulator being augmented above an associated threshold for the other power tool characteristic. Similarly, a leak rate of leaky accumulator may not be constant and may be set by the electronic processor 305 as a function of a power tool characteristic. In some embodiments, a leaky accumulator, as described herein, may be a function implemented by the electronic processor 305.

As illustrated in FIG. 15B, at block 1555, the electronic processor 305 monitors a power tool characteristic (e.g., angular velocity of the housing) of the power tool 102a using information from one or more sensors or components of the power tool 102a (e.g., using information received from the movement sensor 350). At block 1560, the electronic processor 305 determines whether the monitored power tool characteristic exceeds an associated threshold (e.g., a rotation speed threshold). When the power tool characteristic exceeds the associated threshold, the method 1550 proceeds to block 1565 where the electronic processor 305 increments a counter. In some embodiments, the rate at which the electronic processor 305 increments the counter varies based on how much the power tool characteristic exceeds the associated threshold (e.g., using a function or a look-up table or table).

Alternatively or in addition, the electronic processor 305 uses a plurality of thresholds to increment the counter, where each of the plurality of thresholds is associated with a respective increment rate and at least one of the plurality of thresholds may be associated with an increment rate different than the increment rate associated with another one of the plurality of thresholds. For example, the plurality of thresholds may include a first threshold and a second threshold, wherein the first threshold is higher than the second threshold and the increment associated with the first threshold is greater than the increment associated with a second threshold. Accordingly, in this implementation, the electronic processor 305 determines the highest threshold of the plurality of thresholds that the monitored power tool characteristic exceeds and increments the counter according to the increment rate associated with that threshold.

For example, FIG. 15C illustrates multiple example rotation speed thresholds 1567 (referred to as “angular velocity increment thresholds”) that may be used when the monitored power tool characteristic is an angular velocity of the housing (see y-axis in FIG. 15C). Each of the thresholds 1567 may have an associated increment rate such that angular velocities exceeding higher thresholds result in a greater increment to the counter as compared to angular velocities exceeding lower thresholds. It should be understood that any number of thresholds 1567 can be used and various increment rates may be associated with each of the thresholds.

When the monitored power tool characteristic is not greater than any of the associated thresholds (at block 1560), the method 1550 proceeds to block 1570 where the electronic processor 305 may optionally decrement the counter. Similar to the different increment rates of the counter described above when the monitored power tool characteristic is greater than the associated threshold, the electronic processor 305 may be configured to decrement the counter at one or more decrement rates depending on how much the monitored power tool characteristic is less than the rotation speed threshold (e.g., using a function or a look-up table or table).

Alternatively, or in addition, the electronic processor 305 may use a plurality of thresholds when decrementing the counter, where each of the plurality of thresholds is associated with a respective decrement rate. For example, FIG. 15C illustrates multiple example rotation speed thresholds 1572 that may be used when the monitored power tool characteristic is angular velocity of the housing (referred to as “angular velocity reduction thresholds” in FIG. 15C). Each of the thresholds 1572 may have an associated decrement rate such that angular velocities exceeding higher thresholds result in a greater decrement to the counter as compared to angular velocities exceeding lower thresholds. It should be understood that any number of thresholds 1572 can be used and various increment rates may be assigned to each of the thresholds.

Accordingly, similar to the thresholds for incrementing the counter, at least one of the plurality of thresholds 1572 may be associated with a decrement rate different than the decrement rate associated with another one of the plurality of thresholds 1572. For example, as illustrated in FIG. 15C, the plurality of thresholds 1572 may include a first threshold 1573 and a second threshold 1576 , wherein the first threshold 1573 is higher than the second threshold 1576 and the decrement associated with the first threshold 1573 is greater than the decrement associated with a second threshold 1576. Accordingly, in this implementation, the electronic processor 305 determines the highest threshold of the plurality of thresholds that the angular velocity (see, e.g., line 1577 in FIG. 15C representing measured angular velocity over time) exceeds and decrements the counter according to the increment rate associated with that threshold. In other words, if angular velocity exceeds the angular velocity reduction thresholds, then the rate at which the leaky accumulator decrements will increase.

As illustrated in FIG. 15C, when the monitored power tool characteristic is angular velocity, a “higher” and “lower” threshold may refer to a velocity magnitude in a particular direction, wherein one direction may be measured as a positive velocity and the other direction may be measured as a negative velocity. In some implementations, such as when the monitored power tool characteristic is angular value, the incrementing thresholds are in a rotational direction expected when loss of control occurs, and the decrementing thresholds are in an opposite rotational direction.

In should be understood that the electronic processor 305 may be configured to apply an initial rotation speed threshold (e.g., zero) to determine whether the counter should be incremented or decremented and then may determine an amount to increment or decrement the counter, or, alternatively, the electronic processor 305 may be configured to determine the highest threshold (from a plurality of thresholds 1567 and 1572) that the angular velocity exceeds and either increment or decrement the counter based on whether the determined threshold is associated with an increment rate or a decrement rate. In some embodiments, the electronic processor 305 may also be configured to decrement the counter only to a zero value and may not decrement the counter to a negative value. However, in other embodiments, the electronic processor 305 may be configured to decrement the counter to a negative value (e.g., continuously decrement the counter or decrement the counter to an established negative limit).

Although method 1550 illustrates incrementing or decrementing a counter on each cycle, in some embodiments, depending on the monitored power tool characteristic, a value of a counter may be retained (e.g., the increment or decrement rate may be set to zero). Accordingly, it is not required that the counter value change on each cycle of the method 1550.

After incrementing the counter at block 1565 or decrementing the counter at block 1570, the electronic processor 305 determines a counter threshold (also referred to herein as an auto-stop trip threshold) (at block 1574) and compares the value of the counter to the auto-stop trip threshold to determine whether the counter value exceeds the trip threshold (at block 1575). In response to the counter value exceeding the trip threshold, the electronic processor 305 triggers an auto-stop function or event, which stops the motor (through controlling the switching network 325 to cease driving of the motor 330) (at block 1580).

The auto-stop trip threshold may be a static value or may be dynamically adjusted. For example, in the method 1550, the auto-stop trip threshold may be dynamically adjusted based on one or more power tool characteristics (e.g., different from the power tool characteristic used to increment and decrement the counter). Accordingly, as illustrated in FIG. 15B, because the auto-stop trip threshold varies, the counter value may be compared to the dynamically-adjusted auto-stop trip threshold regardless of whether the counter was incremented or decremented (e.g., as the auto-stop trip threshold may be decreased such that even a decremented counter may now exceed the trip threshold). Given the variability of the auto-stop trip threshold, the auto-stop trip threshold may also be determined and compared to the counter value at various times during execution of the method 1550. Also, it should be understood that the electronic processor 305 may be configured to determine the auto-stop trip threshold or the auto-stop trip threshold may be determined by a separate controller or electronic processor or a separate module (executable instructions) executed by the electronic processor 305, which may be configured to determine (e.g., repeatedly) the auto-stop trip threshold. In this configuration, the electronic processor 305 is configured to obtain the auto-stop trip threshold as determined by this separate component or process (e.g., from memory, via a data stream or communication with the separate component or process, or the like) and compare the obtained threshold to the counter value as described herein.

For example, in some implementations, the auto-stop trip threshold is dynamically set based on motor current, motor speed (e.g., RPM or RPM droop), or a combination thereof. When the power tool 102a binds, motor speed (RPM) drops rapidly and current increases. Accordingly, motor current, motor speed (RPM or RPM droop), or the combination thereof can be used to set the auto-stop trip threshold value.

As illustrated in FIG. 15D, the auto-stop trip threshold can vary between a minimum auto-stop trip threshold 1577 and a maximum auto-stop trip threshold 1578, and within this range, may be set based on detected motor current (see x-axis in FIG. 15D representing different current values). For example, as illustrated in FIG. 15D, the auto-stop trip threshold may be set using a linear relationship with motor current, such that, as motor current increases, the value of the auto-stop trip threshold decreases until it reaches the minimum auto-stop trip threshold 1577. Similarly, using this linear relationship, as motor current decreases, the value of the auto-stop threshold increases until it reaches the maximum auto-stop trip threshold 1578. It should be understood that other types of relationships and functions may be used to vary the value of the auto-stop trip threshold based on motor current (e.g., an exponential relationship).

Accordingly, in some examples, the electronic processor 305 uses the measured motor current (e.g., as obtained from the current sensor 340) to set the auto-stop trip threshold to a value between the minimum and maximum auto-stop trip thresholds 1577, 1578, and compares the counter value to this dynamically set auto-stop trip threshold at block 1575. When the counter is not greater than the dynamically set auto-stop trip threshold, the method 1550 proceeds back to block 1555 to continue monitoring the power tool characteristic and incrementing and decrementing the counter accordingly as described above. In some embodiments, before proceeding back to block 1555, the electronic processor 305 may delay a predetermined time period in order to sample or measure the monitored power tool characteristic at predetermined intervals. As mentioned above, in some embodiments, the predetermined time period that defines a sampling rate of the monitored power tool characteristic is dynamically determined by the electronic processor 305 based on another power tool characteristic (for example, based on the orientation of the power tool 102a or the grip parameters).

As also noted above, in some embodiments, the electronic processor 305 executes the method 1550 as the power tool 102a is running (i.e., the motor 330 is operating) and may reset the counter when the trigger 212 is released or when a predetermined time period elapses. For example, an additional conditional block may be added before looping back to block 1505 in which the electronic processor 305 determines whether the predetermined time period has elapsed, the trigger has been released, or both, and, when true, resets the counter to zero. Further, when the trigger has been released and the counter is reset, the electronic processor 305 may cease running the method 1550 until the next trigger pull.

When the counter is greater than the dynamically set auto-stop trip threshold (at block 1575), the method 1550 proceeds to block 1580 where the electronic processor 305 controls the switching network 325 to cease driving of the motor 330. Accordingly, the method 1550 allows the electronic processor 305 to detect loss of control of the power tool 102a when the monitored power tool characteristic (e.g., angular velocity of the housing) of the power tool 102a has exceeded one or more associated thresholds a predetermined number of times within a time period as defined by the dynamically set auto-stop trip threshold. In other words, with reference to the explanation of a leaky accumulator above and using angular velocity as the monitored power tool characteristic, the method 1550 allows the electronic processor 305 to detect loss of control of the power tool 102a when the angular velocity of the housing of the power tool 102a has augmented a leaky accumulator above the dynamically set threshold.

The dynamic nature of the auto-stop threshold addresses nuisance stops while quickly detecting and reacting to loss of control events. For example, when a rotary hammer power tool is operated in an impact-only mode, the rotary hammer may experience nuisance trips of the auto-stop feature described above for loss of control events. One solution to this problem is to disable loss of control detecting when the power tool is operated in impact only mode. However, disabling this detection means that loss of control is not detected or addressed. Another solution is to increase the auto-stop trip threshold in this operating mode. Increasing the auto-stop trip threshold, however, increases the time before a true loss of control event is detected and auto-stop is triggered. Using a dynamic auto-stop trip threshold as described above addresses both of these concerns, as the auto-stop trip threshold is adjusted based on risk of a true loss of control event occurring – as determined based on one or more power tool characteristics, such as motor current.

FIG. 15E similarly illustrates how the auto-stop trip threshold can vary between a minimum auto-stop trip threshold 1581 and a maximum auto-stop trip threshold 1582 (which may be the same thresholds as illustrated in FIG. 15D or different thresholds) and, within this range, may be set based on detected motor speed, or, in particular, RPM droop (see x-axis in FIG. 15E representing different RPM droop values). As illustrated in FIG. 15E, the auto-stop trip threshold may be set using a linear relationship with RPM droop, such that, as RPM droop increases, the value of the auto-stop threshold decreases until it reaches the minimum auto-stop trip threshold 1581. Similarly, using this linear relationship, as RPM droop decreases, the value of the auto-stop threshold increases until it reaches the maximum auto-stop trip threshold 1582. It should be understood that other types of relationships and functions may be used to vary the value of the auto-stop trip threshold based on RPM droop (e.g., an exponential relationship, a quadratic relationship, or the like).

Accordingly, in some examples, the electronic processor 305 uses measured RPM droop (e.g., as determined based on measured data from the one or more Hall sensors 335) to set the auto-stop trip threshold to a value between the minimum and maximum thresholds and compares the counter value to this dynamically set threshold at block 1575. When the counter is not greater than the dynamically set auto-stop trip threshold, the method 1550 proceeds back to block 1555 to continue monitoring the power tool characteristic and incrementing and decrementing the counter accordingly as described above. When the counter is greater than the dynamically set auto-stop trip threshold (at block 1575), the method 1550 proceeds to block 1580 where the electronic processor 305 controls the switching network 325 to cease driving of the motor 330.

In some embodiments, both motor current and RPM droop are used to dynamically set the auto-stop trip threshold. For example, a value for the auto-stop trip threshold may be determined for both motor current and RPM droop using the linear relationships illustrated in FIGS. 15D and 15E and these two values may be used to set the auto-stop trip threshold. In some embodiments, the lower of the two values may be used to set the auto-stop trip threshold. In other embodiments, the values may be averaged (e.g., using a standard average or a weighted average), summed, or the like to set the auto-stop threshold. Accordingly, by dynamically setting the auto-stop trip threshold based on both motor current and RPM droop, the auto-stop trip threshold is scaled based on the risk of a true loss of control event using indicators of whether such an event is occurring.

FIGS. 15F-1 and 15F-2 illustrate using both motor current and RPM droop to dynamically set the auto-stop trip threshold. As illustrated in example of FIG. 15F, the graphs (A), (B), and (C) are aligned in time. Graph (A) illustrates example angular velocity values measured over time (see line 1577) and various thresholds (1567 and 1572) compared to the angular velocity values to determine counter increments and decrements. Graph (C) illustrates example values of the counter (incremented and decrement based on the example angular velocity values represented in line 1577 and associated thresholds 1567 and 1572 represented in Graph (A)) during the same time period as represented in Graph (A). Graph (C) also illustrates the value of an auto-stop trip threshold 1586. As illustrated in Graph (C), the auto-stop trip threshold 1586 dynamically varies between a maximum auto-stop trip threshold 1587 value and a minimum auto-stop trip threshold 1588 during the time period.

Graph (B) illustrates motor current values (see line 1590) and RPM droop values (see line 1592) over the same time period as represented in Graph (A).

As illustrated in Graph (D) of FIG. 15F-2, motor current values (from line 1590) are mapped (e.g., using a linear relationship as represented in Graph (D)) to auto-stop trip threshold values between the maximum and minimum auto-stop trip thresholds 1578, 1577. Similarly, as illustrated in Graph (E) of FIG. 15F-2, RPM droop values (from line 1592) are mapped (e.g., using a linear relationship as represented in Graph (E)) to auto-stop trip threshold values between the maximum and minimum auto-stop trip thresholds 1582, 1581. The mapped values for both motor current and RPM droop (which may be calculated at the same time intervals as the counter increments and decrements) are compared and the lower of the two threshold values is used to set the auto-stop trip threshold, which is compared to the value of the counter to determine whether an auto-stop event or function should be triggered (e.g., if the counter value exceeds the auto-stop trip threshold).

Accordingly, as illustrated in FIGS. 15F-1 and 15F-2, low motor current and RPM droop can indicate a low likelihood of a loss of control event, and, thus, the auto-stop trip threshold can be set high (e.g., at or close to the maximum value, which may be set as a default value). In contrast, a high motor current or a high RPM droop can indicate a high likelihood of a loss of control event, and, thus, the auto-stop trip threshold can be reduced due to either a high motor current or a high RPM droop. For example, as illustrated in FIG. 15F-1, at time T, the motor current value passes a maximum current mapping (meaning that the motor current value at time T is mapped to the minimum auto-stop trip threshold 1577 value), while the RPM droop value is still under the maximum RPM droop mapping (meaning that the RPM droop value at time T is not mapped to the minimum auto-stop trip threshold 1581 value but a value greater than the minimum value). In this situation, the auto-stop trip threshold associated with the motor current value, as the lower threshold value, is used to set the auto-stop trip threshold, which effectively reduces the auto-stop trip threshold value and means a loss of control event can be triggered quicker than if the auto-stop trip threshold was not reduced or kept at the maximum threshold value.

In other words, as illustrated in Graph (C) of FIG. 15F-1, the reduction in the auto-stop trip threshold (set based on the high motor current value) means that a loss of control event is triggered based on the value of the counter at time T, whereas such an event would not have been triggered if the auto-stop threshold had been retained at a higher value. Also, as the auto-stop trip threshold is only reduced when motor current or RPM droop reach particular values, nuisance motor stops are avoided as compared to using the minimum auto-stop trip threshold 1588 in a static manner. For example, as illustrated in Graph (C), using the minimum auto-stop trip threshold 1588 as a static value would have resulted in a nuisance stop at time N, which is avoided through the use of the dynamically-adjusted auto-stop trip threshold.

Accordingly, the method 1550 detects loss of control events of the power tool 102a and shuts down the motor 330 but also prevents nuisance shutdowns of the motor 330 (i.e., preventing frequent shutdown of the motor 330 when the user still has control of the power tool 102a). For example, through use of the counter, the method 1550 shuts down the motor 330 in response to multiple measurements of the monitored power tool characteristic (e.g., angular velocity of the housing) of the power tool 102a exceeding one or more associated thresholds. In other words, in some embodiments when angular velocity is the monitored power tool characteristic, a single measurement of angular velocity that exceeds the rotation speed threshold may not cause the electronic processor 305 to cease driving the motor 330 and, accordingly, operator experience is improved by preventing nuisance shutdowns of the motor 330. Similarly, through the use of the dynamically-adjusted auto-stop threshold, nuisance shutdowns of the motor 330 are avoided by keeping the auto-stop trip threshold high when motor current, RPM droop, or one or more other operating conditions indicate that a loss of control event is unlikely, while reducing the auto-stop trip threshold when motor current, RPM droop, or one or more other operating conditions indicate that a loss of control event is likely, which allows a loss of control event to be quickly detected and addressed.

As noted above, the motor current and motor speed (e.g., RPM and/or RPM droop) can be used independently or in combination to dynamically adjust the auto-stop trip threshold. It should also be understood that other motor characteristics could be used, such as, for example, motor temperature, vibration, or the like. Furthermore, in some embodiments, other characteristics of the power tool (e.g., different from the characteristic used to increment or decrement the counter) may be used to set the auto-stop trip threshold. For example, in some embodiments, battery pack characteristics (e.g., voltage, state of charge, etc.) may be used to set the auto-stop trip threshold – separate from in combination with motor characteristics. Furthermore, an amount of change in any of the above-mentioned characteristics may be used to set the auto-stop trip threshold (e.g., a change in current, change in RPM or RPM droop, change in temperature, change in voltage, etc.). Also, in some embodiments, the relationship may be defined via a machine-learned model that may be trained using various characteristics (e.g., one or more motor characteristics, power tool characteristics (e.g., battery voltage), or the like) and historical or simulated loss of control events to output a corresponding auto-stop trip threshold value based on various inputs. For example, in some implementation, the machine-learned (ML) model may be trained to output a “yes” or “no” (or similar binary output) to indicate whether a loss of control event has been detected. The power tool 102a would then use this output to determine if the motor should continue running or should be braked. As noted, the model may use various inputs, such as, for example, battery voltage, battery current, RPM, trigger pull percentage, accelerometer/gyroscope data, or a combination thereof.

Aspects of the dynamically-set auto-stop trip threshold may be configurable. For example, through one or more user interfaces or communication with the power tool 102a via a remote device, various factors of the method 1550 may be adjusted (e.g., by a user). These factors may include (a) the timestep used in the method 1550 for monitoring the power tool characteristics (e.g., angular velocity), (b) the thresholds used to determine whether to increment or decrement the counter, (c) the increment and decrement rates for the counter (d), (e) the characteristics used by the electronic processor 305 to set the auto-stop threshold, (f) the minimum and/or maximum threshold value of the auto-stop trip threshold, (f) weighting of threshold values used by the processor 305 to set the auto-stop threshold, or a combination thereof. In some embodiments, through one or more user interfaces or communication with the power tool 102 via a remote device, the dynamic auto-stop threshold may be turned on and off. In addition, the power tool 102a may include one or more indicators, controllable, for example, by the electronic processor 305, to inform a user when the dynamically-set auto-stop trip threshold is turned on, when the dynamically-set auto-stop trip threshold has been set lower than the maximum threshold value or is at or within a predetermined range of the minimum threshold value, or the like. Similarly, such indicators may be used to inform the user when a loss of control event has been detected.

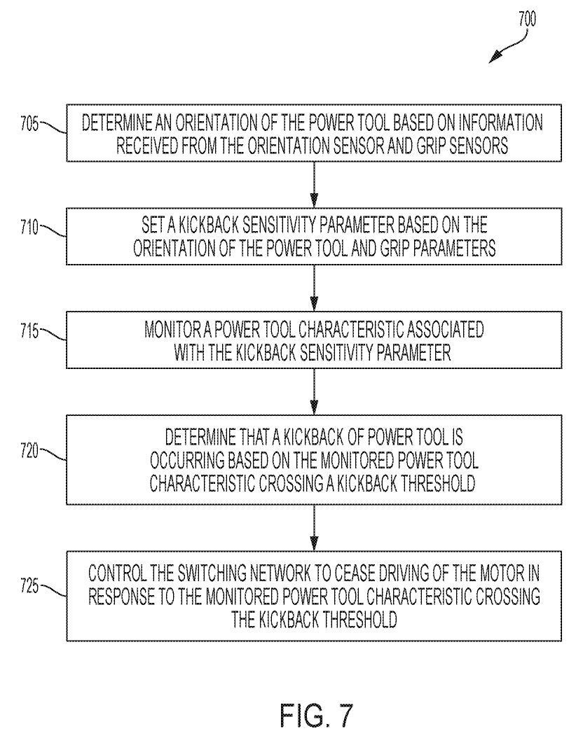

As mentioned above, in some embodiments, the electronic processor 305 monitors a plurality of power tool characteristics and adjusts at least one kickback sensitivity parameter based on at least one of the monitored power tool characteristics. FIG. 16 illustrates a flowchart of an example method 1600 of detecting kickback of the power tool 102a where the method 1600 adjusts a working operating angle range (i.e., a kickback sensitivity parameter) based on a monitored angular velocity of the housing of the power tool 102a (i.e., a monitored power tool characteristic). The method 1600 allows the electronic processor 305 to detect kickback of the power tool 102a when the roll position of the power tool 102a is outside a working operating angle range that is updated based on the angular velocity of the housing of the power tool 102a. Some of the blocks of the method 1600 are similar to blocks from other methods explained below (e.g., FIGS. 7 and 10).

Blocks 1605 and 1610 of FIG. 16 are similar to blocks 705 and 710 of FIG. 7 explained below. At block 1605, the electronic processor 305 determines an initial orientation of the power tool 102a based on information received from the orientation sensor 345 when the trigger 212 is actuated. In some embodiments, the initial position also includes the grip parameters detected by the force sensors 220. In some embodiments, the electronic processor 305 sets the initial orientation to correspond to an initial roll position of zero. At block 1610, the electronic processor 305 determines a working operating angle range of the power tool 102a based on the initial orientation of the power tool 102a. For example, when the pitch of the power tool 102a indicates that the power tool 102a is facing upward (i.e., in the vertically upward orientation 610 of FIG. 6), the user may be drilling overhead and/or standing on a ladder or scaffolding such that they may have less control of the power tool 102a. Accordingly, when the electronic processor 305 determines that the output driver 210 of the power tool 102a is facing upward, the electronic processor 305 may set a working operating angle range of the power tool 102a to be small (e.g., plus-or-minus fifteen degrees from the initial roll position) such that driving of the motor 330 ceases when less kickback is sensed (i.e., higher kickback sensitivity). The kickback sensitivity may be decreased for a two-handed grip relative to a one-handed grip or for a strong grip relative to a weaker grip (e.g., grip strength based on a value for the force applied to a force sensor 220). Additional examples of setting a kickback sensitivity parameter such as the working operating angle range based on the orientation of the power tool 102a are explained below with respect to blocks 705 and 710 of FIG. 7.

At block 1615, the electronic processor 305 monitors angular velocity of the housing of the power tool 102a using the movement sensor 350. At block 1620, the electronic processor 305 determines whether the angular velocity of the housing of the power tool 102a is greater than a working operating angle range adjustment threshold. In some embodiments, an angular velocity above the working operating angle range adjustment threshold may indicate that the user is beginning to lose control of the power tool 102a (i.e., a near kickback event as described below with respect to FIG. 10). Accordingly, when the angular velocity is above the working operating angle range adjustment threshold, at block 1625, the electronic processor 305 adjusts the working operating angle range based on the angular velocity and/or the grip parameters. For example, the user may change from a one-handed grip to a two-handed grip or the user may grip the power tool 102a harder if the user starts to lose control of the power tool 102a. The working operating angle range may be adjusted dynamically if a change in grip parameters is detected by the force sensors 220.

Continuing the above example, the electronic processor 305 may reduce the working operating angle range from plus-or-minus fifteen degrees from the initial roll position of the power tool 102a to plus-or-minus ten degrees from the initial roll position of the power tool 102a. In other words, the electronic processor 305 increases kickback sensitivity by decreasing the range of roll positions in which the power tool 102a is able to rotate without the motor 330 being shut down due to detection of kickback. After the working operating angle range is adjusted, the method 1600 proceeds to block 1630. At block 1620, when the angular velocity is not greater than the working operating angle range adjustment threshold, the method 1600 proceeds to block 1630 without adjusting the working operating angle range. In other words, the working operating angle range remains unchanged because the angular velocity measurement indicates that the housing of the power tool 102a is not rotating or is rotating slowly, and the user is not likely losing control of the power tool 102a.

At block 1630, the electronic processor 305 determines the current roll position of the power tool 102a. As described above, the electronic processor 305 may determine the roll position of the power tool 102a either directly or indirectly. At block 1635, the electronic processor 305 determines whether the roll position of the power tool 102a is within the working operating angle range. When the roll position is within the working operating angle range, the method 1600 proceeds back to block 1615 to continue to monitor the angular velocity of the housing of the power tool 102a. When the roll position is not within the working operating angle range (i.e., when the housing of the power tool 102a has rotated outside of the working operating angle range), at block 1640, the electronic processor controls the switching network 325 to cease driving of the motor 330.

Accordingly, the method 1600 allows the electronic processor 305 to detect kickback of the power tool 102a when the roll position of the power tool 102a is outside a working operating angle range that is updated based on the angular velocity of the housing of the power tool 102a and the grip parameters. In some embodiments, the working operating angle range and the working operating angle range adjustment threshold may be referred to as kickback sensitivity parameters that may be adjusted to refine kickback control of the power tool 102a in accordance with other portions of this application. Although not shown in FIG. 16, in some embodiments, the electronic processor 305 may re-adjust the working operating angle range back to its originally-set value in response to determining that the angular velocity of the housing of the power tool 102a has decreased below a predetermined value or has decreased to zero.

In some embodiments, in addition to shutting down the motor 330 in response to the roll position of the power tool being outside the working operating angle range, the electronic processor 305 also may shut down the motor if the angular velocity exceeds a rotation speed threshold. In some embodiments, the working operating angle range adjustment threshold is less than the rotation speed threshold. In other embodiments, the electronic processor 305 may monitor the angular velocity of the housing of the power tool 102a solely for the purpose of updating the working operating angle range and may not shut down the power tool 102a based on the angular velocity exceeding the rotation speed threshold. In some embodiments, at block 1610, the electronic processor 305 determines an initial value for the working operating angle range adjustment threshold based on the initial orientation of the power tool 102a and the grip parameters in a similar manner as described above with respect to the working operating angle range.

In some embodiments, the kickback control implemented by the electronic processor 305 is controllable via the external device 108. FIG. 5 illustrates an example screenshot of a user interface 505 of the external device 108 that allows for kickback sensitivity parameters (e.g., kickback thresholds, filtering methods, and the like) to be adjusted by a user. As shown in FIG. 5, kickback control can be optionally turned on or off using a toggle switch 510. In other words, the electronic processor 305 receives a user selection via the toggle switch 510 and the external device 108 indicating whether to implement the method 400 described above. In some embodiments, the power tool 102a may include an LED that illuminates to indicate that kickback control is activated.

Also as shown in FIG. 5, a sensitivity level of kickback control can be optionally set using a slider bar 515. In some embodiments, the sensitivity level sets at least one of the kickback thresholds described above (e.g., a current threshold, a rotation speed threshold, a trigger release sensitivity, a working operating angle range, and the like). In other words, the electronic processor 305 receives an indication of the sensitivity level via the slider bar 515 and the external device 108 and adjusts one or more of the kickback thresholds in response to the indication. In some embodiments, the user interface 505 includes a separate slider bar to allow for adjustment of each kickback threshold individually. In some embodiments, the electronic processor 305 turns off the motor 330 in response to less kickback of the power tool 102a when the sensitivity level of kickback control is set higher than when the sensitivity level of the kickback control is set lower. In other words, the electronic processor 305 may set the kickback thresholds to levels that are more easily satisfied (e.g., a lower rotation speed threshold or a higher trigger release sensitivity) when the sensitivity level of kickback control is set higher than when the sensitivity level of the kickback control is set lower.

In some embodiments, the sensitivity level sets a filtering method used by the electronic processor 305 when receiving data from the sensors. For example, when the sensitivity level of kickback control is set higher, the electronic processor 305 may lessen the effect of low-pass filtering of one or more sensor signals such that a spike in data may cause a kickback threshold to be reached that ceases driving of the motor 330. On the other hand, when the sensitivity level of kickback control is set lower, the electronic processor 305 may increase the effect of low-pass filtering of one or more sensor signals such that spikes in data are smoothed out to prevent the monitored power tool characteristic from being as likely to cross its respective kickback threshold. Stated another way, the electronic processor 305 may change a filtering rate of one or more sensors of the power tool 102a to sacrifice accuracy for faster response time (when the sensitivity level of kickback control is set higher) or, alternatively, to sacrifice faster response time for accuracy (when the sensitivity level of kickback control is set lower). In some embodiments, the electronic processor 305 sets or adjusts a filtering method of data received from one or more sensors based on the speed of the motor 330.

In some embodiments, the electronic processor 305 establishes and/or adjusts at least one kickback sensitivity parameter based on the orientation of the power tool 102a. FIG. 6 illustrates three example orientations of the power tool 102a including a horizontal orientation 605, a vertically upward orientation 610, and a vertically downward orientation 615. The orientations may be described based on the rotational axis of the power tool (see, for example, rotational axis 211 of the power tool 102a in FIGS. 2A and 2B) with respect to gravity. For example, when the rotation axis is at 90 degrees with respect to gravity, or within a predetermined range of 90 degrees with respect to gravity (e.g., within 5, 10, 15, 25, 35, or 45 degrees), the power tool may be considered in the horizontal orientation 605. Similarly, when the rotation axis is at 180 degrees with respect to gravity, or within a predetermined range of 180 degrees with respect to gravity (e.g., within 5, 10, 15, 25, 35, or 45 degrees), the power tool may be considered in the vertically upward orientation 610. Similarly, when the rotation axis is at 0 degrees (i.e., aligned) with respect to gravity, or within a predetermined range of 0 degrees with respect to gravity (e.g., within 5, 10, 15, 25, 35, or 45 degrees), the power tool may be considered in the vertically downward orientation 615. In other embodiments, another axis of the tool, such as a longitudinal axis of the tool housing or motor rotational axis, is used to determine the orientation of the power tool.

FIG. 7 illustrates a flowchart of an example method 700 of setting a kickback sensitivity parameter based on the orientation of the power tool 102a. At block 705, the electronic processor 305 determines the orientation of the power tool 102a based on information received from the orientation sensor 345 and the grip sensors 220. For example, the electronic processor 305 receives a signal from the orientation sensor 345 indicating the pitch angle α and compares the pitch angle to threshold ranges for each of the orientations 605, 610, and 615 shown in FIG. 6. The force sensors 220 provide an indication of a one-handed grip or a two-handed grip. In some embodiments, the force sensors 220 also provide a measure of grip strength.

At block 710, the electronic processor sets a kickback sensitivity parameter based on the orientation of the power tool 102a. For example, when the pitch of the power tool 102a indicates that the power tool 102a is facing upward (i.e., in the vertically upward orientation 610 of FIG. 6), the user may be drilling overhead and/or standing on a ladder or scaffolding such that they may have less control of the power tool 102a. Accordingly, when the electronic processor 305 determines that the output driver 210 of the power tool 102a is facing upward, the electronic processor 305 may set at least one kickback sensitivity parameter to be more sensitive such that driving of the motor 330 ceases when less kickback is sensed. For example, the electronic processor 305 may lower the rotation speed threshold in embodiments where the angular velocity of the power tool 102a is being monitored. As another example, the electronic processor 305 may adjust a filtering method to reduce the effect of low-pass filtering such that a spike in data may cause a kickback threshold to be reached that ceases driving of the motor 330. As another example, the electronic processor 305 may set the trigger release sensitivity to exaggerate the quickness of a monitored trigger release by the user. For example, the electronic processor 305 may cease driving of the motor 330 in response to a slight trigger release by the user instead of slowing the speed of the motor 330 as may be done in other situations where the user may have more control of the power tool 102a. As another example, when the orientation of the power tool 102a indicates that the power tool 102a is not being used at a ninety degree angle facing upward, downward, or horizontally (as shown in the three orientations of FIG. 6), the user may have less control of the power tool 102a (e.g., when drilling at a forty-five degree angle). Accordingly, when the electronic processor 305 determines that the output driver 210 of the power tool 102a is not at a ninety degree angle facing upward, downward, or horizontally, the electronic processor 305 may set at least one kickback sensitivity parameter to be more sensitive such that driving of the motor 330 ceases when less kickback is sensed. For example, the electronic processor 305 may lower the rotation speed threshold in embodiments where the angular velocity of the power tool 102a is being monitored or may decrease the working operating angle range where the roll position of the power tool 102a is being monitored.

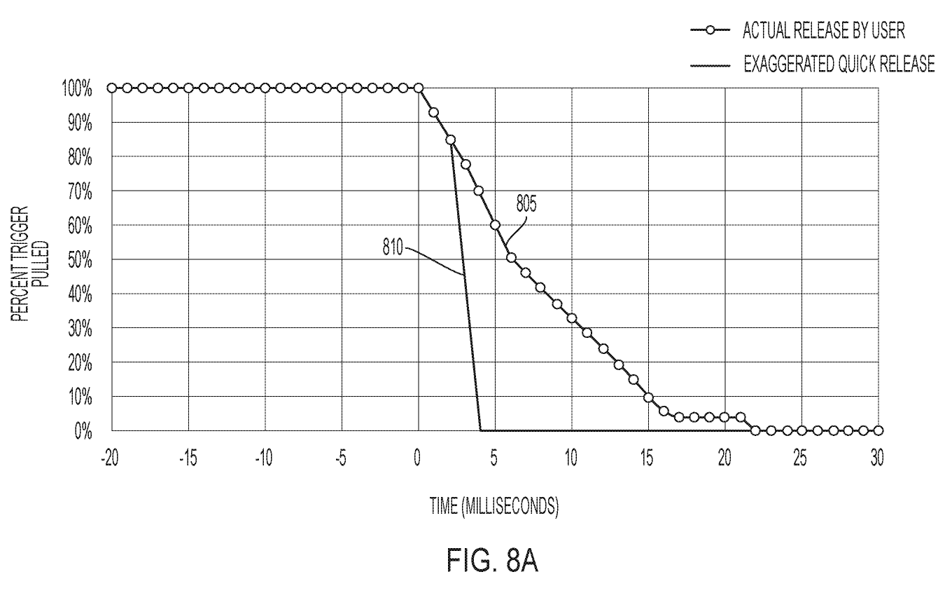

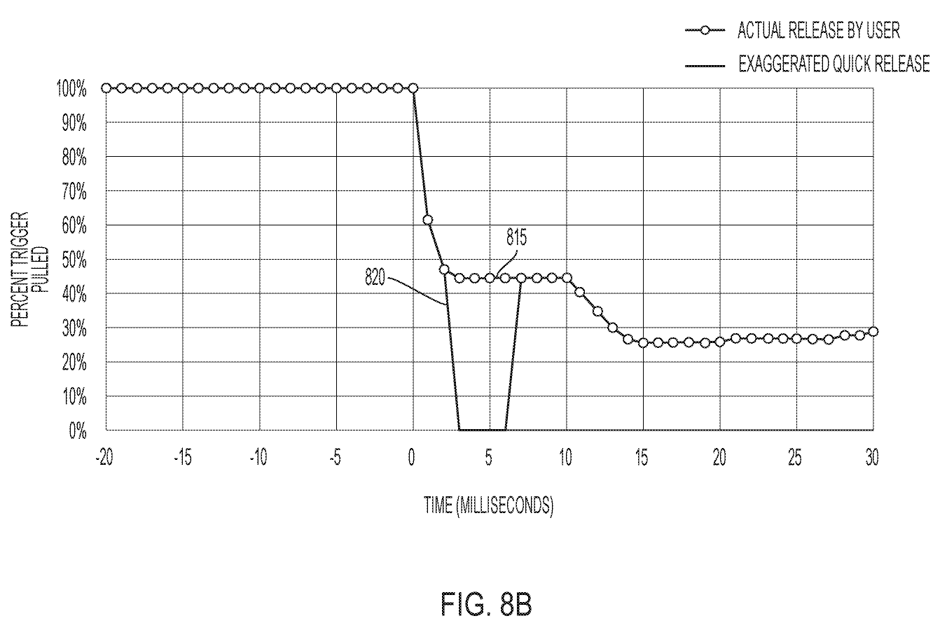

FIGS. 8A and 8B are charts that illustrate the exaggerated quick release implemented by the electronic processor 305 according to some embodiments. Line 805 of FIG. 8A represents the actual position of the trigger 212 over a time period where the user releases the trigger 212. As shown in FIG. 8A, it takes the user approximately twenty-two milliseconds to completely release the trigger 212. However, in situations where the trigger release sensitivity is increased, the electronic processor 305 may cease driving of the motor 330 before the user has completely released the trigger 212. For example, as indicated by line 810 of FIG. 8A, the electronic processor 305 may recognize the change in position of the trigger 212 and cease driving of the motor after approximately five milliseconds. Such control may be useful in situations where release of the trigger 212 may indicate a loss of control of the power tool 102a (e.g., when the power tool 102a is in the vertically upward orientation 610 of FIG. 6).

FIG. 8B illustrates a situation where the trigger 212 is only released part way and is not completely released (i.e., a situation where the user intended to release the trigger 212 only part way to reduce the speed of the motor 330, for example). Similar to FIG. 8A, line 815 indicates the actual position of the trigger 212 over a time period where the user partially releases the trigger 212. As shown in FIG. 8B, similar to line 810 of FIG. 8A, line 820 indicates that the electronic processor 305 ceases driving of the motor 330 in approximately three milliseconds in response to a detected change in position of the trigger 212. However, after a few milliseconds, the electronic processor 305 determines that position of the trigger 212 has remained partially depressed (e.g., steady at approximately 45% actuation) and controls the switching network 325 to provide power to the motor 330 corresponding to the 45% actuation of the trigger 212. In some embodiments, the brief period where the electronic processor 305 ceased driving the motor 330 may occur so quickly that it is unrecognizable to the user. Thus, when the trigger release sensitivity of the power tool 102a is set to implement an exaggerated quick release, the electronic processor 305 may be more sensitive to trigger releases while still maintaining normal operation of the power tool 102a.

Returning to block 710 of FIG. 7, as another example of setting a kickback sensitivity parameter based on the orientation of the power tool 102a, when the pitch of the power tool 102a indicates that the power tool 102a is facing downward (i.e., in the vertically downward orientation 615 of FIG. 6), the user may be in a more stable situation (e.g., located on the floor with both hands on the power tool 102a). Accordingly, when the electronic processor 305 determines that the output driver 210 of the power tool 102a is facing downward, the electronic processor 305 may set at least one kickback sensitivity parameter to be less sensitive such that driving of the motor 330 is not ceased when minor kickback is sensed. In such situations, the trigger release sensitivity may be set not to implement exaggerated quick release of the trigger 212.

As yet another example of setting a kickback sensitivity parameter based on the orientation of the power tool 102a, when the roll of the power tool 102a indicates that the power tool 102a is sideways to the ground when the pitch of the power tool 102a indicates that the power tool 102a is facing horizontally (i.e., in the horizontal orientation 605 of FIG. 6), an arm of the user may be in such a position that it is not able to rotate much further if, for example, kickback occurs. Accordingly, when the electronic processor 305 determines that the power tool 102a is sideways with respect to the ground (i.e., with the handle rotated to an angle of approximately 90 degrees with respect to gravity), the electronic processor 305 may set at least one kickback sensitivity parameter to be more sensitive such that driving of the motor 330 is ceased when less kickback is sensed or is ceased more quickly when a trigger release is detected.

As another example of setting a kickback sensitivity parameter based on the orientation of the power tool 102a, the electronic processor 305 may set a filtering method used during the kickback control method based on the orientation of the power tool 102a. For example, when signals are received from the movement sensor 350 that indicate movement in multiple directions, the electronic processor 305 may give more weight to movement in a certain direction depending on the orientation of the power tool 102a (e.g., a direction in which the power tool 102a is likely to move if kickback occurs).

Accordingly, in some embodiments, the electronic processor 305 sets at least one kickback sensitivity parameter based on the pitch of the power tool 102a, the roll of the power tool 102a, or both. In some embodiments, blocks 705 and 710 of FIG. 7 may be repeated such that the electronic processor 305 adjusts at least one kickback sensitivity parameter in a quasi-continuous manner as the orientation of the power tool 102a changes. For example, for every ten degrees that the roll position increases with respect to the initial roll position, the electronic processor 305 may reduce the rotation speed threshold by ten percent to make the electronic processor 305 more sensitive to kickback. In other example embodiments, different degree and threshold adjustment amounts are used.

As indicated above, the electronic processor 305 may establish and/or adjust at least one kickback sensitivity parameter based on the orientation of the power tool 102a. In other words, in some embodiments, the electronic processor 305 performs blocks 705 and 710 in response to the trigger 212 of the power tool 102a being actuated. In such embodiments, the electronic processor 305 establishes a kickback sensitivity parameter (e.g., a rotation speed threshold, a counter threshold, a delay time between monitored angular velocity samples, a working operating angle range, and/or the like) based on an initial orientation of the power tool 102a at a time that the trigger 212 is actuated. For example, each time the trigger 212 is actuated, the electronic processor 305 establishes at least one kickback sensitivity parameter based on an orientation of the power tool 102a as determined using the orientation sensor 345. The relative changes to the kickback sensitivity parameters may be adjusted based on the grip parameters, where the magnitude of the adjustments made based on tool orientation may be reduced for a two-handed or strong grip. Additionally or alternatively, in some embodiments, the electronic processor 305 dynamically updates at least one kickback sensitivity parameter based on a changing orientation of the power tool 102a or grip parameters during operation while the trigger 212 remains actuated. For example, the electronic processor 305 adjusts the rotation speed threshold based on a change in roll position of the power tool 102a during an operation.

At block 715, the electronic processor 305 monitors a power tool characteristic associated with the kickback sensitivity parameter. For example, the power tool characteristic may be one of the power tool characteristics described above such as a motor current, an angular velocity of the power tool 102, a roll position of the power tool 102a, and a position of the trigger 212. In some embodiments, at block 715, the electronic processor 305 monitors more than one power tool characteristic as explained previously, and each power tool characteristic is associated with a kickback sensitivity parameter. At block 720, the electronic processor 305 determines that a kickback of the power tool 102a is occurring based on the monitored power tool characteristic reaching a kickback threshold. In some embodiments, at block 720, the electronic processor 305 determines that kickback of the power tool 102a is occurring based on more than one power tool characteristic meeting its respective kickback threshold. For example, as explained above with respect to FIG. 4, kickback may be determined after both motor current has decreased below a low current threshold and angular velocity exceeds a rotation speed threshold. At block 725, the electronic processor controls the switching network 325 to cease driving of the motor 330 in response to the power tool characteristic reaching the kickback threshold. In some embodiments, blocks 715, 720, and 725 of FIG. 7 are similar to respective blocks 405, 410, and 415 of FIG. 4 and may include similar functionality as that described above with respect to FIG. 4.

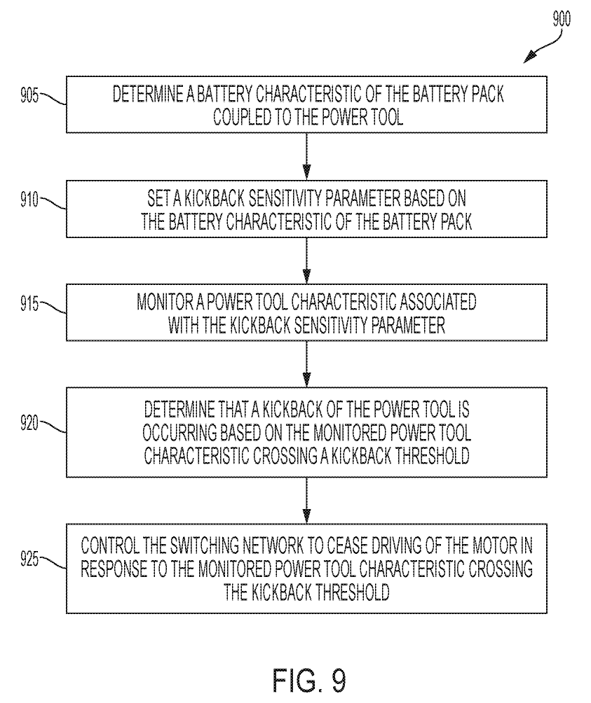

In some embodiments, the electronic processor 305 establishes and/or adjusts at least one kickback sensitivity parameter based on a battery characteristic of a battery pack coupled to the power tool 102a. FIG. 9 illustrates a flowchart of an example method 900 of setting a kickback sensitivity parameter based on a battery characteristic of a battery pack coupled to the power tool 102a. At block 905, the electronic processor 305 determines a battery characteristic of the battery pack coupled to the power tool 102a. In some embodiments, the electronic processor 305 may receive information from the battery pack (e.g., a battery pack identification, a battery pack type, and the like) and may determine a size or weight of the battery pack using a look-up table stored in the memory 310. In other embodiments, the electronic processor may receive information corresponding to the size or weight of the battery pack from the battery pack.

The remaining blocks of the method 900 (block 910, 915, 920, and 925) are similar to blocks 710, 715, 720, and 725 of FIG. 7. Accordingly, the functions, examples, and alternative embodiments described with respect to these blocks of FIG. 7 also apply to the corresponding blocks of FIG. 9. At block 910, the electronic processor 305 sets a kickback sensitivity parameter based on the battery characteristic of the battery pack. For example, the electronic processor 305 may adjust a rotation speed velocity threshold based on the weight of the battery pack because the weight of the battery pack may affect the rotational inertia of the power tool 102a. At block 915, the electronic processor 305 monitors a power tool characteristic associated with the kickback sensitivity parameter. At block 920, the electronic processor 305 determines that a kickback of the power tool 102a is occurring based on the monitored power tool characteristic reaching a kickback threshold. At block 925, the electronic processor 305 controls the switching network 325 to cease driving of the motor 330 in response to the power tool characteristic reaching the kickback threshold.

Similar to the embodiment described above with respect to FIG. 9, in some embodiments, the electronic processor 305 establishes and/or adjusts at least one kickback sensitivity parameter based on a characteristic of an attachment coupled to the power tool 102a. Such establishment or adjustment may allow the electronic processor 305 to compensate for the effect that the presence of the attachment has on the moment of inertia of the power tool 102a. In addition to a battery pack as described above with respect to FIG. 9, that attachment may be for example, a vacuum system, a side handle, or the like. In some embodiments, the power tool 102amay include a sensor to detect the presence of the attachment or an electronic switch that is actuated when the attachment is mounted to the power tool 102a. In other embodiments, the attachment may include at least one of an electronic processor and a communication device to communicate wirelessly or via a wired connection with the power tool 102a. For example, the attachment may communicate characteristics of the attachment such as an attachment type, an attachment location/position, an attachment weight, and the like to the power tool 102a. In some embodiments, a mode of the power tool 102a may indicate that an attachment is coupled to the power tool 102a. For example, when the power tool 102a is placed in a vacuum mode, the electronic processor 305 determines that a vacuum system is mounted to the power tool 102a. In some embodiments, the electronic processor 305 may determine the presence of an attachment based on information from one or more of the orientation sensor 345 and the movement sensor 350 during minor use or while the power tool 102a is resting. For example, the electronic processor 305 may compare information received from the sensors 345 and 350 with information in a look-up table stored in the memory 310 to determine whether the information from the sensors 345 and 350 indicates that an attachment is mounted on the power tool 102a. Based on at least one of detection of the attachment and receipt of a characteristic of the attachment, the electronic processor 305 may establish and/or adjust at least one kickback sensitivity parameter.

In some embodiments, the electronic processor 305 adjusts at least one kickback sensitivity parameter based on a kickback event such as a suspected kickback event, a near kickback event, or a detected kickback event. FIG. 10 illustrates a flowchart of an example method 1000 of adjusting a kickback sensitivity parameter based on a kickback event of the power tool 102a. At block 1005, the electronic processor 305 sets a kickback sensitivity parameter (e.g., a kickback threshold or a filtering method as described above). In some embodiments, the electronic processor 305 sets one or more kickback sensitivity parameters based on the orientation of the power tool 102 or the grip parameters as described above.

At block 1010, the electronic processor 305 monitors a power tool characteristic associated with the kickback sensitivity parameter (e.g., at least one of a motor current, an angular velocity of the power tool 102, a trigger position and the like as explained previously). At block 1015, the electronic processor 305 determines that a kickback event is occurring based on the monitored power tool characteristic or a second monitored power tool characteristic. As noted above, the kickback event may be a suspected kickback event, a near kickback event, or a detected kickback event as explained in greater detail below.

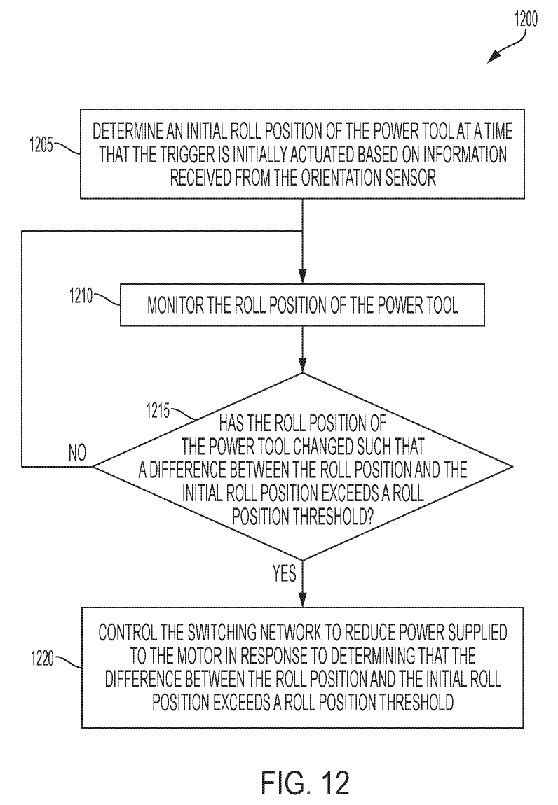

In some embodiments, a suspected kickback event is detected when the power tool 102a is initially operated. For example, when the electronic processor 305 determines that the output driver 210 of the power tool 102a moves slower than expected upon start-up, the electronic processor 305 may determine that a kickback event is more likely (e.g., because the bit of the power tool 102a does not have the rotational momentum to overcome small bindings or shear in the workpiece). In some embodiments, a suspected kickback event is detected during operation of the power tool 102a based on a change in roll position of the power tool 102a during operation, which may be referred to as tool walk (see FIG. 12). In some situations, tool walk may indicate a slow loss of control of the power tool 102a by the user. For example, the electronic processor 305 may determine an initial roll position of the power tool when the power tool 102a is initially operated (see block 1205 of FIG. 12). The electronic processor 305 may then monitor the roll position of the power tool 102a during operation and compare the current roll position to the initial roll position (see blocks 1210 and 1215 of FIG. 12). When the current roll position of the power tool 102a has changed a predetermined amount from the initial roll position (i.e., when tool walk has occurred), the electronic processor 305 may determine that a suspected kickback event is occurring.

In some embodiments, a near kickback event is detected when the movement sensor 350 indicates that the housing of the power tool 102a has rotated in such a manner that the monitored angular velocity is within a predetermined amount from the rotation speed threshold (i.e., a second rotation speed threshold that is lower than the rotation speed threshold that indicates kickback of the power tool 102a). In other words, a near kickback event may occur when the output driver 210 of the power tool 102a briefly binds in a workpiece but quickly becomes unbound.

In some embodiments, a detected kickback event occurs when the output of the power tool 102a becomes bound in a workpiece such that the output remains stationary, and the electronic processor 305 controls the switching network 325 to cease driving of the motor 330 (see, for example, the method 400 of FIG. 4).

At block 1020, the electronic processor 305 adjusts the kickback sensitivity parameter based on the kickback event. For example, based on a suspected kickback event (i.e., a detected change in roll position), the electronic processor 305 may decrease the rotation speed threshold and/or increase the trigger release sensitivity to make the power tool 102a more sensitive to kickback (i.e., cease driving of the motor 330 more quickly) because the user may not have full control of the power tool 102a. In some embodiments, the magnitude of the adjustments to the kickback sensitivity parameter may depend on the grip parameters detected by the force sensors 220.

As another example, when a near kickback event is detected, the electronic processor 305 adjusts at least one kickback sensitivity parameter to be less sensitive so as not to falsely detect a kickback (e.g., when the user may have more control of the power tool 102a). In other situations, when a near kickback event is detected, the electronic processor 305 adjusts at least one kickback sensitivity parameter to be more sensitive (e.g., when the user may have less control of the power tool 102a). Accordingly, the adjustment of the kickback sensitivity parameter by the electronic processor 305 (at block 1020) may also take into account the orientation of the power tool 102a in that the user may be determined to have more control when the power tool 102a is at the horizontal orientation 605 or vertically downward orientation 615 than when in the vertically upward orientation 610.

As another example, when a near kickback event is detected (e.g., based on angular velocity of the housing of the power tool 102a exceeding a working operating angle range adjustment threshold), the electronic processor 305 adjusts a working operating angle range as indicated in the method 1600 of FIG. 16 as explained above. In other words, the method 1600 of FIG. 16 is an example of a specific implementation of the method 1000 of FIG. 10 where the electronic processor 305 adjusts a working operating angle range (i.e., a kickback sensitivity parameter) based on monitored angular velocity of the housing of the power tool 102a exceeding a predetermined threshold (i.e., detection of a near kickback event). As explained in the above example with respect to FIG. 16, the electronic processor 305 may decrease the working operating angle range from plus-or-minus fifteen degrees from the initial roll position of the power tool 102a to plus-or-minus ten degrees from the initial roll position of the power tool 102. In this example, the electronic processor 305 adjusts the kickback sensitivity parameter (i.e., the working operating angle range) to be more sensitive to kickback (i.e., cease driving of the motor 330 more quickly) because the angular velocity measurement may indicate that the user does not have full control of the power tool 102a. With respect to this example of decreasing the working operating angle range from plus-or-minus fifteen degrees from the initial roll position of the power tool 102a to plus-or-minus ten degrees from the initial roll position of the power tool 102, the values of the angle range are merely examples and other angle ranges may be used. Additionally, with respect to other example values of and relationships between speeds, angles, thresholds, ranges, and the like throughout this description, these values and relationships are merely examples and other values and relationships are possible in other situations and embodiments.

In some embodiments, the electronic processor 305 may keep track of the number of kickback events that have occurred, for example, using the memory 310. In some embodiments, the electronic processor 305 may adjust at least one kickback sensitivity parameter based on a predetermined number of kickback events occurring. For example, the electronic processor 305 may decrease the sensitivity of a kickback threshold after three detected kickback events to prevent the motor 330 from being shut down so often during use. Further, in such embodiments, the electronic processor 305 may adjust at least one kickback sensitivity parameter based on a predetermined number of kickback events occurring within a predetermined period of time (e.g., thirty seconds). For example, the electronic processor 305 may decrease the sensitivity of a kickback threshold when three detected kickback events occur within thirty seconds.

In some embodiments, the kickback events may be detected during a single, continuous operation of the power tool 102a (i.e., during a single trigger actuation before the trigger 212 is released). However, in other embodiments, these kickback events may be detected over multiple trigger actuations. In both embodiments, the electronic processor 305 may store the number of kickback events in the memory 310 and may adjust at least one kickback sensitivity parameter based on a predetermined number of occurrences of one or more of these events. For example, when three near kickback events are detected, the electronic processor 305 may adjust the rotation speed threshold of the power tool 102a.

In some embodiments, the electronic processor 305 may store kickback sensitivity parameters used during previous operating modes of the power tool 102a (i.e., a history of modes selected by the user and corresponding history of kickback sensitivity parameters used during the modes). When the power tool 102a switches modes, the electronic processor 305 may adjust at least one kickback sensitivity parameter based on a selected mode of the power tool 102a to, for example, correspond to a kickback sensitivity parameter that was previously used during the selected mode.

In some embodiments, blocks 1010, 1015, and 1020 of the method 1000 are repeated such that one or more kickback sensitivity parameters are adjusted more than once as kickback events are detected by the electronic processor 305.

The remaining blocks of the method 1000 (block 1025 and 1030) are similar to blocks 720 and 725 of FIG. 7. Accordingly, the functions, examples, and alternative embodiments described with respect to these blocks of FIG. 7 also apply to the corresponding blocks of FIG. 10. At block 1025, the electronic processor 305 determines that a kickback of the power tool is occurring based the monitored power tool characteristic reaching a kickback threshold. At block 1030, the electronic processor 305 controls the switching network to cease driving of the motor 330 in response to the monitored power tool characteristic reaching the kickback threshold.

In some embodiments, the electronic processor 305 is configured to establish or adjust at least one kickback sensitivity parameter during a start-up of the power tool 102a. For example, the power tool 102a may be more likely to experience kickback when the motor 330 is being started from a standstill than when the motor 330 is already moving and has some rotational momentum. In such situations when the electronic processor 305 determines that the motor 330 is starting from a standstill, the electronic processor 305 may set at least one kickback sensitivity parameter to be less sensitive to allow the power tool 102a to power through minor kickback caused by small bindings or shear in the workpiece (e.g., when the orientation of the power tool 102a indicates that the power tool 102a is in a well-controlled position). Alternatively, the electronic processor 305 may set at least one kickback sensitivity parameter to be more sensitive to attempt to cease providing power to the motor 330 when even minor kickback is detected (e.g., when the orientation of the power tool 102a indicates that the power tool 102a is in a less-controlled position). In some embodiments, after the motor 330 has reached a desired operating speed, the electronic processor 305 may further adjust at least one kickback sensitivity parameter. In some embodiments, the electronic processor 305 may be configured to adjust at least one kickback sensitivity parameter in a quasi-continuous manner as the speed of the motor 330 changes. For example, as the speed of the motor 330 increases from a standstill to a desired operating speed, the electronic processor 305 may gradually increase or decrease at least one kickback sensitivity parameter.

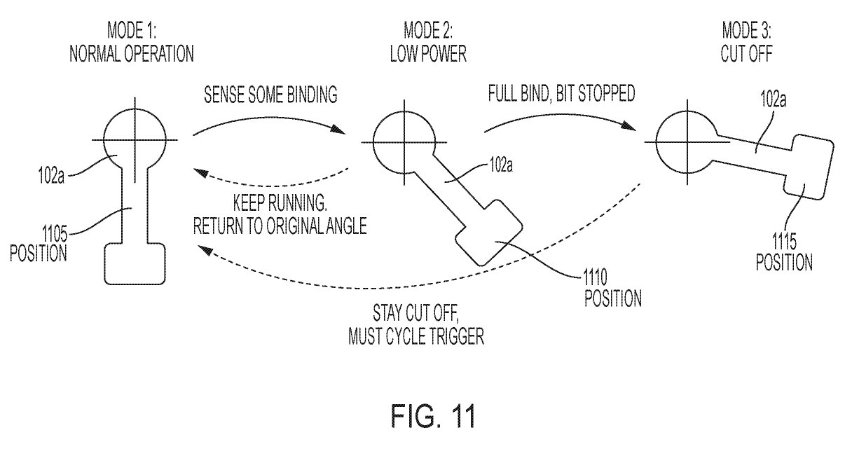

FIG. 11 illustrates three example roll positions of the power tool 102a. Position 1105 represents the initial position of the power tool 102a when the trigger 212 is pulled to begin operation on a workpiece. In this example situation, the power tool 102a is being used in a horizontal position and is vertically upright with a roll position of approximately zero degrees with respect to gravity. At position 1110, the power tool 102a has rotated due to minor binding with the workpiece (i.e., tool walk has occurred). At position 1115, the output of the power tool 102a has become bound in the workpiece and a kickback has occurred.

In some embodiments, the electronic processor 305 reduces the power supplied to the motor 330 when tool walk is detected. Such power reduction may indicate to the user that the roll position of the power tool 102a has changed during operation (position 1110 of FIG. 11). In some embodiments, if the user corrects the roll position to, for example, correspond with the initial roll position of the power tool 102a (position 1105 of FIG. 11), the electronic processor 305 may allow full power to be supplied to the motor 330 in accordance with the position of the trigger 212. In some embodiments, if the force sensors 220 detect that the user has changed to a two-handed grip or stronger grip, the electronic processor 305 may allow full power to be supplied to the motor 330 in accordance with the position of the trigger 212.

FIG. 12 illustrates a flowchart of an example method 1200 of reducing power supplied to the motor 330 based on detected tool walk of the power tool 102a. At block 1205, the electronic processor 305 determines an initial roll position of the power tool 102a (e.g., with respect to gravity) at a time that the trigger 212 is initially actuated based on information received from the orientation sensor 345 (e.g., position 1105 of FIG. 11). The electronic processor 305 may store the information related to the initial roll position in the memory 310.

At block 1210, the electronic processor 305 monitors the roll position of the power tool 102a. At block 1215, the electronic processor 305 determines whether the roll position of the power tool 102a has changed such that a difference between the roll position and the initial roll position exceeds a roll position threshold. In some embodiments, the roll position threshold is a predetermined number of degrees from the initial roll position. Additionally or alternatively, the roll position threshold may be a predetermined number of degrees with respect to a desired operation position (e.g., during horizontal operation, a tool walk that results in a tool position of 70 degrees in either direction with respect to gravity). When the electronic processor 305 determines that the difference between the roll position and the initial roll position has not reached the roll position threshold, the method 1200 proceeds back to block 1210 to continue monitoring the roll position of the power tool 102a.

When the electronic processor 305 determines that the difference between the roll position and the initial roll position exceeds the roll position threshold (e.g., position 1110 of FIG. 11), at block 1220, the electronic processor 305 controls the switching network 325 to reduce power supplied to the motor 330 in response to determining that the difference between the roll position and the initial roll position exceeds the roll position threshold. In some embodiments, the roll position threshold is not a single, discrete threshold. Rather, the electronic processor 305 may adjust the power supplied to the motor 330 in a quasi-continuous manner based on the roll position of the power tool 102a as the roll position changes. For example, for every ten degrees that the roll position increases with respect to the initial roll position, the electronic processor 305 may reduce the speed of the motor 330 by twenty percent.

As mentioned above, the reduction in power that occurs at block 1220 may notify the user that tool walk has occurred. In some embodiments, if the user corrects the roll position to, for example, correspond with the initial roll position of the power tool 102a, the electronic processor 305 may allow full power to be supplied to the motor 330 in accordance with the position of the trigger 212. In such embodiments, the electronic processor 305 may gradually increase power supplied to the motor 330 to full power (e.g., using a time delay). Similar to the reduction of power described above, the restoration of power as the roll position of the power tool 102a is corrected may be provided in a quasi-continuous manner. Additionally, in some embodiments, the electronic processor 305 may require the roll position of the power tool 102a to correspond to a desired roll position (e.g., during horizontal operation, a vertically upright tool with a tool position of approximately zero degrees with respect to gravity) to re-allow full power to be supplied to the motor 330 rather than restoring full power to the motor 330 when the power tool is re-oriented to an initial roll position. In some embodiments, the electronic processor 305 may restore full or partial power to the motor 330 in response to the roll position of the power tool 102a being corrected to be within a predetermined amount from the initial roll position or from a desired roll position. In other words, the electronic processor 305 may restore full or partial power to the motor 330 when the roll position of the power tool 102a has been partially, but not completely, corrected.

In some embodiments, the electronic processor 305 executes the method 1200 in conjunction with one of the previously described methods such that the electronic processor 305 may detect a kickback of the power tool 102a and cease driving of the motor 330 during execution of the method 1200. Additionally, the electronic processor 305 may adjust a kickback sensitivity parameter based on detected tool walk as explained in detail above with respect to FIG. 10.

In another embodiment of FIG. 12, at block 1215, the electronic processor 305 may proceed to block 1220 to reduce power supplied to the motor 330 in response to the roll position of the power tool 102a exceeding a predetermined roll position threshold. In such embodiments, the electronic processor 305 may not determine the difference between the roll position and an initial roll position. Rather, the electronic processor 305 reduces the power supplied to the motor 330 based on merely the roll position of the power tool 102. For example, the electronic processor 305 may reduce the power supplied to the motor 330 in response to determining that the roll position of the power tool 102a is horizontal with respect to the ground (i.e., with the handle rotated to an angle of approximately 90 degrees with respect to gravity).

When kickback of the power tool 102a occurs, the power tool 102a may remain bound in the workpiece at an awkward angle such that it is difficult for the user to grasp or operate the power tool 102a. Often, a user will attempt to unbind the power tool 102a by applying force to the housing of the power tool 102a to manually rotate the housing and the output driver 210 of the power tool 102a. However, the user may not be able to apply enough force to unbind the power tool 102a, and if the power tool 102a becomes unbound, it may move/swing quickly due to the force applied by the user. In other instances, to attempt to unbind the power tool 102a, a user may switch the rotational direction of the motor 330 of the power tool 102a and operate the power tool 102a in a reverse mode. However, this also may cause the power tool 102a to move/swing quickly after the power tool 102a becomes unbound.

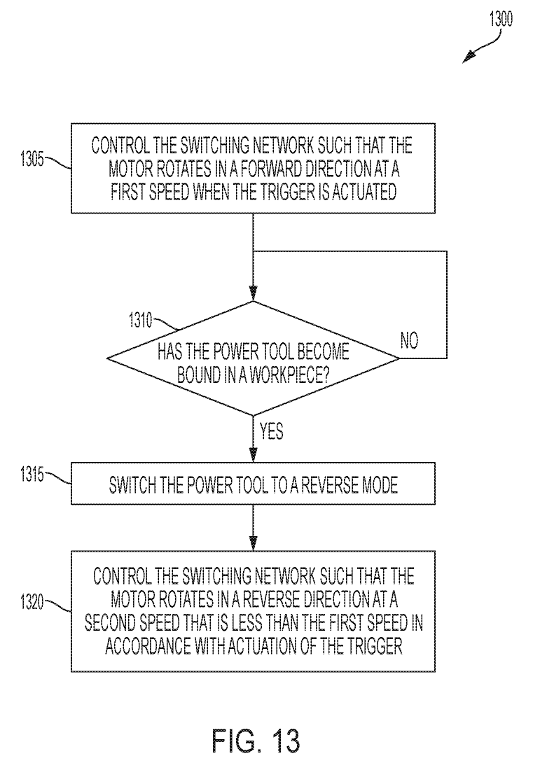

FIG. 13 illustrates a flowchart of a method 1300 of controlling the power tool 102a after the power tool 102a becomes bound in a workpiece. The method 1300 allows the housing of the power tool 102a to return to a desired position such that the user can attempt to unbind the power tool 102a. In some situations, the power tool 102a may become unbound during execution of the method 1300. In some embodiments, the method 1300 allows the housing of the power tool 102a to move slowly in the reverse direction to prevent the quick movements/swings mentioned above with respect to other methods of unbinding of the power tool 102a.

At block 1305, the electronic processor 305 controls the switching network 325 such that the motor 330 rotates in a forward direction at a first speed when the trigger 212 is actuated. At block 1310, the electronic processor 305 determines whether the power tool 102a has become bound in a workpiece. For example, when the electronic processor 305 ceases driving the motor 330 in response to a monitored power tool characteristic reaching a kickback threshold, the electronic processor 305 may determine that the power tool 102 has become bound in a workpiece. When the power tool 102a has not become bound in a workpiece, the method 1300 remains at block 1310 and the electronic processor 305 continues to control the switching network 325 such that the motor 330 rotates in a forward direction at the first speed in accordance with actuation of the trigger 212.

When the electronic processor 305 has determined that the power tool 102a has become bound in the workpiece (at block 1310), at block 1315, the electronic processor 305 switches the power tool 102a to a reverse mode. In some embodiments, this switch to a reverse mode may be caused by the user actuating the forward/reverse selector 219. In other embodiments, the electronic processor 305 switches the power tool 102a to reverse mode without requiring the user to actuate the forward/reverse selector 219. In other words, the electronic processor 305 switches the power tool 102a to reverse mode in response to determining that the power tool 102a has become bound in a workpiece.

At block 1320, the electronic processor 305 controls the switching network 325 such that the motor 330 rotates in a reverse direction at a second speed that is less than the first speed in accordance with actuation of the trigger 212 (e.g., at a speed that is less than a predetermined reversal speed). For example, the electronic processor 305 may control the motor 330 in this manner in response to the trigger 212 being actuated after the power tool 102a has become bound in a workpiece. In other words, the electronic processor 305 may not execute block 1320 until the user actuates the trigger 212. Because the output driver 210 is bound in the workpiece and unable to rotate, the slow reverse rotation of the motor 330 allows the housing of power tool 102a to return to a desired position without swinging/moving the power tool 102a too quickly. In some embodiments, the electronic processor 305 sets the second speed as a single speed of the motor 330 regardless of the distance that the trigger 212 is actuated. In other embodiments, the electronic processor 305 sets the second speed as a maximum speed of the motor 330 and allows the user to operate the motor 330 at slower speeds by actuating the trigger 212 less than the maximum distance. In some embodiments, the second speed is a predetermined percent reduction of the first speed. In some embodiments, the second speed of the motor 330 may start near the first speed and gradually ramp downward until it reaches a predetermined level.

When the electronic processor 305 determines that the trigger 212 is no longer actuated, the electronic processor 305 controls the switching network 325 to cease driving the motor 330. In embodiments where the switch to reverse mode (at block 1315) was caused by the user actuating the forward/reverse selector 219, the electronic processor 305 keeps the power tool 102a in reverse mode but may not limit the speed of the motor 330 the next time the trigger is actuated. In other words, the next time the trigger 212 is actuated, the power tool 102a may operate at full reverse speed in accordance with the actuation of the trigger 212. On the other hand, in embodiments where the electronic processor 305 switched the power tool 102a to reverse mode without requiring the user to actuate the forward/reverse selector 219 (at block 1315), the electronic processor 305 may switch the power tool 102a back to forward mode. In such embodiments, the next time the trigger 212 is actuated, the power tool 102a may operate at full forward speed in accordance with the actuation of the trigger 212. In one or both of these embodiments, the electronic processor 305 may control the speed of the motor 330 to gradually increase speed to allow the user to realize the direction and speed in which the motor 330 is set to operate.

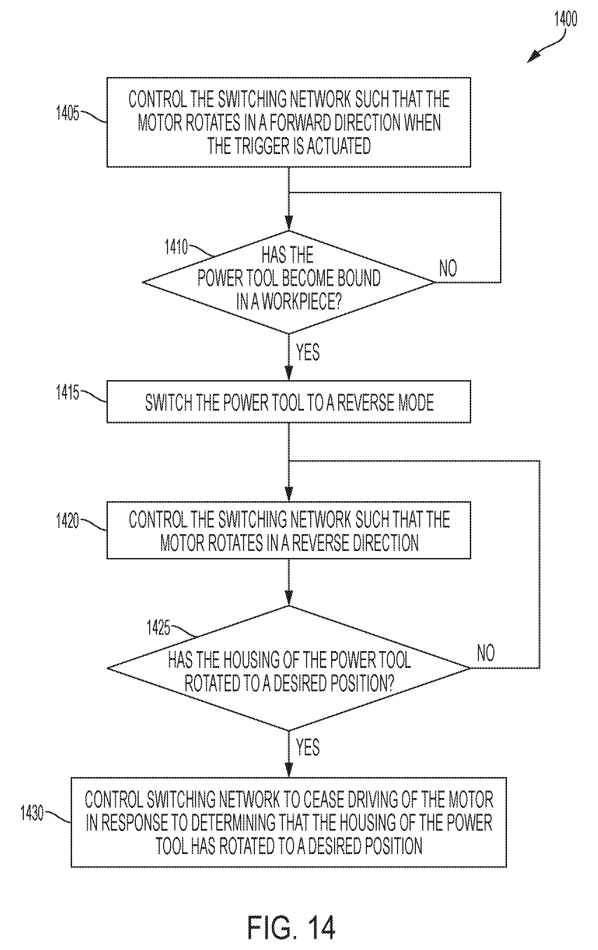

FIG. 14 illustrates a flowchart of another method of controlling the power tool 102a after the power tool 102a become bound in a workpiece. Blocks 1405, 1410, and 1415 are similar to blocks 1305, 1310, and 1315 of the method 1300 of FIG. 13 explained above such that the electronic processor 305 switches the power tool 102a to a reverse mode when the power tool 102a has become bound in a workpiece.

At block 1420, the electronic processor 305 controls the switching network 325 such that the motor 330 rotates in a reverse direction. In some embodiments, the electronic processor 305 controls the motor 330 to rotate in the reverse direction without requiring any user action (i.e., auto-reverse). For example, the electronic processor 305 may control the motor 330 to rotate in the reverse direction in response to determining that the power tool 102a has become bound in the workpiece. In some embodiments, the electronic processor 305 may control the motor 330 to rotate in the reverse direction after a predetermined time has elapsed since the electronic processor 305 has determined that the power tool 102a has become bound in the workpiece (e.g., three seconds, one second, 200 milliseconds, and the like). In some embodiments, the electronic processor 305 controls the motor 330 to rotate at a predetermined speed that is similar to the second speed described above with respect to block 1320 of FIG. 13.

In other embodiments, the electronic processor 305 controls the motor 330 to rotate in the reverse direction in response to detecting that the user applied a force to the power tool 102a in the reverse direction (i.e., user-assist reverse). For example, when the power tool 102a becomes bound in the workpiece, the electronic processor 305 determines the rotational position of the motor 330 and the position of the power tool 102a about the rotational axis 211. In some embodiments, the power tool 102a has a clutch that allows for the housing of the power tool 102a to be slightly manually rotated (e.g., 10-15 degrees) with respect to the output driver 210 when the output driver 210 is bound in the workpiece. Such a characteristic is referred to as “play in the clutch” and may be monitored by the electronic processor 305 using, for example, the orientation sensor 345 and the Hall sensors 335. For example, based on values received from these sensors the electronic processor may determine a difference between a position of the shaft of the motor 330 and a position of the housing of the power tool 102a. By continuing to monitor the rotational position of the motor 330 and the position of the power tool 102a with respect to the rotational axis 211 after the power tool 102a has become bound in the workpiece, the electronic processor 305 is able to determine whether a force is being applied to the power tool 102a by the user. The force may be recognized by the electronic processor 305 when the position of the housing of the power tool 102a with respect to the rotational axis 211 changes relative to the rotational position of the motor 330 above a certain threshold (e.g., 10 or 15 degrees), which may be realized by manual rotation of the housing due to the play in the clutch. Accordingly, in some embodiments, when the electronic processor 305 determines that a force is being applied to the power tool 102a in a reverse direction, the electronic processor 305 controls the motor 330 to rotate in the reverse direction. Such reverse rotation of the motor 330 may allow the user to rotate the housing of the power tool 102a to return to a desired position while the output driver 210 remains bound in the workpiece and unable to rotate. In some embodiments, the speed at which the motor 330 rotates in the reverse direction depends on the amount in which the power tool 102a is rotated within the play in the clutch.

While the motor 330 of the power tool 102a is rotating in the reverse direction, at block 1425, the electronic processor 305 determines whether the housing of the power tool 102a has rotated to a desired position. For example, the electronic processor 305 may compare the roll position of the power tool 102a to the initial roll position as described above. As another example, the electronic processor 305 may compare the roll position of the power tool 102a to a preferred roll position (e.g., during horizontal operation, a vertically upright tool with a tool position of approximately zero degrees with respect to gravity). In some embodiments, the electronic processor 305 may determine that a desired position has been reached when the housing of the power tool 102a has rotated a predetermined number of degrees from a bound roll position. In other words, the electronic processor 305 may compare a bound roll position of the power tool 102a at a time immediately after the power tool 102a became bound in the workpiece to a current roll position. In some embodiments, a desired position may be indicated by the electronic processor 305 determining that the user is applying a force to the power tool 102a to stop the reverse rotation of the motor 330. For example, the electronic processor 305 may determine that the motor current has increased above a predetermined threshold (e.g., to attempt to overcome the force provided by the user to stop the power tool 102a from rotating in the reverse direction). Along similar lines, in some embodiments, a desired position may be indicated by the electronic processor 305 determining that the position of the housing of the power tool 102a with respect to the rotational axis 211 changes relative to the rotational position of the motor 330 above a certain threshold (e.g., 10 or 15 degrees). This relative change may be realized by manual rotation of the housing, due to the play in the clutch, in a direction opposite the rotation of the housing being caused by the motor 330. In some embodiments, the electronic processor 305 determines that a desired position has been reached when the electronic processor 305 determines that the output driver 210 is no longer bound in the workpiece. For example, a drop in motor current (e.g., below a threshold) may indicate that the output driver 210 is no longer bound in the workpiece. In some embodiments, the electronic processor 305 may determine that a desired position has been reached when the trigger 212 is actuated or when some other switch/button on the power tool 102a is actuated (i.e., the user attempts to use the power tool 102a again because the housing of the power tool 102a has rotated to a desired position of the user).

When the housing of the power tool 102a has not rotated to a desired position, the method 1400 proceeds back to block 1420 to continue controlling the motor 330 to slowly rotate in the reverse direction. When the housing of the power tool 102a has rotated to a desired position, at block 1430, the electronic processor 305 controls the switching network 325 to cease driving of the motor 330 in response to determining that the housing of the power tool 102a has rotated to a desired position.

Similar to the description of the method 1400 above, in embodiments where the switch to reverse mode (at block 1415) was caused by the user actuating the forward/reverse selector 219, the electronic processor 305 keeps the power tool 102a in reverse mode but may not limit the speed of the motor 330 the next time the trigger is actuated. In other words, the next time the trigger 212 is actuated, the power tool 102a may operate at full reverse speed in accordance with the actuation of the trigger 212. On the other hand, in embodiments where the electronic processor 305 switched the power tool 102a to reverse mode without requiring the user to actuate the forward/reverse selector 219 (at block 1415), the electronic processor 305 may switch the power tool 102a back to forward mode. In such embodiments, the next time the trigger 212 is actuated, the power tool 102a may operate at full forward speed in accordance with the actuation of the trigger 212. In one or both of these embodiments, the electronic processor 305 may control the speed of the motor 330 to gradually increase speed to allow the user to realize the direction and speed in which the motor 330 is set to operate.

In some embodiments, any of the previously-explained kickback and loss of control features and methods may be optionally executed by the electronic processor 305 based on instructions received from the external device 108. For example, the graphical user interface 505 may include additional toggle switches to allow the user to select which kickback control features and methods should be implemented as well as the kickback sensitivity parameters of each kickback control feature or method. For example, the graphical user interface 505 may receive an indication of whether to enable adjustment of kickback sensitivity parameters based on at least one of orientation of the power tool 102a (FIG. 7), a battery characteristic of the battery pack coupled to the power tool 102a (FIG. 9), and kickback events (FIG. 10). The graphical user interface 505 may also receive an indication from the user of whether to enable power reduction based on tool walk (FIG. 12) or whether to enable one of the reverse rotation methods of FIGS. 13 and 14 when the power tool 102a becomes bound in a workpiece.

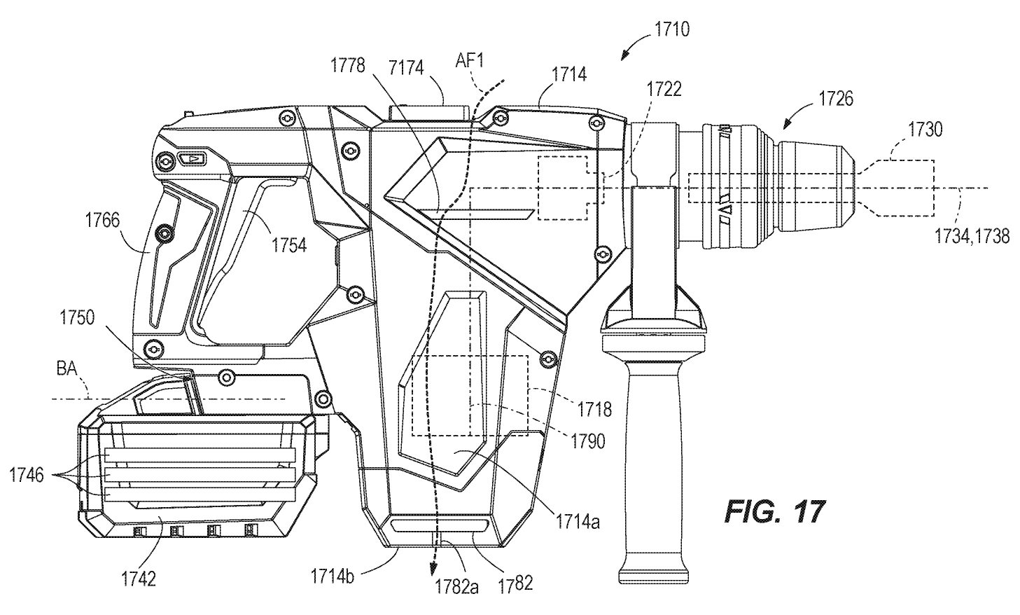

FIG. 17 illustrate a reciprocating percussive power tool, such as a rotary hammer 1710, according to an embodiment of the invention. The rotary hammer 1710 may implement one or more of the kickback and loss of control functions described herein, such as, for example, the method 1550 illustrated in FIGS. 15B and/or 18A and 18B. The rotary hammer 1710 includes a housing 1714, a motor 1718 disposed within the housing 1714, and a rotatable spindle 1722 coupled to the motor 1718 for receiving torque from the motor 1718. In the illustrated embodiment, the rotary hammer 1710 includes a quick-release mechanism 1726 coupled for co-rotation with the spindle 1722 to facilitate quick removal and replacement of a tool bit 1730. The rotary hammer 1710 defines a tool bit axis 1734, which in the illustrated embodiment, is coaxial with a rotational axis 1738 of the spindle 1722.

In the illustrated embodiment, the motor 1718 is configured as a brushless direct current (BLDC) motor that receives power from a power source 1742 (e.g., a battery pack) that is selectively coupled to the rotary hammer 1710. The battery pack 1742 may include any of a number of different nominal voltages (e.g., 12V, 18V, etc.), and may be configured having any of a number of different chemistries (e.g., lithium-ion, nickel-cadmium, etc.). In some embodiments, the battery pack 1742 is a battery pack 1742 including a plurality of battery cells 1746. The battery cells 1746 may be cylindrical cells, pouch cells, button cells, prismatic cells, or any other type of battery cell. Each battery cell 1746 of the battery pack 1742 may be physically oriented within the battery pack 1742 in any suitable arrangement. For example, the battery pack 1742 illustrates battery cells 1746 (e.g., pouch cells) oriented in a direction parallel to the bit axis 1734 where the battery pack 1742 is coupled to the rotary hammer 1710. In other embodiments, battery cells 1746 (e.g., cylindrical cells) may be oriented parallel to a drive train when the battery pack 1742 is coupled to the rotary hammer 1710. The battery cells 1746 may be electrically coupled to one another in any series, parallel, or other electrical arrangement. Terminals of the battery cells 1746 may be electrically coupled with battery terminals (not shown) configured to be removably coupled to a battery receptacle 1750 of the housing 1714. The battery terminals are dimensioned and made of electrically conductive material such that the battery terminals can pass current (e.g., power) from the battery pack 1742 to the rotary hammer 1710 via the battery receptacle 1750. The battery receptacle 1750 is configured to receive the battery pack 1742 and to mechanically couple and electrically couple the battery pack 1742 to the rotary hammer 1710. In the illustrated embodiment, the battery pack 1742 is configured to be coupled to the battery receptacle 1750 by relative translation of the battery pack 1742 along a battery axis BA. In the illustrated embodiment, a battery axis BA extends in parallel with the tool bit axis 1734.

The motor 1718 is selectively activated by depressing an actuating member, such as a trigger 1754, which in turn actuates an electrical switch. The switch is electrically connected to the motor 1718 via an electronic control unit (including, for example, an electronic processor, such as, for example, the electronic processor 305 described herein and/or one or more circuits) for controlling operation of the motor 1718. In the illustrated embodiment, the trigger 1754 is positioned adjacent a handle 1766 of the rotary hammer 1710, and the electrical switch may be positioned within the handle 1766.

The rotary hammer 1710 further includes a drive train that selectively provides axial and/or rotational movement of the tool bit 1730 based on the position of a mode selection dial 1774. The mode selection dial 1774 is movable (e.g., rotatable) by an operator to switch between various positions corresponding with various operating modes of the rotary hammer 1710. In a “combined hammer and drilling” mode, the motor 1718 is drivably coupled to the drive train such that the rotary hammer 1710 is configured to axially and rotationally move the tool bit 1730. In a “hammer-only” mode (i.e., “chisel” mode), the motor 1718 is drivingly coupled to the drive train for reciprocation while the spindle 1722 is not rotated by the motor 1718. In other words, in the “hammer-only” mode (i.e., “chisel” mode), the rotary hammer 1710 is configured to axially move the tool bit 1730. In a “drill-only” mode, the motor 1718 is drivingly coupled to the spindle 1722 for rotation, while the drive train is not driven by the motor 1718. In other words, in the “drill-only” mode, the rotary hammer 1710 is configured to rotationally move the tool bit 1730. In a “chisel adjustment mode” (i.e., “hammer adjustment mode”), the spindle 1722 is unlocked from the motor 1718, and the spindle 1722 is permitted to freely rotate within the housing 1714 such that a user may adjust (e.g., move) the orientation of the spindle 1722 and thus the tool bit 1730 to a desired orientation. In other rotary hammers 1710, more or fewer operating modes may be possible.

As shown in FIG. 17, the housing 1714 includes an inlet opening 1778 in at least one side surface 1714a thereof (e.g., a right side, closest to the viewer as viewing FIG. 17, and a left side, furthest from the viewer as viewing FIG. 17). In the illustrated embodiment, the inlet opening 1778 is positioned between the motor 1718 and the mode selection dial 1774. However, in other embodiments, the inlet opening 1778 may be otherwise positioned upstream of the motor 1718. The housing 1714 further includes a plurality of exhaust openings 1782 positioned at the bottom of the housing 1714. In the illustrated embodiment, the exhaust openings 1782 are provided in a sidewall of the housing 1714. Additionally or alternatively, exhaust openings 1782a may be provided in an axial end wall 1714b of the housing 1714. In other embodiments, the exhaust openings 1782 may be otherwise positioned downstream of at least the motor 1718, and preferably downstream of both the motor 1718 and the electronic control unit. For example, the exhaust openings 1782 may be positioned adjacent a bottom surface of the housing 1714, but exhaust air in a direction perpendicular to a rotational axis 1790 of the motor 18 and into and/or out of the page as viewed in FIG. 17. For context, the axial end wall 1714b of the housing 1714 including the exhaust openings 1782a is positioned at an axial end of the housing 1714 relative to the rotational axis 1790. In the illustrated embodiment, the electronic control unit may be positioned between the motor 1718 and the exhaust openings 1782.

With continued reference to FIG. 17, the motor 1718 is coupled to a motor fan (not shown), which generates an airflow AF1 (e.g., a first airflow) through (e.g., within) the housing 1714 in response to rotation of the motor 1718. During operation of the rotary hammer 1710, the motor 1718 and the electronic control unit (e.g., electronic processor 305) generate heat. The airflow induced by the motor fan passes through the inlet opening 1778, through and around the motor 1718, and around the electronic control unit, thereby transferring heat from the motor 1718 and the electronic control unit to the airflow. The heated airflow is then exhausted from the housing 1714 via the exhaust openings 1782.

The rotary hammer 1710 may also include one or more sensors as described above with respect to the power tool 102a, such as, for example, the movement sensor 350, the orientation sensor 345, the force sensor(s) 220, the Hall sensors 355, the current sensor 340, or a combination thereof. Accordingly, the electronic processor included in the rotary hammer 1710 may include similar components as illustrated in FIG. 3 and may use data from one or more of the sensors described herein to perform one or more of the kickback and loss of control features described herein.

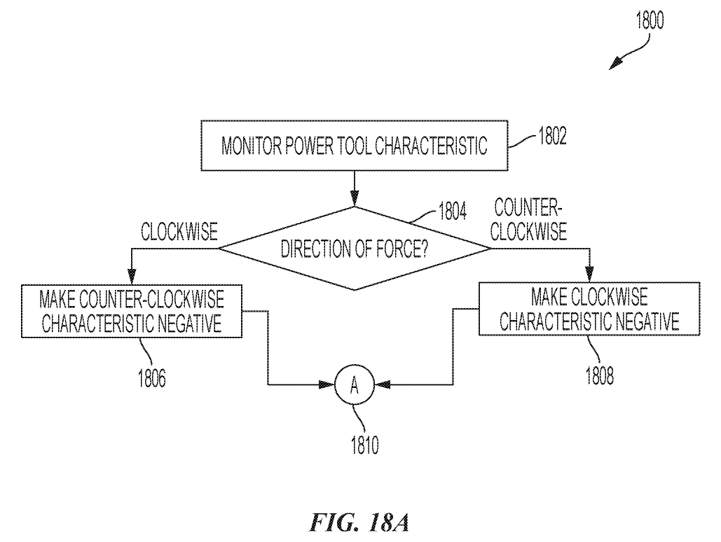

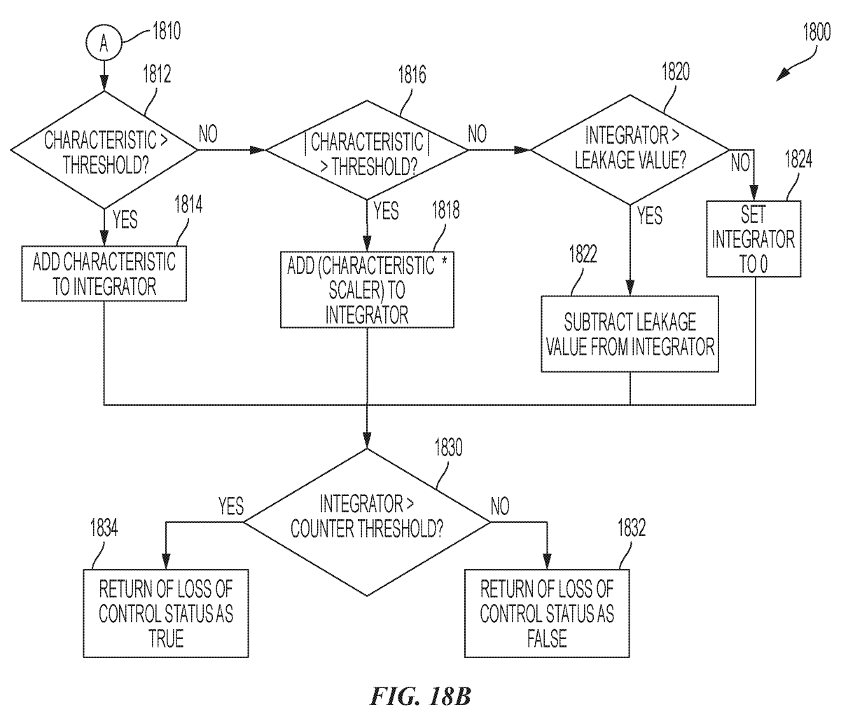

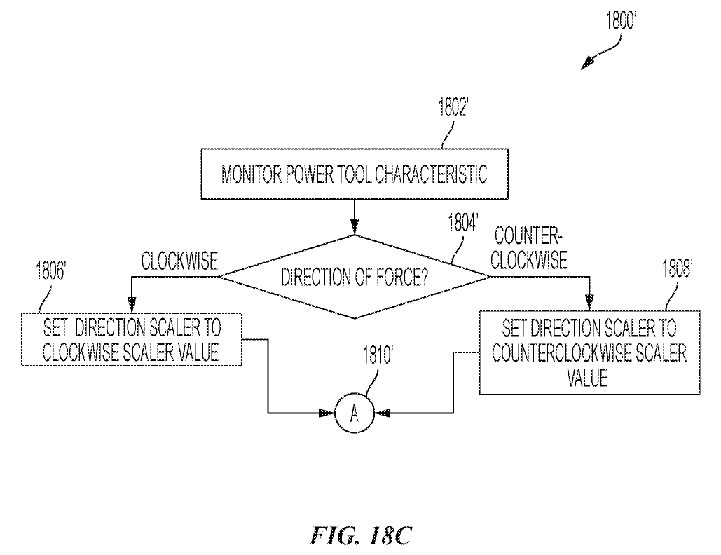

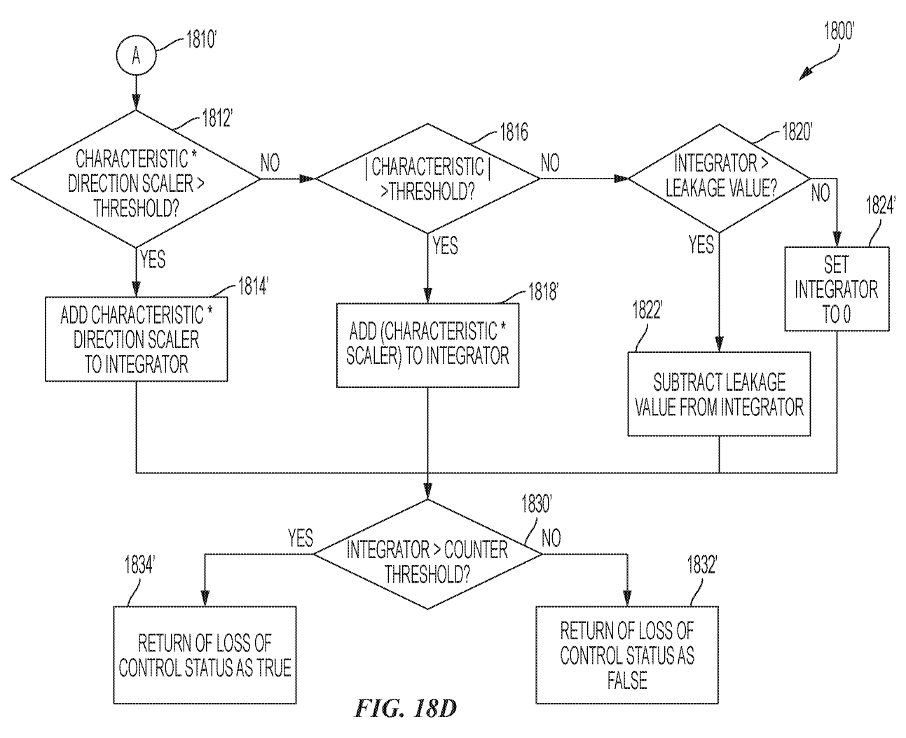

FIGS. 18A and 18B illustrate a flowchart of another method 1800 of detecting particular operation of the power tool 102a (e.g., the rotary hammer 1710) and ceasing driving of the motor 330 in response to detecting the operation. The method 1800 is described with respect to detecting a loss of control event of the power tool 102a. As used herein, “loss of control” may be a state in which the tool enters a bind event that causes excess rotation of the power tool 102a due to the user not providing enough counter torque on the power tool 102. A “loss of control” event, when detected, can be prevented by braking the motor 330 of the power tool 102, which prevents the tool from over rotating.

Similar to the method 1500, the method 1800 is performed during operation of the motor 330 (i.e., while the power tool 102a is running or being operated or used) and includes detecting loss of control of the power tool 102a based on a monitored characteristic of the power tool 102, such as, for example, angular velocity of the housing. As described herein, the method 1800 compares detected angular velocity to a velocity threshold and uses an integrator to track a position of the power tool 102a over a period time to detect a loss of control event.

In some embodiments, the time period (during which the integrator is maintained tracking a positional change of the power tool 102) is a predetermined time period (for example, 250 milliseconds, 500 milliseconds, one second, or the like). In other embodiments, the time period is not predetermined and instead the time period lasts for as long as the trigger 212 is actuated and the power tool 102a is running. In other words, a value of the integrator described herein with respect to FIGS. 18A and 18B may rise and fall for as long as the power tool 102a is running and may be reset (e.g., be set to a value of zero) when the trigger 212 is released. As described herein, by effectively accumulating positional changes of the housing in both a loss of control direction and a controlled direction, the integrator functions similar to the other counter values described herein that function as a leaky accumulator.

As illustrated in FIG. 18A, at block 1802 of the method 1800, the electronic processor 305 monitors a power tool characteristic (e.g., angular velocity of the housing) of the power tool 102a using information from one or more sensors or components of the power tool 102a (e.g., using information received from the movement sensor 350). The detected angular velocity may represent movement of the housing in one of two possible directions (e.g., clockwise rotation or counter-clockwise rotation around the rotational axis of the power tool 102a), wherein, depending on whether a direction of force applied via the tool 102a (e.g., via a drill bit, grinder disk, etc.) is in a clockwise direction or a counter-clockwise direction, one direction represents unintended or uncontrolled movement (e.g., loss of control movement) and the other direction represents intended or user-controlled movement. For example, when the direction of force applied via operation of the power tool 102 (e.g., a direction of rotation of a drill bit, grinder disk, or other component of the power tool 102a) is clockwise, (i) rotation of the housing in a clockwise direction may represent loss of control movement as the housing is rotating with the tool components and (ii) rotation of the housing in a counter-clockwise direction (i.e., opposite the direction of force) may represent controlled movement (e.g., movement by the user to counter the rotational movement of the tool components). In contrast, when the direction of force applied via operation of the power tool 102 (e.g., a direction of rotation of a drill bit, grinder disk, or other component of the power tool 102) is counter-clockwise, (i) rotation of the housing in a counter-clockwise direction may represent loss of control movement as the housing is rotating with the tool components and (ii) rotation of the housing in a clockwise direction (i.e., opposite the direction of force) may represent controlled movement (e.g., movement by the user to counter the rotational movement of the tool components). In other words, rotation of the tool housing opposite the direction of force (e.g., direction of rotation of the drill bit, grinder disk, etc.) is considered a loss of control direction, and rotation of the tool housing in the same direction as the direction of force (e.g., direction of rotation of the drill bit, grinder disk, etc.) is considered a controlled direction. In some implementations, depending on the configuration of the power tool 102a, the direction of force may correspond to the direction of rotation of the motor 330. However, in other configurations, the direction of force may be opposite the direction of the rotation of the motor 330.

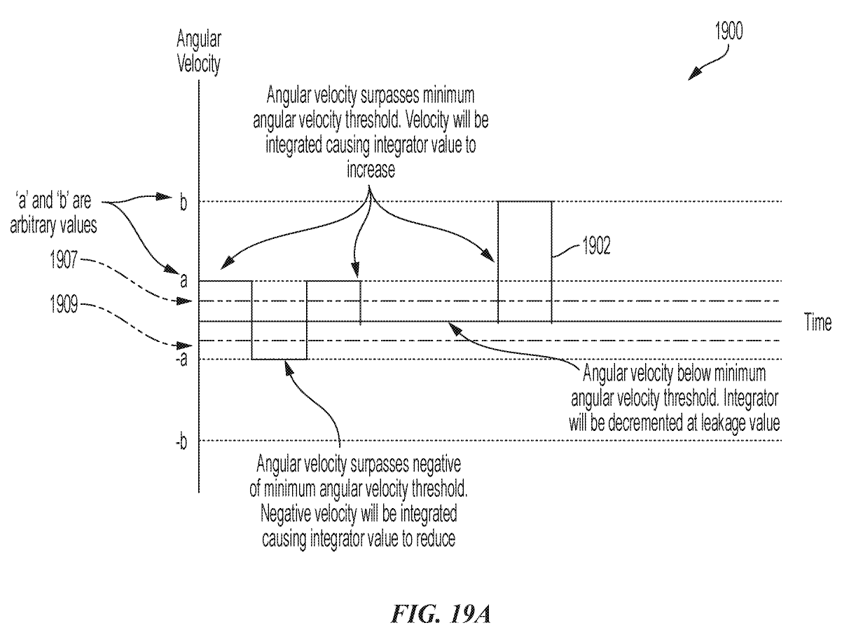

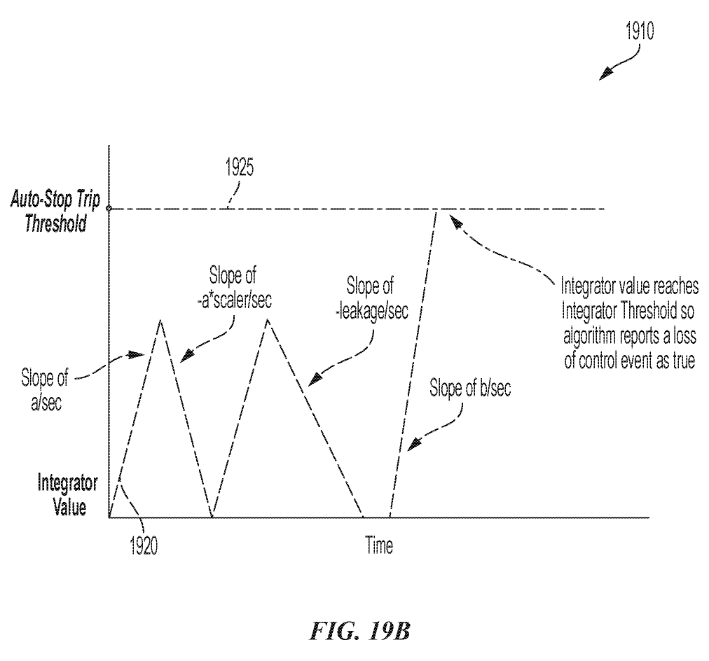

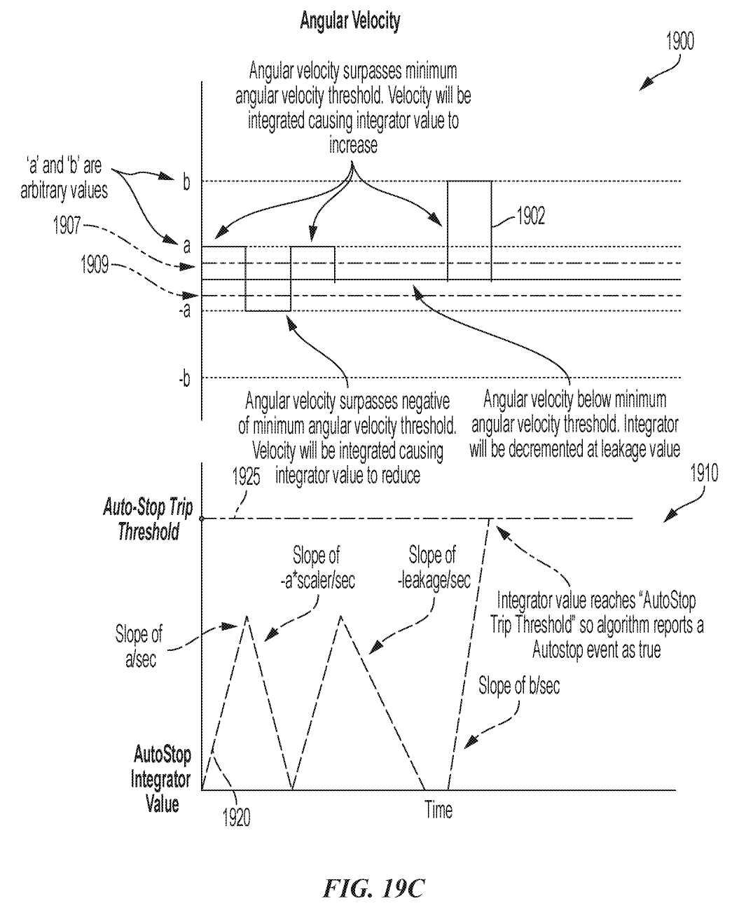

Accordingly, as illustrated in FIG. 18A, the electronic processor 300 determines a direction of force (e.g., based on a direction of rotation of the drill bit, a grinder disk, etc. or a direction of rotation of the motor 330) (at block 1804) and uses this direction of rotation to set the detected angular velocity negative when the detected velocity is in an opposite direction as the direction of force (i.e., representing controlled movement), which means that detected velocity in the same direction as the direction of force rotation will be represented as positive velocity. In particular, when the direction of force is clockwise, the electronic processor 300 makes detected velocity in the counter-clockwise direction negative (at block 1806) and, when the direction of force is counter-clockwise, the electronic processor 300 makes detected velocity in the clockwise direction negative (at block 1808). Accordingly, after blocks 1804, 1806, and 1806, detected angular velocity of the housing that represents potential loss of control (i.e., rotation in the same direction as the direction of force) is represented as positive angular velocity and detected angular velocity of the housing that represents unlikely loss of control (i.e., rotation in an opposite direction as the direction of force) is represented as negative angular velocity. At block 1812 (see FIG. 18B through connecting point 1810), the electronic processor 305 determines whether the monitored power tool characteristic (i.e., angular velocity) exceeds an associated threshold (e.g., a rotational speed threshold). In response to the detected angular velocity exceeding the velocity threshold (i.e., detected velocity is positive and has a value that exceeds the threshold), the electronic processor 305 adds the monitored characteristic (i.e., the value of the detected angular velocity) to an integrator (at block 1814). The integrator functions as an accumulator that tracks a positional change of the housing. As a non-limiting example and as illustrated in graph 1900 in FIG. 19A, assume the angular velocity of the housing (represented by line 1902 tracked over time) is detected as being positive ‘a’ distance units (e.g., degrees, radians, etc.) per second and ‘a’ exceeds the applicable velocity threshold (e.g., a positive minimum angular velocity threshold 1907 as the velocity is positive, whereas a negative minimum angular velocity threshold 1909 would be applied when the velocity is negative). In this situation, the positive value ‘a’ is added to the value of the integrator, which means that while the detected velocity remains at positive ‘a’, the integrator value increases at a rate of ‘a’ per second.

In some embodiments, the velocity value may be modified before adding the value to the integrator, such as, for example, to align a rate of detection of angular velocity with a rate of the angular velocity. For example, when angular velocity is represented as a value per second but is detected once per millisecond, the detected velocity value may be divided by 1000 (i.e., multiplied by 1/1000) to represent a positional change over the time period of one millisecond and this positional change is added to the integrator. In other words, the electronic processor 305 may be configured to add the value of the angular velocity to the integrator by multiplying the detected angular velocity of the housing by a detection rate of the power tool characteristic monitored by the sensor to calculate a positional change of the housing and add the positional change to the integrator.

In some embodiments, a scaler is applied to the positive velocity value added to the integrator at block 1818 to cause the integrator value to quickly increase in response to high velocity values.

In response to the monitored power tool characteristic (i.e., angular velocity) not exceeding the associated threshold (e.g., a rotational speed threshold), the electronic processor 305 determines whether the absolute value of the characteristic (i.e., angular velocity) exceeds the threshold (at block 1816). In other words, at block 1816, the electronic processor 305 effectively checks for a negative detected angular velocity (representing controlled movement) exceeding the threshold, which likely represents corrective movement performed by a user (e.g., to counter rotation of the housing due to rotation of the drill bit, grinder disk, or other rotating component of the power tool 102a). In response to the absolute value of the detected angular velocity exceeding the velocity threshold (i.e., detected velocity is negative and has a value that exceeds the threshold), the electronic processor 305 adds the value of the monitor characteristic (i.e., the negative value of the detected angular velocity) to the integrator (at block 1818). Accordingly, when negative angular velocity is detected that exceeds the velocity threshold, the negative value is added to the integrator, which effectively decrements the integrator to represent that corrective rotation has occurred.

Similar to the value added to the integrator at block 1814, the value added to the integrator at block 1818 may be modified (e.g., convert a per second velocity to a positional change over a millisecond as angular velocity is detected and processed on a per millisecond basis). In other words, the electronic processor 305 may be configured to add the value of the angular velocity to the integrator by multiplying the detected angular velocity of the housing by a detection rate of the power tool characteristic monitored by the sensor to calculate a positional change of the housing and add the positional change to the integrator.

In some embodiments, a scaler is applied to the negative velocity value added to the integrator at block 1818 to cause the integrator value to quickly return to zero in response to detected corrective rotation by a user (i.e., indicating that no loss of control movement is occurring). In some embodiments, the scaler value can range of 0.5 to 2.0 or from 2.0 to 5.0.

As illustrated in FIG. 18B, in response to the absolute value of the characteristic not exceeding the velocity threshold, the value of the integrator is compared to a predetermined leakage value (e.g., 0-10 degrees/millisecond) (at block 1820). In response to the integrator value exceeding the leakage value, the electronic processor 303 subtracts the leakage value from the integrator (at block 1822). In response to the integrator not exceeding the leakage value, the integrator is set to a value of zero (at block 1824). Accordingly, at block 1820, the electronic processor 305 has already identified that the detected value (positive or negative) does not exceed the velocity threshold and therefore, the integrator value should be effectively decremented to represent a reduced likelihood of a loss of control event. In this situation, rather than adding the actual detected value (e.g., positive or negative), the predefined leakage rate is used to represent a controlled decrement of the integrator value. Also, by comparing the integrator value to the leakage value, the electronic processor 303 can ensure that the integrator value does not go negative, which could create a situation where a loss-of-control event exists for an extended period of time before a corrective action is taken as the integrator has to initially increase to zero before increasing to a value that triggers the corrective action.

FIG. 19B is a graph 1910 representing values of the integrator over a period of time corresponding with the period of time illustrated in the graph 1900 of FIG. 19A associated with detected angular velocity 1902 (see, e.g., FIG. 19C for both graphs 1900 and 1910 aligned in time). As shown in FIG. 19B, the value of the integrator (represented by line 1920) increases and decreases, respectively, with positive and negative detected angular velocity 1902 (see FIG. 19A) exceeding the applicable velocity thresholds 1907 and 1909 (i.e., based on the value of the detected velocity to track positional changes of the housing over time). As also illustrated in FIG. 19B, when the positive or negative detected angular velocity does not exceed the applicable velocity threshold 1907 or 1909, the value of the integrator decreases according to a predetermined leakage value until the integrator value reaches zero.

From blocks 1814, 1818, 1822, and 1824, the electronic processor 303 determines whether the value of the integrator exceeds an auto-stop trip threshold (also referred to herein as an integrator threshold) (at block 1830). In response to the integrator value not exceeding the auto-stop trip threshold, no loss of control event is detected, and a loss of control status may be returned as “false” (at block 1832). Other components or modules of the power tool may consume this returned value to take appropriate action as applicable. Block 1832 may lead back to block 1802 (see FIG. 18A) to continue checking for a loss of control event. As also noted above, in some embodiments, the electronic processor 305 executes the method 1800 as the power tool 102a is running (i.e., the motor 330 is operating) and may reset the counter when the trigger 212 is released or when a predetermined time period elapses. For example, an additional conditional block may be added before looping back to block 1802 in which the electronic processor 305 determines whether the predetermined time period has elapsed, the trigger has been released, or both, and, when true, resets the integrator value to zero. Further, when the trigger has been released and the integrator value is reset, the electronic processor 305 may cease running the method 1800 until the next trigger pull.

In response to the integrator value exceeding the auto-stop trip threshold (see line 1920 in FIG. 2B exceeding the threshold represented by line 1925), a loss of control event is detected a loss of control status may be returned as “true” (at block 1834). As described herein, the loss of control event may trigger an auto-stop function or event, which stops the motor 330 (e.g., through controlling the switching network 325 to cease driving of the motor).

The auto-stop trip threshold may be a static value or may be dynamically adjusted similar to the auto-stop trip threshold described herein with respect to method 1550. For example, in the method 1880, the auto-stop trip threshold may be dynamically adjusted based on one or more power tool characteristics (e.g., different from the power tool characteristic used to increment and decrement the integrator). For example, in some implementations, the auto-stop trip threshold used in the method 1800 is dynamically set based on motor current, motor speed (e.g., RPM or RPM droop), or a combination thereof as described above with respect to the method 1500.

It should be understood that rather than making detected angular velocity positive or negative to track whether the rotation supports or counters a loss-of-control event, the electronic processor 300 may set a flag or may check whether the detected rotation is in the same or opposite direction as the direction of force at subsequent blocks of the method 1800. Using the negative and positive distinguisher, however, reduces the complexity and computational requirements of the method 1800.

For example, FIG. 18C and 18D illustrate an alternative version of the method 1800 (labeled as method 1800’) used in some embodiments. It should be understood that blocks repeated in both method 1800 and method 1800’ (e.g., block 1802 repeated in method 1800’ as block 1802’) may operate the same unless described herein as being different.

As illustrated in FIG. 18C, rather than making a detected angular velocity negative to flag rotational movement in a controlled manner (see blocks 1806 and 1808 in FIG. 18A), a value of a direction scaler (which is distinct from a scaler used to have the integrator “leak” as described above) is set to a negative or positive value. In particular, as illustrated in FIG. 18C, a direction scaler is set to a clockwise scaler value when the direction of force is clockwise (at block 1806’), and the direction scaler is set to a counterclockwise scaler value when the direction of force is counterclockwise (at block 1808’). The clockwise and counterclockwise scaler values are predetermined values so that angular velocity is positive when in the loss of control direction regardless of the direction of force (e.g., a direction of rotation of the motor).

As a non-limiting example, assume a Tool A experiences loss of control rotation in a positive angular velocity (as measured by the gyroscope) when the direction of force (e.g., motor rotation) is in a clockwise direction. Since the velocity is positive when in the loss of control direction, the direction scaler is set to a positive value (e.g., 1) so that a positive value is added to the integrator when the tool housing spins in the positive angular velocity direction. Similarly, the Tool A experiences loss of control rotation in a negative angular velocity when the direction of force (e.g., motor rotation) is in a counterclockwise direction. Accordingly, since the velocity is negative in the loss of control direction, the direction scaler is set to a negative value (e.g., -1) so that a positive value (resulting from the multiplication of a negative velocity and a negative direction scaler value) is added to the integrator when the tool housing spins in the negative angular velocity direction.

As another example, assume a Tool B experiences loss of control rotation in a negative angular velocity (as measured by the gyroscope) when the direction of force (e.g., motor rotation) is in a clockwise direction. Since the velocity is negative when in the loss of control direction, the scaler is set to a negative value (e.g., -1) so that a positive value (resulting from the multiplication of a negative velocity and a negative scaler value) is added to the integrator when the tool housing spins in the negative angular velocity. Similarly, the Tool B experiences loss of control rotation in a positive angular velocity when the direction of force (e.g., motor rotation) is in a counterclockwise direction. Accordingly, since the velocity is positive in the loss of control direction, the scaler value is set to a positive value (e.g., 1) so that a positive value is added to the integrator when the tool housing spins in the positive angular velocity direction. Accordingly, the direction scaler value allows the method 1800 to be used regardless of whether the power tool 102 experiences angular velocity in the loss of control direction as a positive or negative direction.

As illustrated in FIG. 18D, at block 1812’ (through connecting point 1810’ in FIG. 18C), the electronic processor 305 determines whether the monitored power tool characteristic (i.e., angular velocity) multiplied by the direction scale value exceeds an associated threshold (e.g., a rotational speed threshold). In response to the product of these values exceeding the velocity threshold, the electronic processor 305 adds the product (i.e., the value of the detected angular velocity multiplied by the direction scaler) to an integrator (at block 1814’). As described above, the direction scaler is used to ensure that a positive value is added to the integrator in response to detected loss of control rotation of the tool housing (i.e., regardless of whether such rotation is detected as being positive or negative).

As compared to the method 1550 described herein, the methods 1800 and 1800’ use a single threshold value associated with angular velocity, which reduces the complexity and computational requirements of the loss-of-control. For example, as illustrated in FIG. 19A, a single threshold is applied to detected angular velocity (whether positive or negative through the use of the absolute value) and, rather than using different increment and decrement values associated with different threshold buckets as described above with respect to the method 1550, the value of the detected angular velocity is integrated or converted into a positional change, which is accumulated by the integrator to track an amount of loss-of-control movement as well as an amount of corrective movement (e.g., by adding positive and negative positional changes of the housing to the integrator value). Accordingly, the integrator tracks the positional displacement of the housing (e.g., rotation about the rotational axis of the power tool) to detect a loss of control event before a tool over rotates. In other words, as compared to tracking a speed or acceleration of rotation by the housing, the methods 1800 and 1800’ track a positional change of the housing to accurately detect and respond to loss of control events.

It should be understood that the various kickback and loss of control features described herein can be used in various combinations. For example, in some embodiments, the dynamic auto-stop trip threshold feature (see, e.g., FIG. 15B and/or 18A and 18B) may be used in combination with one or more of the kickback control features described herein (e.g., setting a kickback sensitivity parameter based on orientation of the tool, grip parameters, battery characteristics, etc.).

In addition to the previously described velocity thresholds used as part of detecting a loss of control event, any embodiment described herein may also include a bypass velocity threshold. For example, in some instances, the electronic processor 305 is further configured to implement a bypass angular velocity threshold during operation of the power tool 102a that represents an angular velocity of the housing that, when exceeded, results in an immediate and non-conditional shutdown of the motor 330 (e.g., as compared to waiting until various counters, integrators, increments, or the like reach various thresholds or counts). Thus, in response to a single measurement of the angular velocity of the housing obtained from the movement sensor 350 exceeding the bypass velocity threshold, the electronic processor 305 bypasses any incrementing steps (e.g., of block 1565 or block 1814) and controls the switching network 325 to cease driving of the motor 330. The bypass velocity threshold allows for an immediate stopping (shutdown) of the tool (e.g., the motor) in response to a particular angular velocity that clearly represents a loss of control event without waiting for an accumulated count or positional change to reach an auto-stop trip threshold as described herein.

In some examples, the value of the bypass velocity threshold is set as the highest velocity threshold within the memory 310, exceeding other angular velocity thresholds used as part of auto-stop operation (e.g., the plurality of thresholds 1567 as illustrated in FIG. 15C). In some embodiments, the electronic processor 305 dynamically adjusts the bypass threshold based on one or more operating parameters of the tool 102a, such as, for example, the orientation of the power tool 102a as determined by the orientation sensor 345. For example, when the power tool 102a is in the vertically upward orientation 610, the bypass velocity threshold may be reduced to a more sensitive value compared to the horizontal orientation 605, reflecting the increased difficulty in maintaining tool control during overhead drilling. In other examples, the bypass velocity threshold may be fixed and not dynamic. Furthermore, the electronic processor 305 may set the bypass velocity threshold based on a battery characteristic received via the battery pack interface 320, such as the weight or electrical current output capability of the battery pack 102b, to account for changes in the moment of inertia of the power tool 102a.

The examples described herein may be combined with each other. Furthermore, although the examples are described with respect to their respectively illustrated embodiments, it should be understood that any example described may fully perform any process from another example, in part or in full. The following are examples of the present disclosure. It should be understood that any of the examples may be combined to include some or all of the features of any other example. Likewise, any of the features of the illustrations as described herein may be included in any combination with any of the examples.

Example 1. A power tool comprising: a housing; a motor within the housing and having a rotor and a stator, the rotor configured to rotationally drive a motor shaft about a rotational axis; a first sensor configured to monitor a power tool characteristic; a second sensor configured to measure a motor characteristic, wherein the motor characteristic includes at least one selected from a group consisting of motor current and motor speed; a switching network electrically coupled to the motor; and an electronic processor connected to the switching network, the first sensor, and the second sensor, the electronic processor configured to implement an auto-stop function of the power tool, wherein, to implement the auto-stop function, the electronic processor is configured to, while the motor is operating: increment a counter based on the power tool characteristic monitored by the first sensor, set an auto-stop trip threshold based on at least one selected from the group consisting of motor current and motor speed as measured by the second sensor, determine, based on a value of the counter exceeding the auto-stop trip threshold, that a loss of control event is occurring, and control, in response to determining that the loss of control event is occurring, the switching network to cease driving of the motor.

Example 2. The power tool of example 1, wherein the motor speed is represented as a revolutions per minute (RPM) droop.

Example 3. The power tool of any of examples 1 to 2, wherein the electronic processor is configured to set the auto-stop trip threshold by: mapping the motor current to a threshold value using a relationship mapping motor current values to a plurality of threshold values between a maximum auto-stop trip threshold and a minimum auto-stop trip threshold, and setting the auto-stop trip threshold to the threshold value defined via the relationship.

Example 4. The power tool of example 3, wherein the relationship is a linear relationship.

Example 5. The power tool of example 3, wherein the relationship maps the motor current values to decreasing auto-stop trip threshold values as motor current increases.

Example 6. The power tool of any of examples 1 to 5, wherein the electronic processor is configured to set the auto-stop trip threshold by: mapping the motor speed to a threshold value using a relationship mapping motor speed values to a plurality of threshold values between a maximum auto-stop trip threshold and a minimum auto-stop trip threshold, and setting the auto-stop trip threshold to the threshold value defined via the relationship.

Example 7. The power tool of example 6, wherein the relationship is a linear relationship.

Example 8. The power tool of example 6, wherein the motor speed values represent speed droop values and wherein the relationship maps the motor speed droop values to decreasing auto-stop trip threshold values as motor speed droop increases.

Example 9. The power tool of any of examples 1 to 8, wherein the electronic processor is configured to set the auto-stop trip threshold by: mapping the motor current to a first threshold value using a first relationship mapping motor current values to a plurality of threshold values between a maximum auto-stop trip threshold and a minimum auto-stop trip threshold, mapping the motor speed to a second threshold value using a second relationship mapping motor speed values to a plurality of threshold values between the maximum auto-stop trip threshold and the minimum auto-stop trip threshold, and setting the auto-stop trip threshold based on the first threshold value and the second threshold value.

Example 10. The power tool of example 9, wherein the electronic processor is configured to set the auto-stop trip threshold based on the first threshold value and the second threshold value by setting the auto-stop trip threshold to the lower of the first threshold value and the second threshold value.

Example 11. The power tool of example 9, wherein the electronic processor is configured to set the auto-stop trip threshold based on the first threshold value and the second threshold value by setting the auto-stop trip threshold to an average of the first threshold value and the second threshold value.

Example 12. The power tool of any of examples 1 to 11, wherein the power tool characteristic includes a measurement of an angular velocity of the housing of the power tool.

Example 13. The power tool of any of examples 1 to 12, wherein the electronic processor is configured to increment the counter based on the power tool characteristic by determining a highest threshold of a plurality of thresholds that the power tool characteristic exceeds and incrementing the counter according to an incrementing rate associated with the highest threshold.

Example 14. The power tool of any of examples 1 to 13, wherein the electronic processor is further configured to decrement the counter based on the power tool characteristic.

Example 15. A method for detecting loss of control of a power tool, the method comprising: incrementing, during operation of a motor of the power tool, a counter based on a power tool characteristic; setting, during the operation of the motor, an auto-stop trip threshold based on at least one selected from a group consisting of a motor current and a motor speed; determining, based on a value of the counter exceeding the auto-stop trip threshold, that a loss of control event is occurring; and controlling, in response to determining that the loss of control event is occurring, a switching network of the power tool to cease driving of the motor.

Example 16. The method of example 15, wherein the motor speed is a represented as revolutions per minute (RPM) droop.

Example 17. The method of any of examples 15 to 16, wherein setting the auto-stop trip threshold includes: mapping the motor current to a threshold value using a relationship mapping motor current values to a plurality of threshold values between a maximum auto-stop trip threshold and a minimum auto-stop trip threshold, and setting the auto-stop trip threshold to the threshold value defined via the relationship.

Example 18. The method of example 17, wherein the relationship is a linear relationship and maps the motor current values to decreasing auto-stop trip threshold values as motor current increases.

Example 19. The method of any of examples 15 to 18, wherein setting the auto-stop trip threshold includes: mapping the motor speed to a threshold value using a relationship mapping motor speed values to a plurality of threshold values between a maximum auto-stop trip threshold and a minimum auto-stop trip threshold, and setting the auto-stop trip threshold to the threshold value defined via the relationship.

Example 20. The method of example 19, wherein the relationship is a linear relationship and maps the motor speed values to decreasing auto-stop trip threshold values as motor speed increases.

Example 21. The method of any of examples 15 to 20, wherein setting the auto-stop trip threshold includes: mapping the motor current to a first threshold value using a first relationship mapping motor current values to a plurality of threshold values between a maximum auto-stop trip threshold and a minimum auto-stop trip threshold, mapping the motor speed to a second threshold value using a second relationship mapping motor speed values to a plurality of threshold values between the maximum auto-stop trip threshold and the minimum auto-stop trip threshold, and setting the auto-stop trip threshold based on the first threshold value and the second threshold value.

Example 22. The method of example 21, wherein setting the auto-stop trip threshold based on the first threshold value and the second threshold value includes setting the auto-stop trip threshold to a lower value of the first threshold value and the second threshold value.

Example 23. A power tool comprising: a housing; a motor within the housing and having a rotor and a stator, the rotor configured to rotationally drive a motor shaft about a rotational axis; a sensor configured to monitor a power tool characteristic; a switching network electrically coupled to the motor; and an electronic processor connected to the switching network and the sensor, the electronic processor configured to implement an auto-stop function of the power tool, wherein, to implement the auto-stop function, the electronic processor is configured to, while the motor is operating: determine an angular velocity of the housing about the rotational axis based on the power tool characteristic monitored by the sensor, compare the angular velocity to a velocity threshold, in response to the angular velocity exceeding the velocity threshold, add a value of the angular velocity to an integrator, determine, based on a value of the integrator exceeding an auto-stop trip threshold, that a loss of control event is occurring, and control, in response to determining that the loss of control event is occurring, the switching network to cease driving of the motor.

Example 24. The power tool of example 23, wherein the electronic processor is configured to add the value of the angular velocity to the integrator by multiplying the angular velocity of the housing by a detection rate of the power tool characteristic monitored by the sensor to calculate a positional change of the housing and add the positional change to the integrator.

Example 25. The power tool of any of example 23 to 24, wherein the electronic processor is configured to add the value of the angular velocity to the integrator by, in response to the angular velocity of the housing being opposite to a direction of force applied via operation of the power tool, adding the angular velocity of the housing multiplied by a scaler value to the integrator.

Example 26. The power tool of any of examples 23 to 25, wherein the electronic processor is further configured to make a value of the angular velocity of the housing negative in response to the angular velocity of the housing being opposite to a direction of force applied via operation of the power tool and wherein the electronic processor is configured to compare the negative angular velocity to the velocity threshold by comparing the negative angular velocity to an absolute value of the velocity threshold.

Example 27. The power tool of any of examples 23 to 26, wherein the electronic processor is further configured to, in response to the angular velocity not exceeding the velocity threshold, subtract a predetermined leakage value from the integrator.

Example 28. The power tool of any of examples 23 to 27, wherein the electronic processor is further configured to, in response to the angular velocity not exceeding the velocity threshold and the integrator having a value less than a predetermined leakage value, set the integrator to a value of zero.

Example 29. The power tool of any of examples 23 to 28, wherein the electronic processor is further configured to determine the auto-stop trip threshold based at least one selected from a group consisting of motor current and motor speed.

Example 30. A method of controlling a motor in a power tool, the method comprising determining, with an electronic processor of the power tool, an angular velocity of a housing of the power tool about a rotational axis of the motor based on a power tool characteristic monitored by a sensor of the power tool, comparing, with the electronic processor, the angular velocity to a velocity threshold, adding, with the electronic processor, a value of the angular velocity to an integrator in response to the angular velocity exceeding the velocity threshold, determining, based on a value of the integrator exceeding an auto-stop trip threshold, that a loss of control event is occurring, and, in response to determining that the loss of control event is occurring, controlling, with the electronic processor, a switching network of the power tool to cease driving of the motor.

Example 31. The method of example 30, wherein adding the value of the angular velocity to the integrator includes multiplying the angular velocity of the housing by a detection rate of the power tool characteristic monitored by the sensor to calculate a positional change of the housing and adding the positional change to the integrator.

Example 32. The method of any of examples 30 to 31, wherein adding the value of the angular velocity to the integrator comprises, in response to the angular velocity of the housing being opposite to a direction of force applied via operation of the power tool, adding the angular velocity of the housing multiplied by a scaler value to the integrator.

Example 33. The method of any of examples 30 to 32, further comprising making a value of the angular velocity of the housing negative in response to the angular velocity of the housing being opposite to a direction of force applied via operation of the power tool, and wherein comparing the angular velocity to the velocity threshold comprises comparing the negative angular velocity to an absolute value of the velocity threshold.

Example 34. The method of any of examples 30 to 33, further comprising, in response to the angular velocity not exceeding the velocity threshold, subtracting a predetermined leakage value from the integrator.

Example 35. The method of any of examples 8 to 34, further comprising, in response to the angular velocity not exceeding the velocity threshold and the integrator having a value less than a predetermined leakage value, setting the integrator to a value of zero.

Example 36. The method of any of examples 30 to 35, further comprising determining the auto-stop trip threshold based on at least one selected from a group consisting of motor current and motor speed.

Example 37. A non-transitory computer-readable medium storing instructions that, when executed by an electronic processor of a power tool, perform a set of functions, the set of functions comprising, determining an angular velocity of a housing of the power tool about a rotational axis based on a power tool characteristic monitored by a sensor of the power tool, comparing the angular velocity to a velocity threshold, in response to the angular velocity exceeding the velocity threshold, adding a value of the angular velocity to an integrator, determining, based on a value of the integrator exceeding an auto-stop trip threshold, that a loss of control event is occurring, and controlling, in response to determining that the loss of control event is occurring, a switching network of the power tool to cease driving a motor of the power tool.

Example 38. The non-transitory computer-readable medium of example 37, the set of functions further comprising making the value of the angular velocity negative in response to the angular velocity being in a direction opposite to a direction of force applied via operation of the power tool, and adding the negative value of the angular velocity to the integrator.

Example 39. The non-transitory computer-readable medium of any of examples 37 to 38, wherein adding the value of the angular velocity to the integrator includes multiplying the angular velocity by a detection rate of the power tool characteristic to calculate a positional change of the housing and adding the positional change to the integrator.

Example 40. The non-transitory computer-readable medium of any of examples 37 to 39, the set of functions further comprising, in response to the angular velocity not exceeding the velocity threshold, subtracting a predetermined leakage value from the integrator.

Example 41. The non-transitory computer-readable medium of any of examples 37 to 40, the set of functions further comprising, in response to the angular velocity not exceeding the velocity threshold and the integrator having a value less than a predetermined leakage value, setting the integrator to a value of zero.

Example 42. The non-transitory computer-readable medium of any of examples 37 to 41, wherein the set of functions further comprises determining a motor characteristic comprising at least one selected from a group consisting of motor current and motor speed, and determining the auto-stop trip threshold based on the motor characteristic.

Thus, the invention provides, among other things, a power tool with various kickback and loss of control features.

We claim:

1. A power tool comprising:
a housing;
a motor within the housing and having a rotor and a stator, the rotor configured to rotationally drive a motor shaft about a rotational axis;
a sensor configured to monitor a power tool characteristic;
a switching network electrically coupled to the motor; and
an electronic processor connected to the switching network and the sensor, the electronic processor configured to implement an auto-stop function of the power tool, wherein, to implement the auto-stop function, the electronic processor is configured to, while the motor is operating:
determine an angular velocity of the housing about the rotational axis based on the power tool characteristic monitored by the sensor,
compare the angular velocity to a velocity threshold,
in response to the angular velocity exceeding the velocity threshold, add a value of the angular velocity to an integrator,
determine, based on a value of the integrator exceeding an auto-stop trip threshold, that a loss of control event is occurring, and
control, in response to determining that the loss of control event is occurring, the switching network to cease driving of the motor.

2. The power tool of claim 1, wherein the electronic processor is configured to add the value of the angular velocity to the integrator by multiplying the angular velocity of the housing by a detection rate of the power tool characteristic monitored by the sensor to calculate a positional change of the housing and adding the positional change to the integrator.

3. The power tool of claim 1, wherein the electronic processor is configured to add the value of the angular velocity to the integrator by, in response to the angular velocity of the housing being opposite to a direction of force applied via operation of the power tool, adding the angular velocity of the housing multiplied by a scaler value to the integrator.

4. The power tool of claim 1, wherein the electronic processor is further configured to make a value of the angular velocity of the housing negative in response to the angular velocity of the housing being opposite to a direction of force applied via operation of the power tool and wherein the electronic processor is configured to compare the negative angular velocity to the velocity threshold by comparing the negative angular velocity to an absolute value of the velocity threshold.

5. The power tool of claim 1, wherein the electronic processor is further configured to, in response to the angular velocity not exceeding the velocity threshold, subtract a predetermined leakage value from the integrator.

6. The power tool of claim 1, wherein the electronic processor is further configured to, in response to the angular velocity not exceeding the velocity threshold and the integrator having a value less than a predetermined leakage value, set the integrator to a value of zero.

7. The power tool of claim 1, wherein the electronic processor is further configured to determine the auto-stop trip threshold based on at least one selected from a group consisting of motor current and motor speed.

8. A method of controlling a motor in a power tool, the method comprising:
determining, with an electronic processor of the power tool, an angular velocity of a housing of the power tool about a rotational axis of the motor based on a power tool characteristic monitored by a sensor of the power tool;
comparing, with the electronic processor, the angular velocity to a velocity threshold;
adding, with the electronic processor, a value of the angular velocity to an integrator in response to the angular velocity exceeding the velocity threshold;
determining, based on a value of the integrator exceeding an auto-stop trip threshold, that a loss of control event is occurring; and
in response to determining that the loss of control event is occurring, controlling, with the electronic processor, a switching network of the power tool to cease driving of the motor.

9. The method of claim 8, wherein adding the value of the angular velocity to the integrator includes multiplying the angular velocity of the housing by a detection rate of the power tool characteristic monitored by the sensor to calculate a positional change of the housing and adding the positional change to the integrator.

10. The method of claim 8, wherein adding the value of the angular velocity to the integrator comprises, in response to the angular velocity of the housing being opposite to a direction of force applied via operation of the power tool, adding the angular velocity of the housing multiplied by a scaler value to the integrator.

11. The method of claim 8, further comprising making a value of the angular velocity of the housing negative in response to the angular velocity of the housing being opposite to a direction of force applied via operation of the power tool, and wherein comparing the angular velocity to the velocity threshold comprises comparing the negative angular velocity to an absolute value of the velocity threshold.

12. The method of claim 8, further comprising, in response to the angular velocity not exceeding the velocity threshold, subtracting a predetermined leakage value from the integrator.

13. The method of claim 8, further comprising, in response to the angular velocity not exceeding the velocity threshold and the integrator having a value less than a predetermined leakage value, setting the integrator to a value of zero.

14. The method of claim 8, further comprising determining the auto-stop trip threshold based on at least one selected from a group consisting of motor current and motor speed.

15. A non-transitory computer-readable medium storing instructions that, when executed by an electronic processor of a power tool, perform a set of functions, the set of functions comprising:
determining an angular velocity of a housing of the power tool about a rotational axis based on a power tool characteristic monitored by a sensor of the power tool;
comparing the angular velocity to a velocity threshold;
in response to the angular velocity exceeding the velocity threshold, adding a value of the angular velocity to an integrator;
determining, based on a value of the integrator exceeding an auto-stop trip threshold, that a loss of control event is occurring; and
controlling, in response to determining that the loss of control event is occurring, a switching network of the power tool to cease driving a motor of the power tool.

16. The non-transitory computer-readable medium of claim 15, the set of functions further comprising:
making the value of the angular velocity negative in response to the angular velocity being in a direction opposite to a direction of force applied via operation of the power tool; and
adding the negative value of the angular velocity to the integrator.

17. The non-transitory computer-readable medium of claim 15, wherein adding the value of the angular velocity to the integrator includes multiplying the angular velocity by a detection rate of the power tool characteristic to calculate a positional change of the housing and adding the positional change to the integrator.

18. The non-transitory computer-readable medium of claim 15, the set of functions further comprising, in response to the angular velocity not exceeding the velocity threshold, subtracting a predetermined leakage value from the integrator.

19. The non-transitory computer-readable medium of claim 15, the set of functions further comprising, in response to the angular velocity not exceeding the velocity threshold and the integrator having a value less than a predetermined leakage value, setting the integrator to a value of zero.

20. The non-transitory computer-readable medium of claim 15, wherein the set of functions further comprises:
determining a motor characteristic comprising at least one selected from a group consisting of motor current and motor speed; and
determining the auto-stop trip threshold based on the motor characteristic.
